(19) United States
(12) Patent Application Publication
(10) Pub. No.: US 2012/0156537 A1
(43) Pub. Date: Jun. 21, 2012

(54) ELECTROCHEMICAL ENERGY STORAGE DEVICE

(75) Inventors: Jens Meintschel, Bernsdorf (DE); Claudia Brasse, Hanau (DE); Torsten Schmidt, Landsberg (DE); Claus-Rupert Hohenthanner, Hanau (DE)

(73) Assignee: LI-TEC BATTERY GMBH, Kamenz (DE)

(21) Appl. No.: 13/144,707

(22) PCT Filed: Jan. 14, 2010
(86) PCT No.: PCT/EP2010/000176

§ 371 Date: Feb. 28, 2012

(30) Foreign Application Priority Data
Jan. 19, 2009 (DE) 10 2009 005 124.4

(51) Int. Cl. H01M 2/10

(52) U.S. Cl. 429/99

(57) ABSTRACT

A storage device for electric energy according to an aspect of the invention comprises a plurality of flat storage cells, wherein a plurality of storage cells are stacked in a stacking direction into a cell block and are held together by a tensioning device between two pressure plates, and wherein the storage cells are connected to each other within the cell block in parallel and/or in series. Each storage cell is held in the edge region thereof between two frame elements. According to another aspect, each storage cell comprises current conductors in the edge region and electric contacting between current conductors of successive storage cells is carried out via the tensioning device by way of a non-positive fit.

Priority application DE 10 2009 005 124.4 is fully incorporated by reference into the present application.

The present invention relates to an electrochemical energy storage device according to the preamble of claim 1 or 77.

Batteries (primary storage devices) and storage batteries (secondary storage devices) for storing electric energy are known, which are assembled from one or more storage cells in which, when a charging current is applied, in an electrochemical charge reaction between a cathode and an anode in or between an electrolyte, electric energy is converted into chemical energy and thus is stored, and in which, when an electrical load is applied, in an electrochemical discharge reaction chemical energy is converted into electric energy. Primary storage devices are thereby charged only once as a rule and must be disposed of after discharge, while secondary storage devices permit several (from several 100 to over 10,000 cycles) of charging and discharging. It should be noted thereby that storage batteries are now also referred to as batteries, such as, e.g., vehicle batteries, which, as is known, undergo frequent charging cycles.

In recent years, primary and secondary storage devices based on lithium compounds have become increasingly important. They have a high energy density and thermal stability, provide a constant voltage with low automatic discharge and are free from the so-called memory effect.

It is known to produce energy storage devices and, in particular, lithium batteries and lithium storage batteries in the form of thin plates. We refer to this study by way of example for the functional principle of a lithium-ion cell.

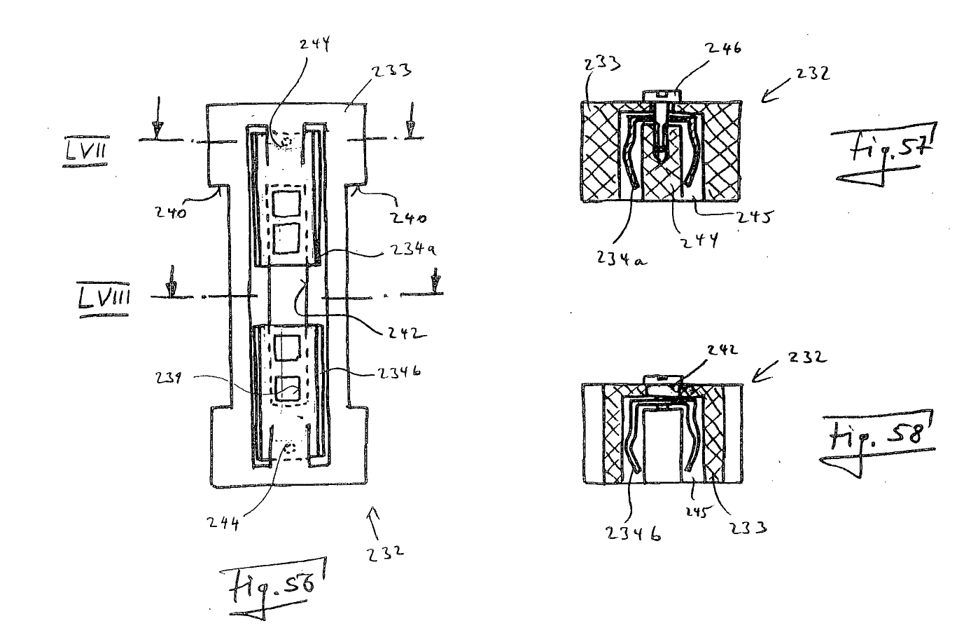

In order to achieve the voltages and capacities desired in practice, for automobile batteries, for example, it is necessary to arrange several cells to form a stack and to connect their connectors in a suitable manner. The interconnection of the individual cells is usually carried out on a narrow side (generally defined as “top”) of the cells, from which the connectors project. Interconnection arrangements of this type are shown in WO 2008/128764 A1, WO 2008/128769 A1, WO 2008/128770 A1 and WO 2008/128771 A1, as is illustrated in FIG. 60 by way of example. In an arrangement of this type, the connectors must each be connected individually to a connector of another cell. As a rule, this work can be carried out only manually. The connectors and the connections thereof are exposed on the top face. In the arrangement of the individual cells in the stack, precise attention must be paid to their position with correct polarity with respect to one another.

JP 07-282841 A shows a similar arrangement, in which the individual cells are inserted into a housing, as is shown in FIG. 61. Here, the individual cells are loose in individual divisions of the housing, and the contacts projecting out at the top are connected to one another by means of bolts. The whole arrangement is then closed from above by a cover.

From a development as yet unpublished it is known to combine several thin, rectangular galvanic cells to form one or more stacks such that their sides of greatest expansion are facing towards one another or touch one another and thus are sealed in a holding device. An arrangement of this type can no longer be dismantled.

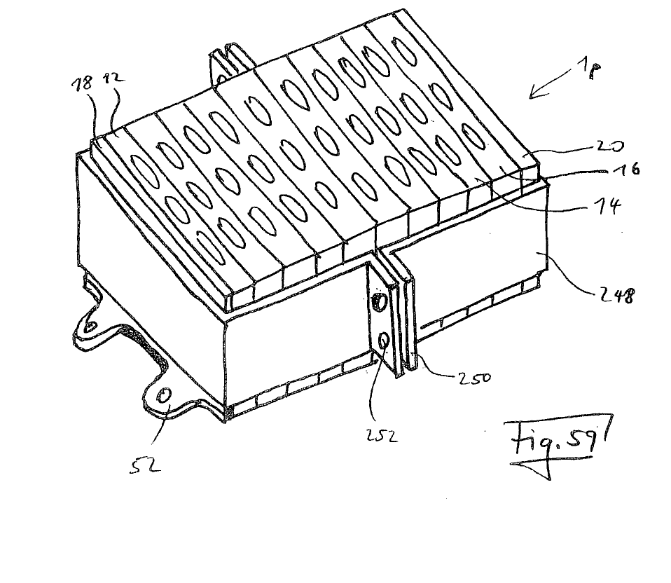

The inventors are also aware of an arrangement not substantiated in further detail in print in which several flat cells are stacked between two pressure plates, the stack being held together by tension bars (stud bolts or fillister head screws), which extend between the pressure plates. An arrangement of this type is shown diagrammatically in FIG. 62. Not inconsiderable pressure is hereby exerted on the active part of the storage cells located in the internal region. Furthermore, the cell block forms a solid body with high heat capacity and few heat radiating surfaces.

A patent application filed by the applicant of this application on the same day, which is tracked internally under file number 105907, describes the configuration of flat cells with flat connector projecting laterally from narrow sides located opposite one another, the extension of which along the respective narrow side is larger than half the length of this narrow side. These cells can be contacted to the connectors and at the same time can be assembled in a positionally stable manner. The disclosure of this patent application is hereby included by reference herein without the application of the present invention being restricted to the details described there.

A demand exists for an electrochemical energy storage device that has a stack of flat storage cells, which avoids the disadvantages of the prior art. Furthermore, a demand fundamentally exists, particularly for vehicles, for further space-saving, that is, for a reduction in the size of the total battery arrangement. Furthermore, with respect to the increased storage requirement particularly for electric or hybrid vehicles, an adjustment to the existing space available and the geometric conditions is required as well as adjustability to various voltage and capacity requirements.

The object of the present invention is therefore to create an electrochemical energy storage device of the above-mentioned type which is compact and rugged, can be easily and securely assembled, the individual cells of which are exposed to lower mechanical stress and the temperature of which is easy to regulate and which can be adapted flexibly to the different requirements.

The object is attained with the features of the independent claims. Advantageous further developments of the invention form the subject matter of the dependent claims.

An electric energy storage device according to one aspect of the invention has a plurality of storage cells with a flat shape, several storage cells being stacked in a stacking direction to form a cell block and being held together by a clamping device between two pressure plates, and the storage cells being connected to one another in parallel and/or in series inside the cell block. Each storage cell is held in its edge region between two frame elements.

In this manner a defined pressure zone is obtained, in which the cells are held.

Preferably, each storage cell has an active part in which a structure configured and adapted for absorbing and releasing electric energy by means of an electrochemical reaction is arranged, and the edge region surrounds the active part. The clamping pressure and possible impairments to the function by this are thus kept away from the active part.

Preferably, each storage cell has planar contact sections, which project in the edge region from two opposite narrow sides of the storage cell transversely to the stacking direction. In this manner the contact sections are configured in a comparatively rugged manner and can be utilized to hold the cell.

The invention can be applied particularly advantageously to electrochemical cells, such as, e.g., galvanic secondary cells. Preferably, the active part is thereby tightly enclosed by a membrane, which has at least one seam in the edge region, in particular at least on two opposite narrow sides of the storage cell, wherein the region enclosed by the membrane is preferably evacuated.

Preferably, the contact sections are respectively part of connectors that extend through the seams on the two opposite narrow sides and are in contact with the active part in the interior. Since the contact sections are connected to the active part, which accounts for the heaviest part of a cell, mechanical stress and the likelihood of damage to a casing are kept low.

This is advantageously attained in that the contact sections form pressure surfaces for the pressure applied by the clamping device via the frame elements.

The active part generally has a greater thickness than the edge region. If the frame elements have such a thickness that there is a free space between the active parts of adjacent storage cells, this free space can be used for temperature adjustment with a heat transfer medium.

If, for example, the frame elements respectively have at least one opening transversely to the stacking direction, which connects the free space between adjacent storage cells to an exterior space, a heat transfer medium can flow or circulate through these openings and realize a cooling circuit. This is achieved particularly effectively by arranging several openings in sections of the frame elements located opposite transversely to the stacking direction. In particular, a cooling medium can flow through the space between two storage cells, the cooling medium in particular entering and leaving through the openings in the frame elements.

The cooling medium is preferably flame-resistant or not combustible in order to improve safety. Thus, for example, air, deionized water or oil or the like can be used as a cooling medium.

A particularly effective heat transfer results when the cooling medium undergoes a phase transition when flowing through the space between two storage cells.

Preferably, the pressure plates are embodied in a frame-shaped manner. The pressure of the clamping device can thus be uniformly introduced into the cell stack via the frame elements with the slightest weight.

A suitable clamping device has several, in particular four or six, tension bars. These can extend in a particularly space-saving manner through holes running in the stacking direction in the pressure plates, the frame elements and the edge regions of the storage cells.

If the tension bars extend through holes running in the stacking direction in the contact sections of the storage cells, the pressure can be exerted particularly effectively on the contact sections of the storage cells. In this case it is particularly advantageous if the electrical connection of the storage cells is carried out by means of friction fit via the clamping device.

A contact connection element made of an electrically conducting material is arranged in particular where an electrical connection is to be produced between contact sections of adjacent storage cells, which element is pressed onto both contact sections by means of the clamping pressure exerted in the stacking direction via the clamping device. The contact connection element can be composed of a metal or a metal alloy, preferably copper, brass, bronze, and particularly preferably can be gold-plated or silver-plated in order to reduce the contact resistance between contacts.

A compact design and simple assembly result when the contact connection element is integrated into a frame element. This is in particular the case when the contact connection element is a plurality of cylindrical bodies, which are inserted into the through-holes in the frame element.

When the frame elements have a reduced thickness between regions in which contact connection elements are used, a concentration of the contact pressure on the end faces of the contact connection elements and a particularly effective contacting result. Furthermore, the regions of reduced thickness can form openings for a circulation of the heat transfer medium.

The contact connection element can be, for example, a plurality of sleeves through which respectively one of the tension bars runs. Alternatively, the contact connection element can have an elongated basic shape with a substantially rectangular cross section, wherein the contact connection element is inserted into a cut-out in the frame element between the contact sections of the two storage cells to be connected, substantially following the course thereof, and wherein parallel outer surfaces of the contact connection element contact the contact sections of the storage cells.

In the latter case, the contact connection element can have thickened regions in the stacking direction, the outer end surfaces of which contact the contact sections of the storage cells. This in turn produces a high contact pressure and contacting pressure and the openings already mentioned for a circulation of the heat transfer medium.

If the contact connection element has at least one cooling rib extending in the longitudinal direction and pointing into the interior of the device, an effective heat transfer can take place from the connectors to the heat transfer medium.

Advantageously, where no electrical connection is to be produced between two contact sections, spacer elements made of electrically insulating material are inserted between the contact sections into cutouts in the frame elements, which preferably has substantially the shape of the contact connection element.

The contact connection element preferably has at least two through-holes, through which respectively one of the tension bars runs. To avoid a short circuit, the tension bars are thereby preferably electrically insulated with respect to the contact connection element and the contact section. This can be accomplished, for example, by the tension bars having an electrically insulating coating on the shank surfaces, or by the tension bars each bearing sleeves made of electrically insulating material.

One embodiment is characterized in that spring elements are arranged in a free space between adjacent storage cells, which spring elements support the storage cells elastically with respect to one another in the stacking direction. The spring elements can be, for example, planar foam elements that are fixedly attached to one or both flat sides of the storage cells. An arrangement of this type reduces oscillations of the cells during use and mechanical stresses caused thereby at the points at which the cells are held.

In order to avoid undesirable contacts between current-carrying parts, it is necessary to position the components exactly with respect to one another in the radial direction during assembly. This is facilitated by a centering device, which establishes the relative position of the storage cells and the frame elements transversely to the stacking direction. The centering device can comprise projections arranged in end faces of the frame elements, which engage in matching recesses in the edge region of the storage cells. The projections can be pins, nubs, noses or the like, wherein the recesses can be arranged in the contact regions or in the non-conducting sections of the edge regions. The recesses can be through-holes or perforations.

In alternative designs, the centering device can comprise embossing in the edge region of the storage cells, which engage in a matching relief on the frame elements. The centering device can also be realized such that the tension bars run with fit through holes in the edge region of the storage cells with the exception of the contact regions, that the storage cells, in particular with the thicker active sections thereof, are supported against the frame elements transversely to the stacking direction, or that an elastic element, in particular foam, is inserted between the frame elements and the storage cells, which foam is preferably molded directly onto the frame elements in order to avoid slipping during the assembly.

Furthermore, it is important that the storage cells are always installed in the correct direction of polarity. In order to avoid errors here, a reverse polarity protection device can be provided, which codes an installation direction of the storage cells.

The reverse polarity protection device can be realized such that the centering device is configured non-symmetrically. Thus, for example, the projections and recesses or the embossing and counter-relief can be arranged at a greater distance on the side of one contact section or can be embodied in another shape or size than on the side of the other contact section. The components of the centering device can thus perform the function of reverse polarity protection at the same time, and no additional measures or components need to be provided for this.

Alternatively, the reverse polarity protection device can be realized in that the spring elements on both flat sides of the storage cells and, depending on the desired direction of polarity of several storage cells with respect to one another, are arranged on the half of the flat sides assigned to one and the same contact section or on halves of the flat sides assigned to different contact sections. The spring elements can thus take over the function of reverse polarity protection at the same time, and no additional measures or components need to be provided for this.

In a further embodiment, the frame elements can have at least one edge-side indentation arranged at respectively the same point, the indentations of several frame elements in the assembled state forming a channel open to the outside with a substantially U-shaped cross section, which extends in the stacking direction. A channel of this type can be used to guide lines advantageously and in a space-saving manner. Connection elements such as for sensors or thermo elements or control elements can be attached and connected via holes, which are respectively made on the base of the indentation perpendicular to the extension direction of the channel. It is advantageous thereby if the channel is accessible on the end face via at least one through-hole or perforation or notches arranged in at least one of the pressure plates.

The storage cells can be connected in series or at least part of the storage cells can be connected in parallel. In particular, several storage cells connected in parallel can form respectively one group and several groups comprising a respectively identical number of storage cells are connected in series. Through suitable combination and number of storage cells and groups of the same, within the scope of the available space virtually any desired voltage and capacity can be represented as a multiple of the cell voltage and cell capacity.

The pressure plates can be composed of an electrically conducting material and can be electrically connected via an above-mentioned contact connection element to a contact section of a storage cell. The pressure plates can thus serve as electric terminals. Furthermore, if the pressure plates have connection elements, which are equipped for connection to a connecting lead or a counterpart, a further interconnection of the cell blocks is particularly simple. The connection elements, for example, can thus be lugs, preferably provided with through-holes or bearing stud bolts, which laterally project transversely to the stacking direction or project at the end face in the stacking direction. To avoid short circuits, it is advantageous in this case if the tension bars are electrically insulated with respect to the pressure plates.

In an alternative embodiment it can be provided for the tension bars to be electrically insulated with respect to one of the pressure plate, while they are connected to the other pressure plate in an electrically conducting manner and have connection elements that preferably are screwed to the tension bars or embodied integrally at least on the side of the insulated pressure plate. The tension bars, which, insulated against the other components anyway, are guided through the cell block, can thus serve as one of the terminals, so that both of the terminals are on one and the same end face of a cell block. This can simplify the interconnection and the connection of the cell blocks.

It is advantageous thereby if the tension bars on at least one side have connection elements, which preferably are screwed to the tension bars or are embodied integrally.

The connection elements of the tension bars on at least one side can be electrically connected to one another for the purpose of a potential equalization.

A particularly simple and self-centering construction results when the tension bars are screwed directly into one of the pressure plates.

Preferably, the frame elements and pressure plates collectively define a substantially prismatic contour, which completely surrounds the storage cells arranged therein. This thus results in a closed body, which is easy to handle. Advantages also result with respect to the possibilities of embodying a cooling circuit with a heat transfer medium.

Furthermore, it is advantageous if, at the end-face ends of a cell block, the two frame elements have transverse braces of reduced thickness, which span the space left free by the respective frame element. This results in a reinforcement of this end frame element and furthermore a defined exposed surface of the respective end storage cell.

The electric energy storage device preferably has a control unit for monitoring and balancing the storage cells. This control unit is particularly preferably attached to the cell block, preferably to one of the transverse braces described above.

The channel formed by the indentations described above can be advantageously used for guiding lines, which are with the control unit.

An advantageous modularity and flexibility results if several cell blocks are connected to one another in series and/or in parallel.

If, furthermore, the cell blocks have a different number of storage cells, the installation space available can be utilized particularly effectively. For this purpose it is advantageous if the number of storage cells in the cell blocks is selected on the basis of the geometry of an available installation space. The cell blocks can be arranged in respective stacking directions one behind the other and/or with respect to the respective stacking directions next to one another and/or one above the other and/or at, in particular, a right angle of the respective stacking directions to one another and connected to one another via their connection elements.

A housing can accommodate the entire arrangement. The connection elements described above can thereby be advantageously used at least in part to attach the cell blocks to the housing.

An electric energy storage device of a further aspect of the invention has a plurality of storage cells with a flat shape, several storage cells being stacked in a stacking direction to form a cell block and held together by a clamping fixture, and the storage cells inside the cell block being connected to one another in parallel and/or in series. In this electric energy storage device, each storage cell has connectors in its edge region, and an electric contacting takes place between connectors of consecutive storage cells by means of friction fit via the clamping fixture.

To this end, a pressure-transferring component is preferably arranged between connectors in the stacking direction, which component is composed of either an electrically conducting material or an electrically insulating material, and on which the force of the clamping fixture acts.

In particular the storage cells are held by the pressure-transferring components.

The further features, functions and advantages of the present invention and those cited in the claims are more clearly described in the following description of preferred embodiments, which was prepared with reference to the attached drawings.

In the drawings:

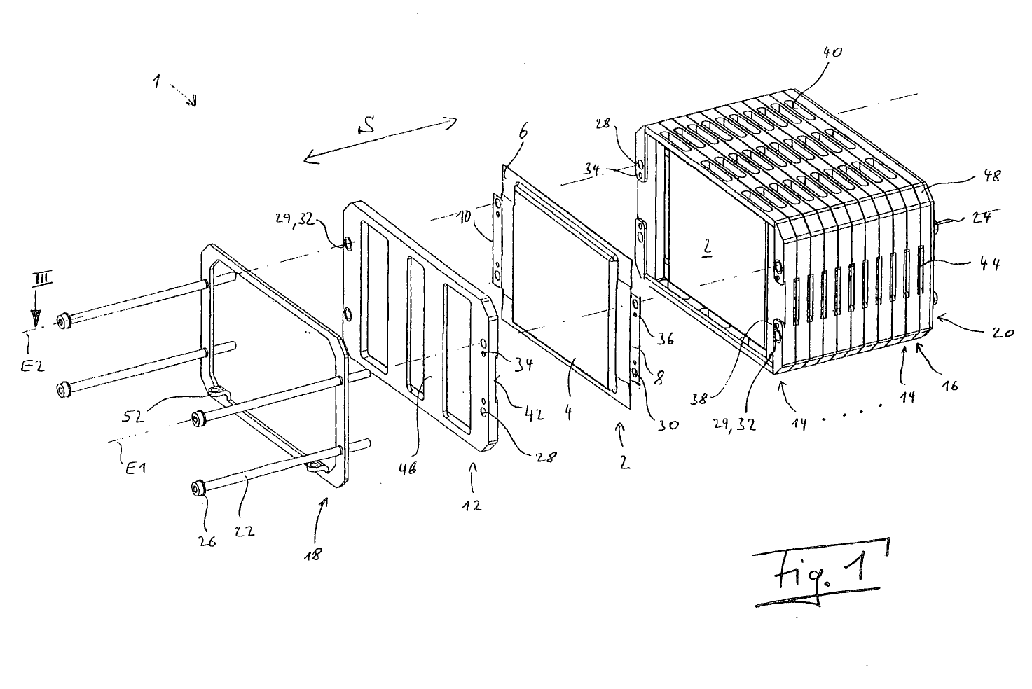

FIG. 1 shows a cell block according to the first embodiment in a perspective partially exploded view;

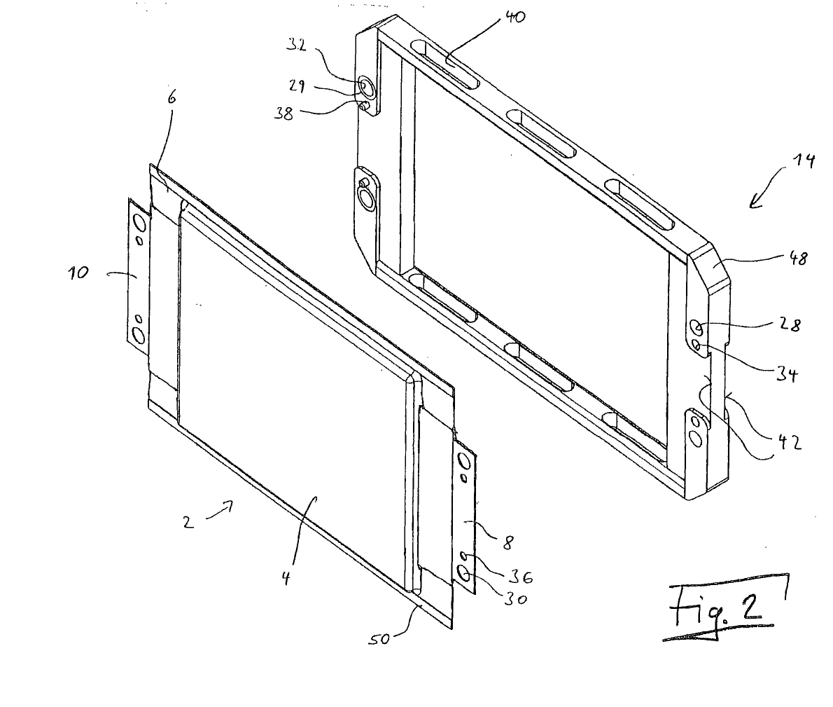

FIG. 2 shows a storage cell and a frame element therefrom;

FIG. 3 shows a sectional view through a cell block in a plane defined by two lines E1, E2 in the line of sight of an arrow III in FIG. 1;

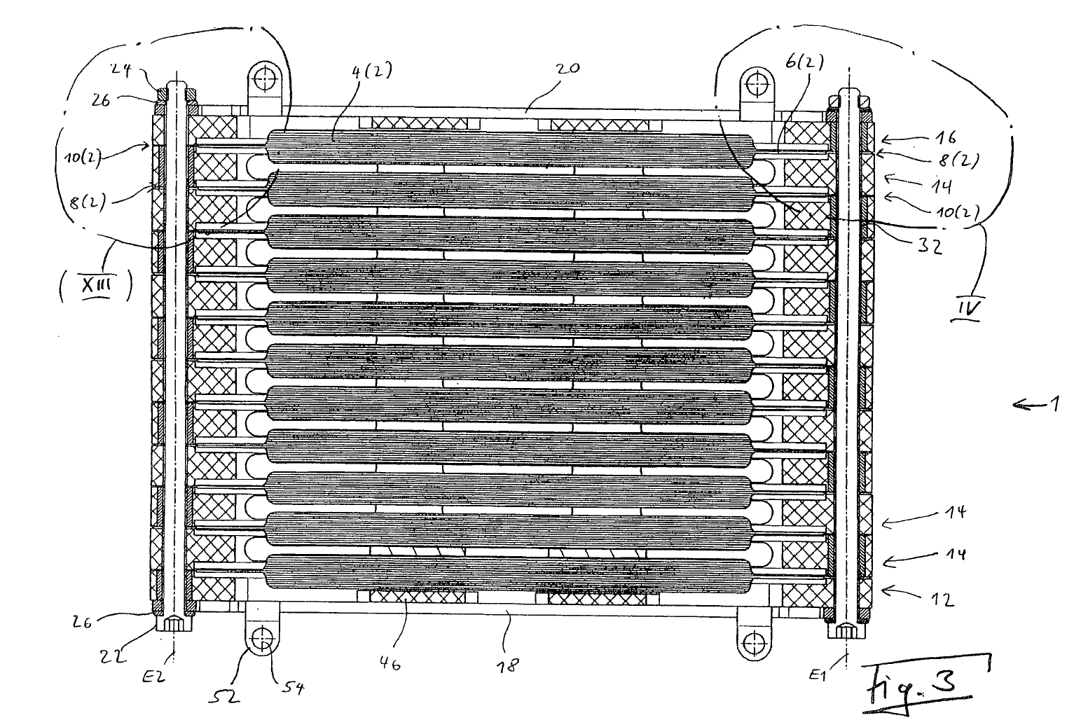

FIG. 4 shows a detail IV in FIG. 3 in the region of the threaded assembly;

FIG. 5 shows a perspective overall view with additional connection elements and a control device;

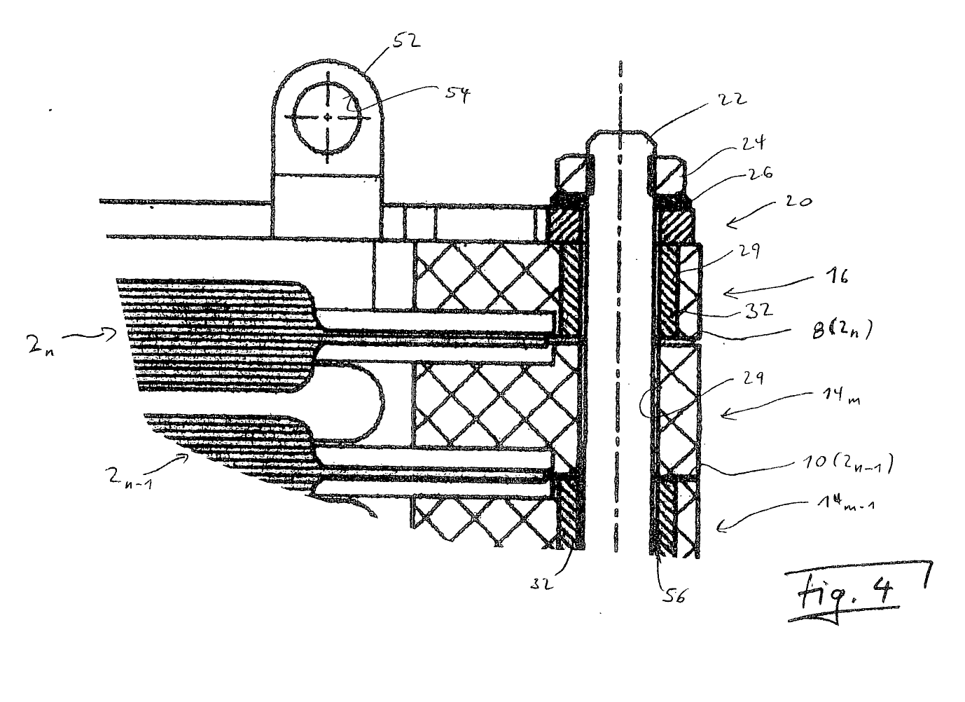

FIG. 6 shows an equivalent circuit diagram of the cell block similar to that shown in FIG. 1;

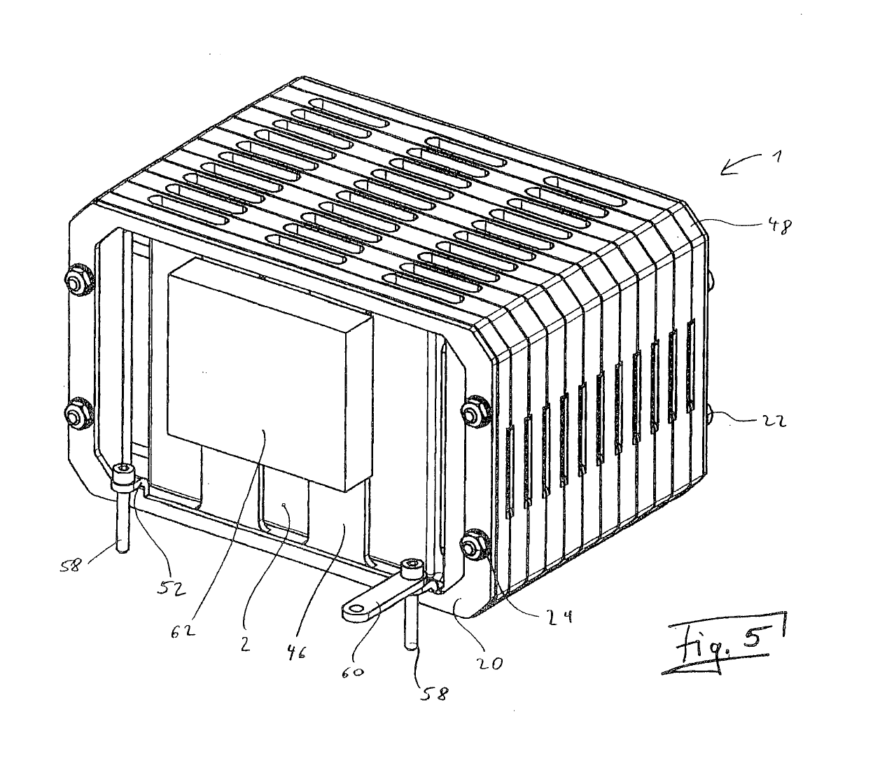

FIG. 7 shows an equivalent circuit diagram of a second embodiment of the present invention;

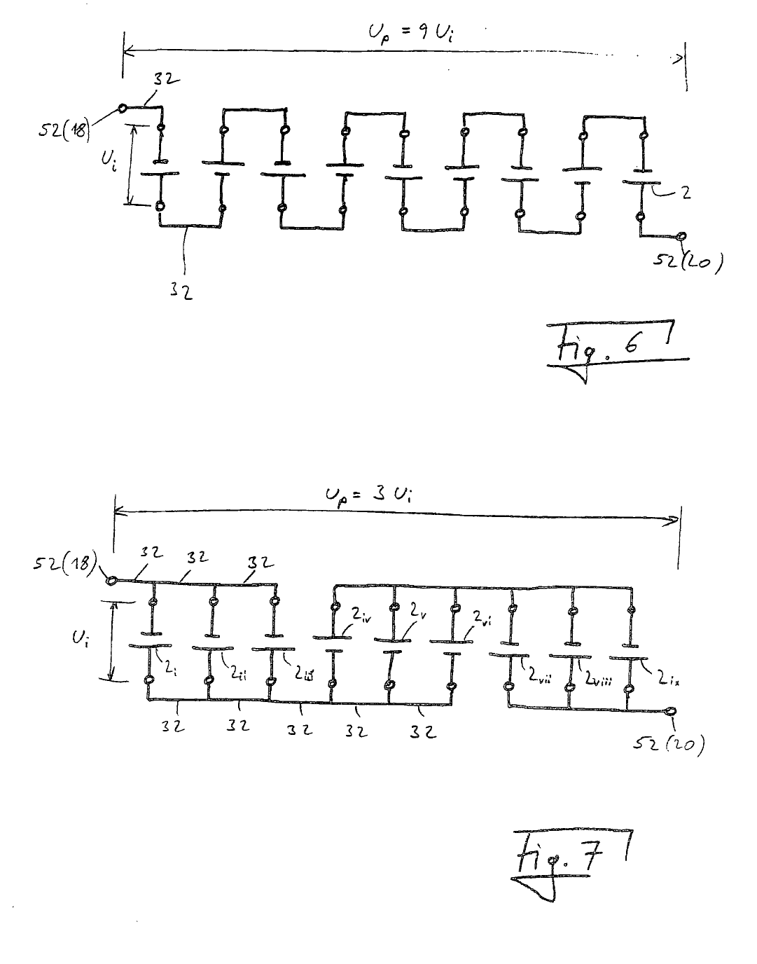

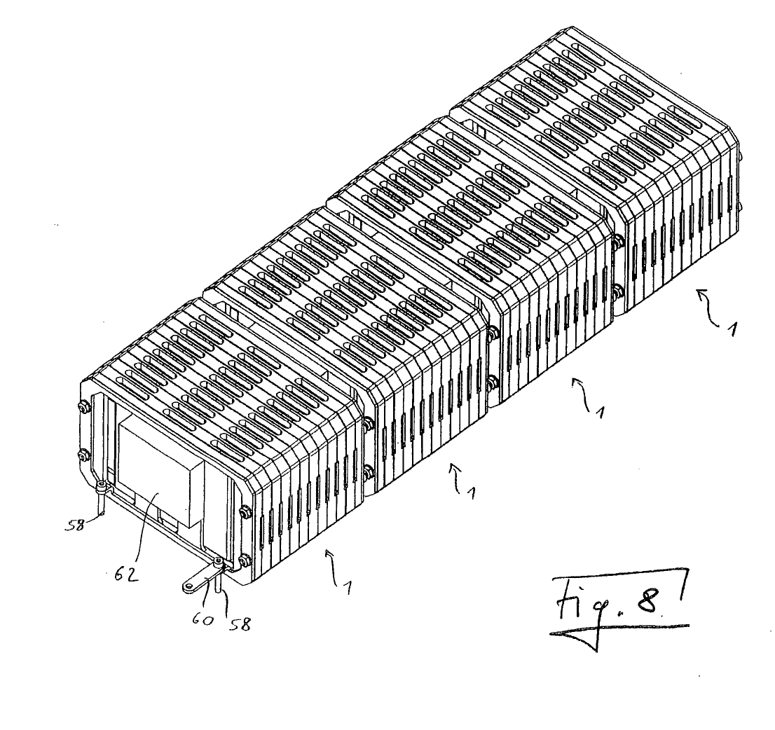

FIG. 8 shows a perspective representation of the arrangement of four cell blocks as the third embodiment of the present invention;

FIG. 9 shows a side view of the arrangement from FIG. 8;

FIG. 10 shows a series connection of two cell blocks as a fourth embodiment of the present invention;

FIG. 11 shows a parallel connection of two cell blocks as a fifth embodiment of the present invention;

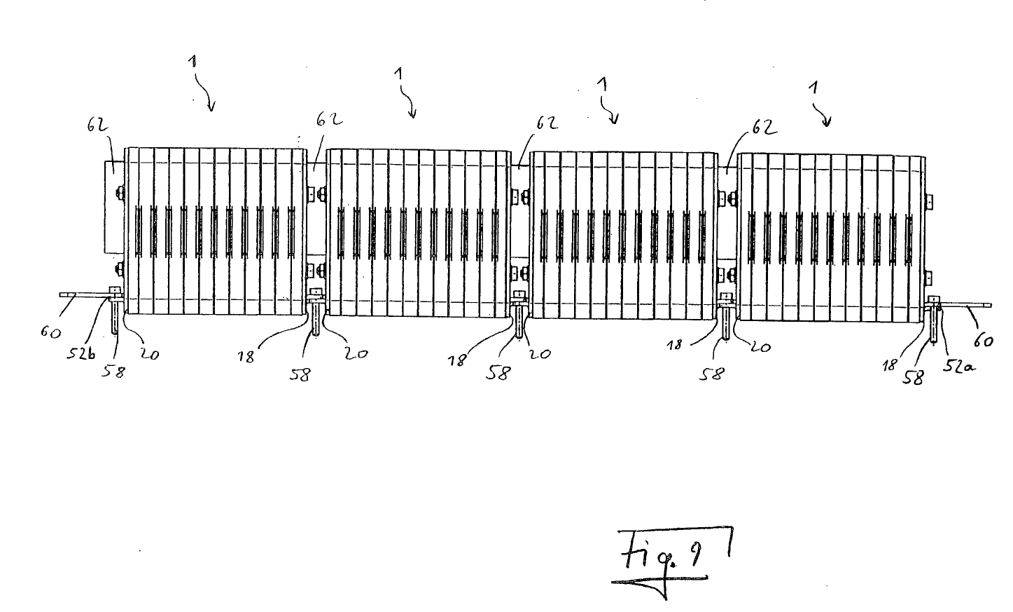

FIG. 12 shows an arrangement of cell blocks as a sixth embodiment of the present invention;

FIG. 13 shows a detail of a cell block of a seventh embodiment;

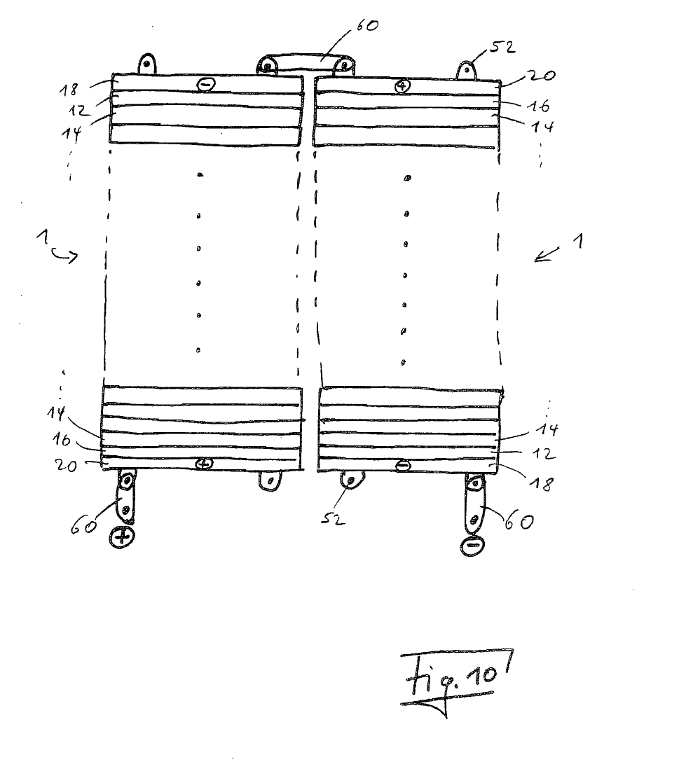

FIG. 14 shows an assembled state of a cell block of an eighth embodiment in perspective view;

FIG. 15 sows the cell block from FIG. 14 without pressure plates and clamping;

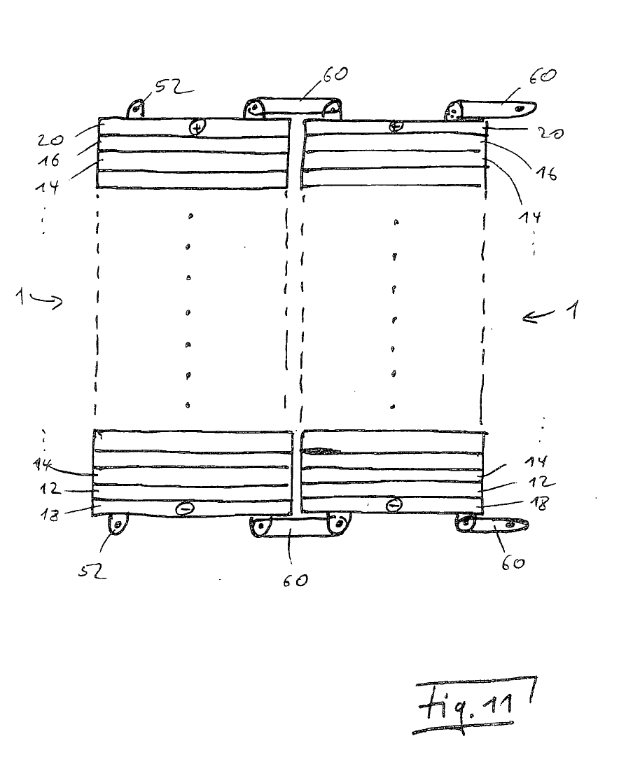

FIG. 16 shows an end frame of the cell block from FIG. 14 in front view;

FIG. 17 shows an intermediate frame 4 in a perspective view;

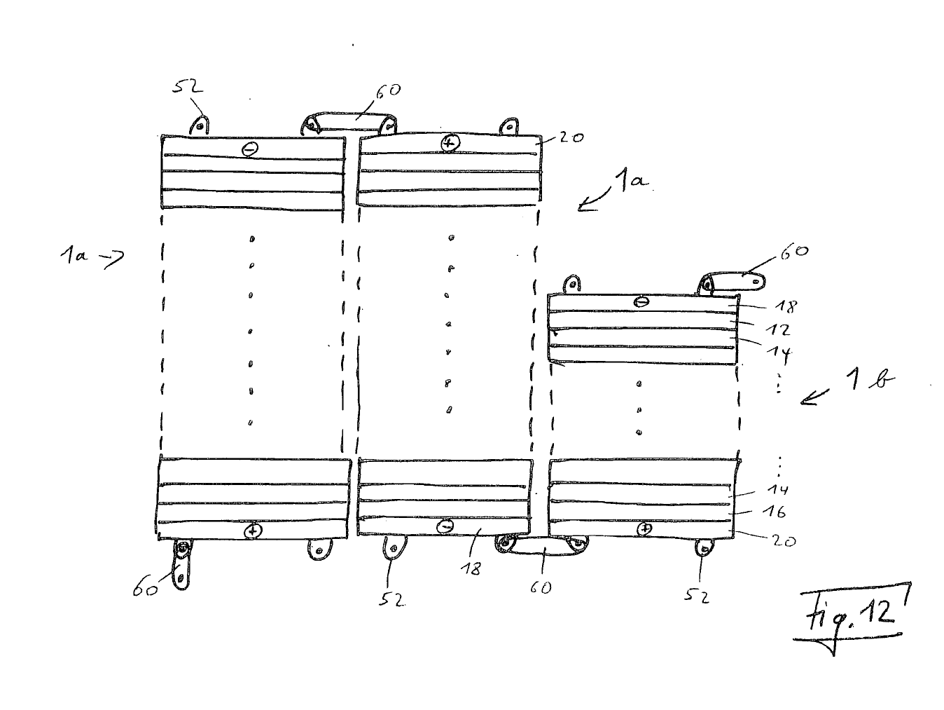

FIG. 18 shows a perspective representation of an individual cell block of a ninth embodiment of the present invention of this embodiment;

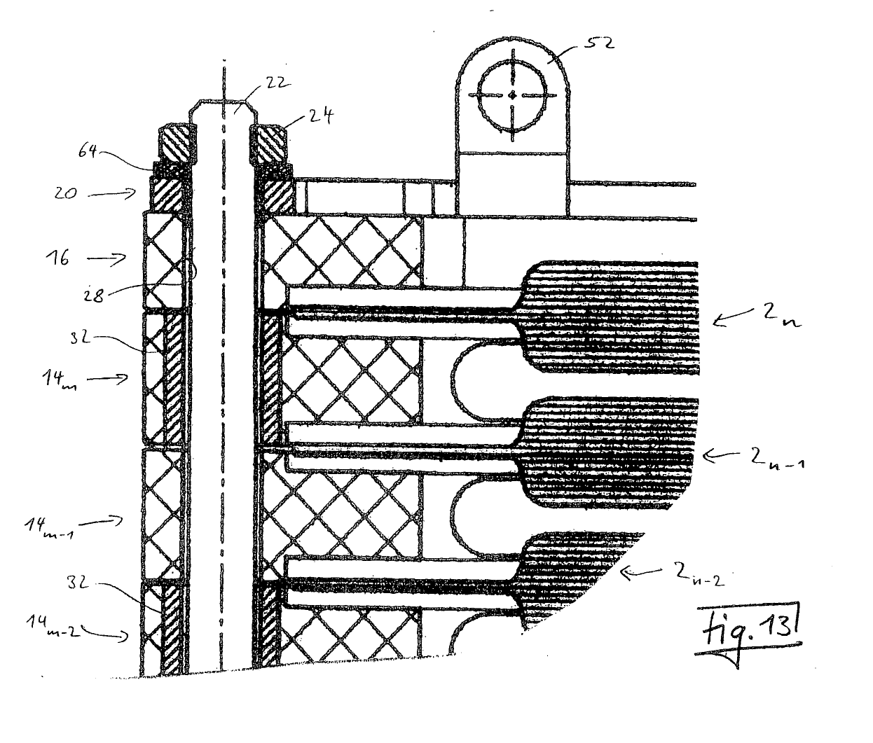

FIG. 19 shows a side view of an arrangement of four cell blocks from FIG. 18 connected in series;

FIG. 20 shows a perspective view of a storage battery cell of a tenth embodiment;

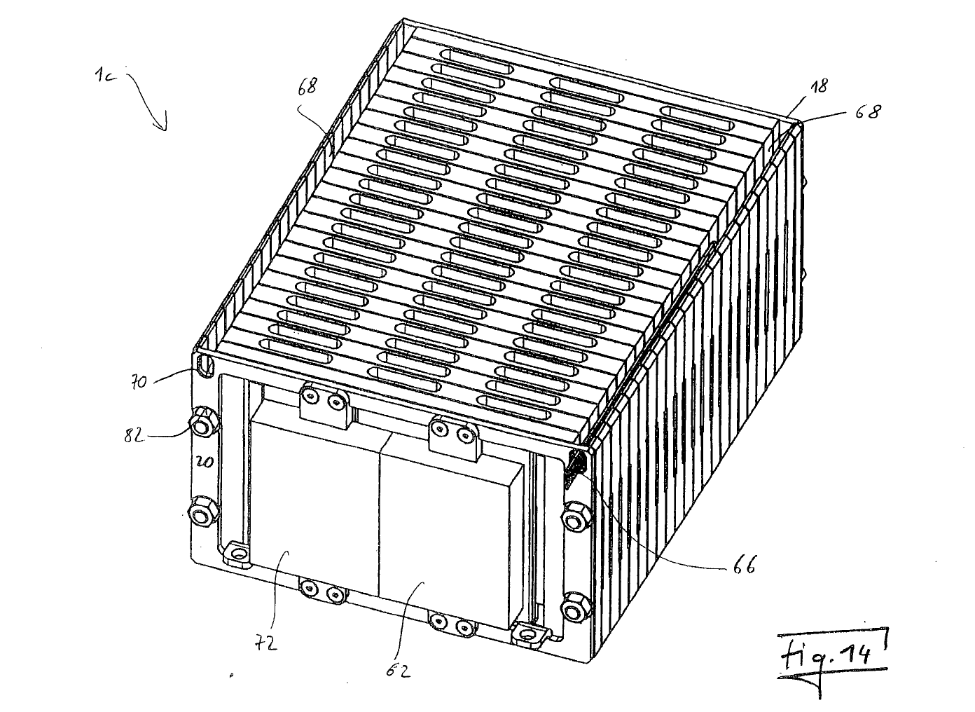

FIG. 21 shows a plan view, i.e., a view onto the upper narrow side of the storage battery cell from FIG. 20;

FIG. 22 shows a perspective representation of two storage battery cells in their arrangement in a cell block with contact strips in an eleventh embodiment of the present invention;

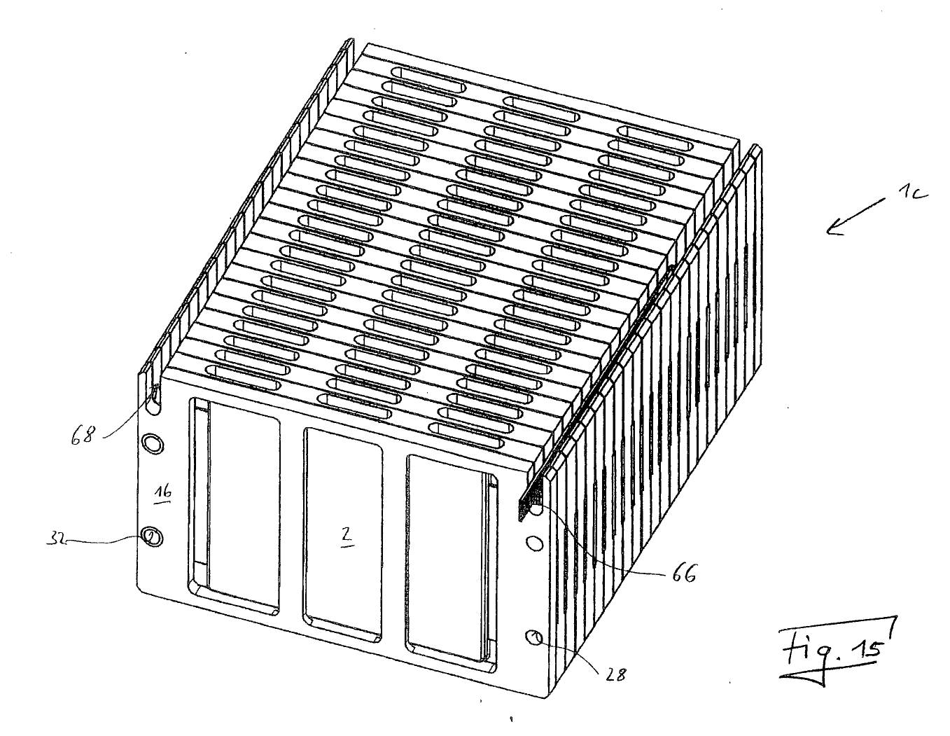

FIG. 23 shows a plan view, i.e., a view from above onto the long narrow sides of the storage battery cells from FIG. 22;

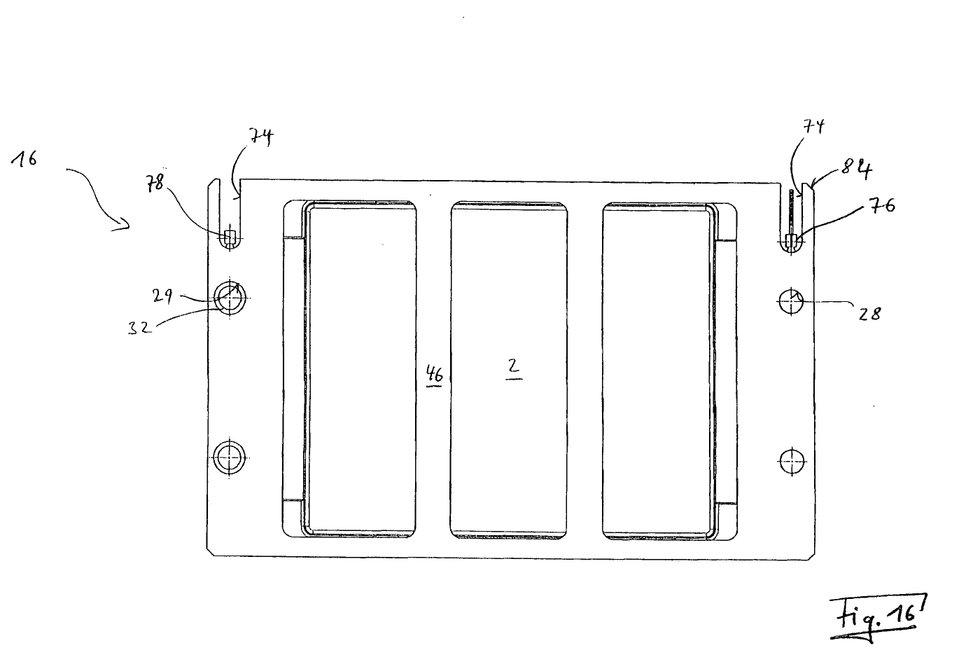

FIG. 24 shows a perspective view of a contact strip from FIG. 22;

FIG. 25 shows a front view of an intermediate frame in this embodiment;

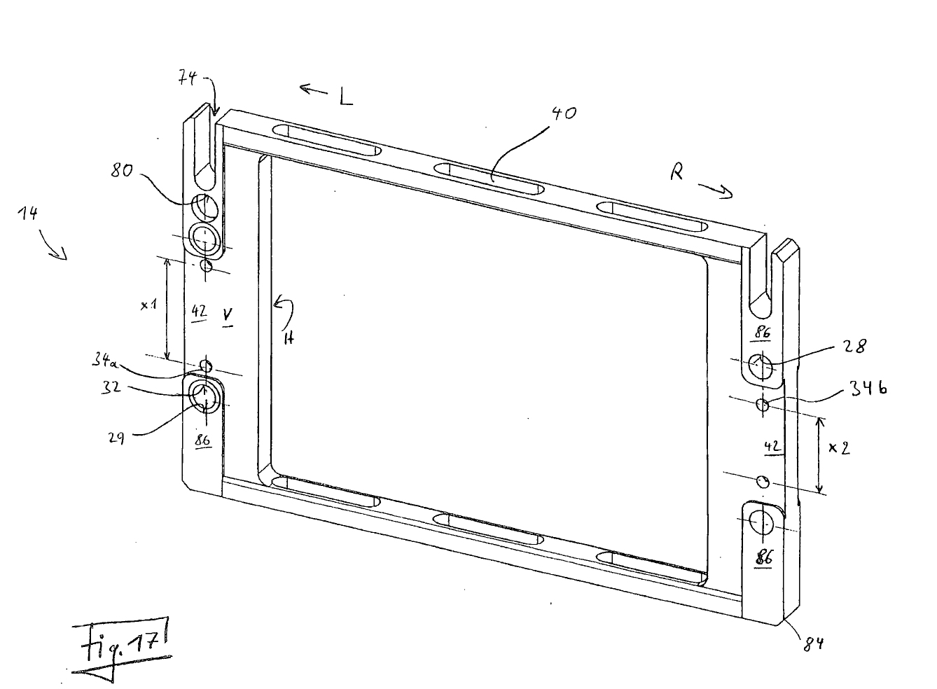

FIG. 26 shows a perspective representation of a storage battery cell in its arrangement in the cell block with contacting bars in a twelfth embodiment of the present invention;

FIG. 27 shows an exploded view of the arrangement according to FIG. 26, wherein in addition an insulating bar is shown;

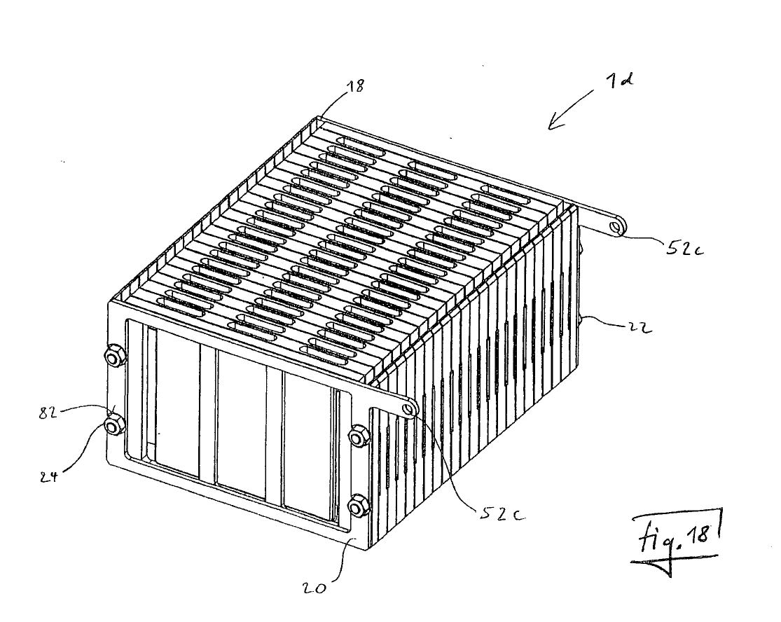

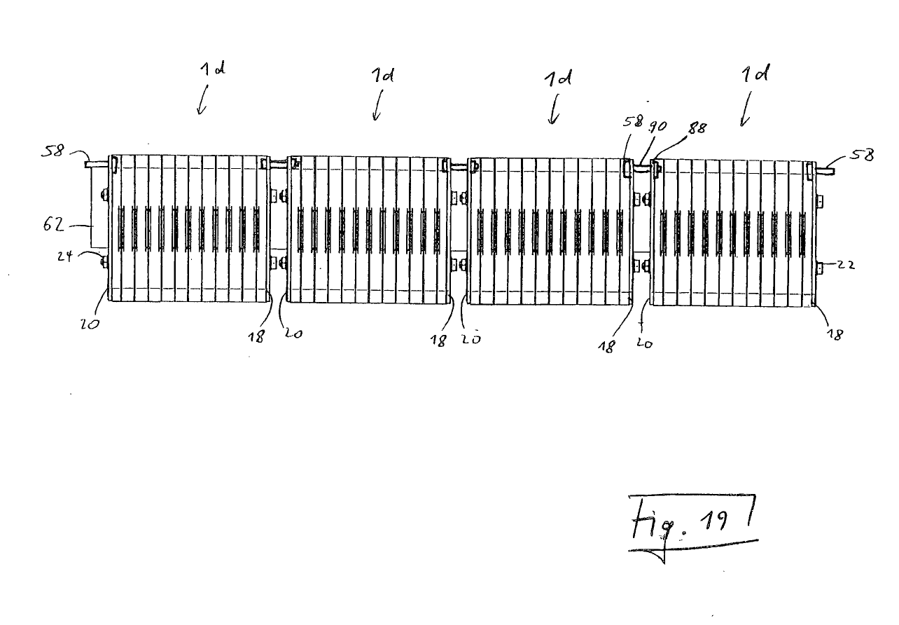

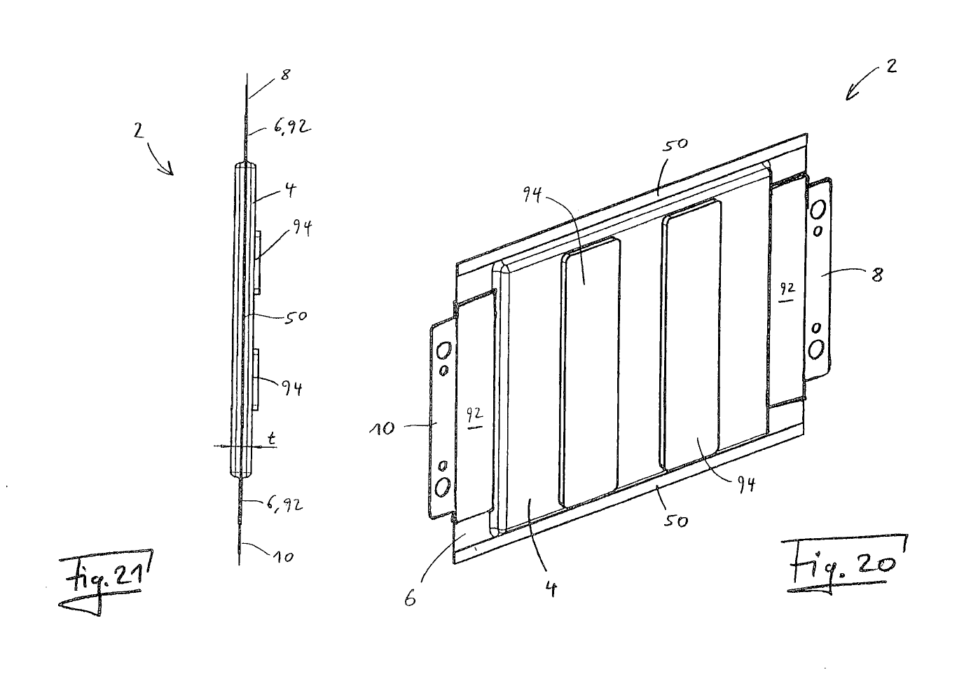

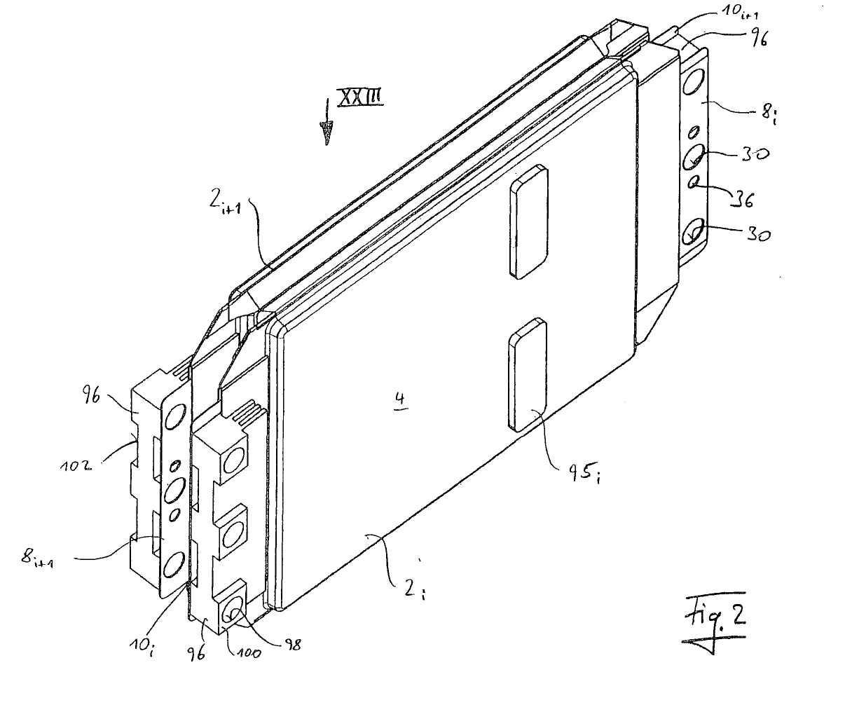

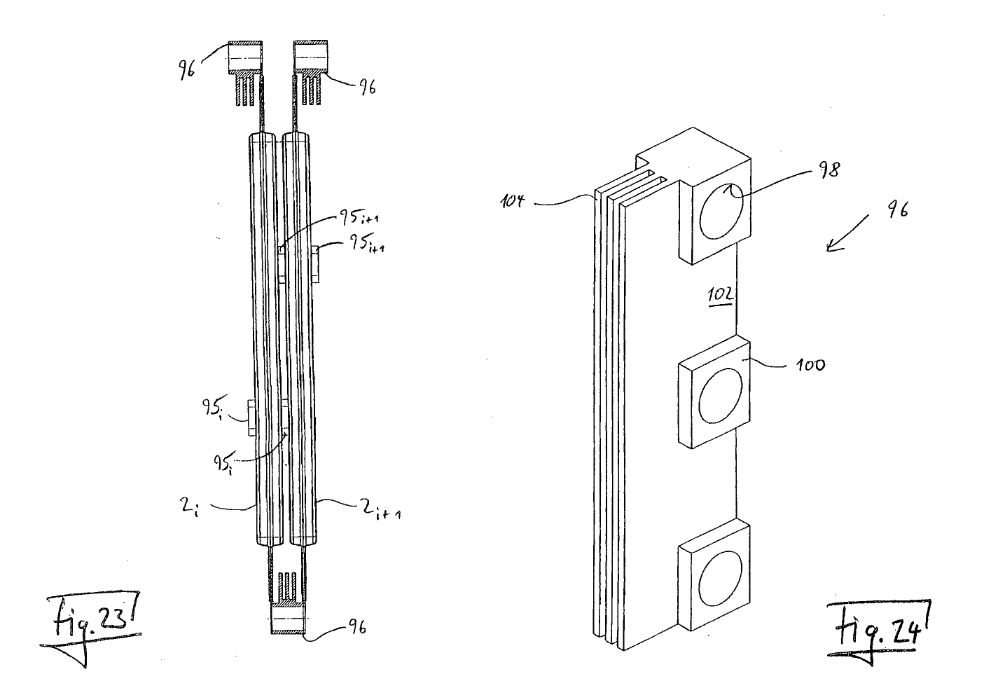

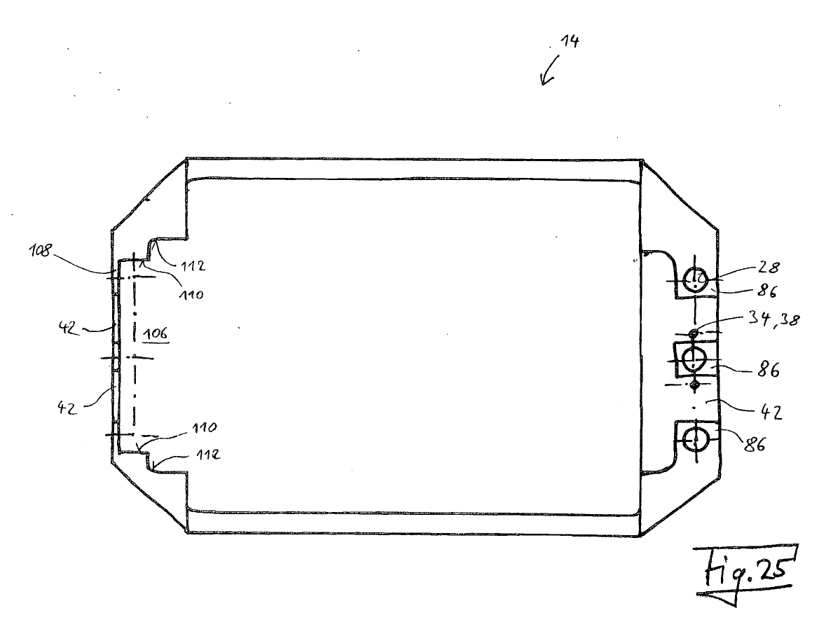

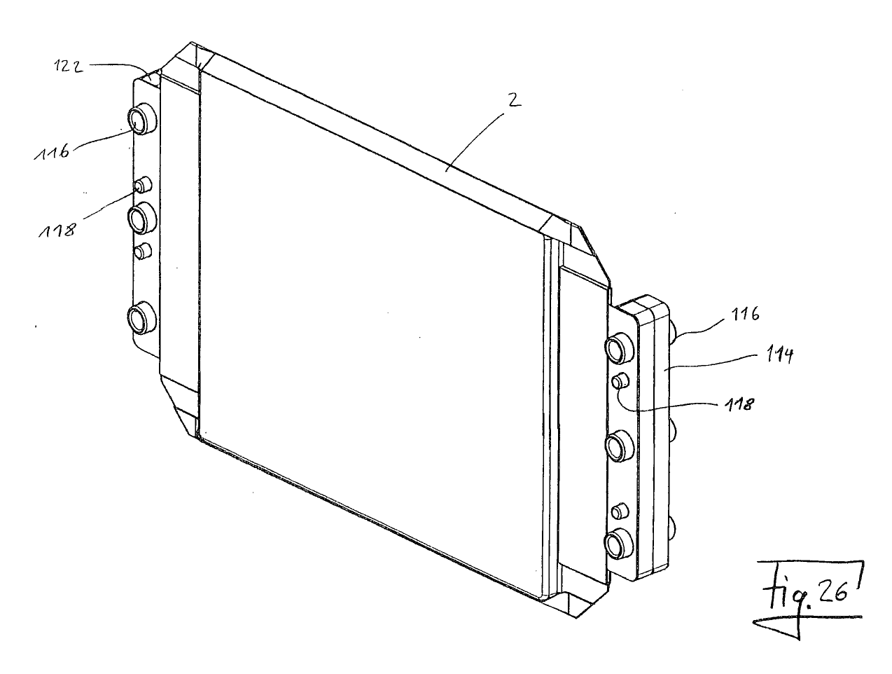

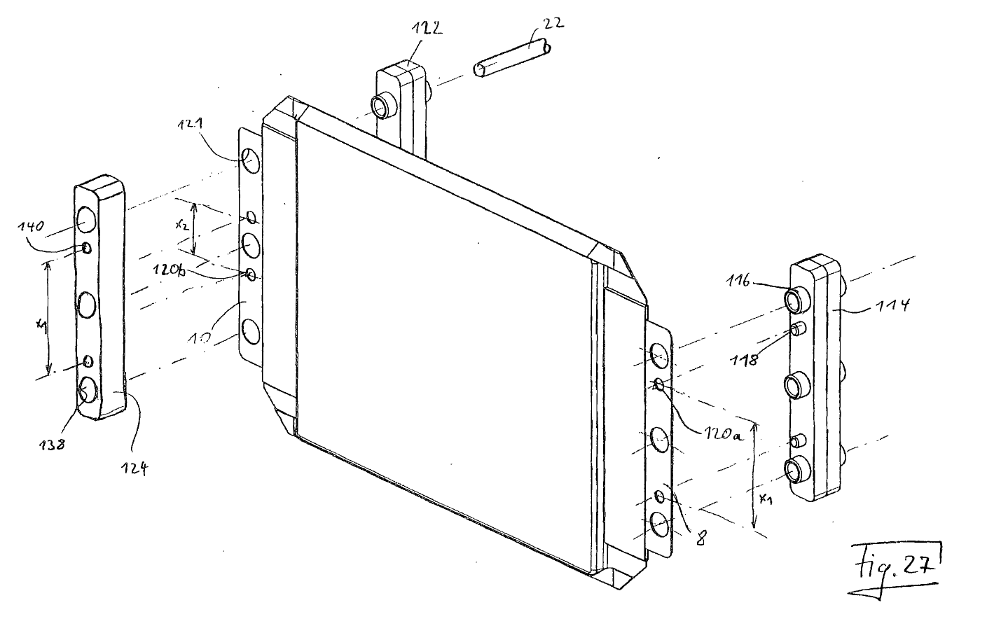

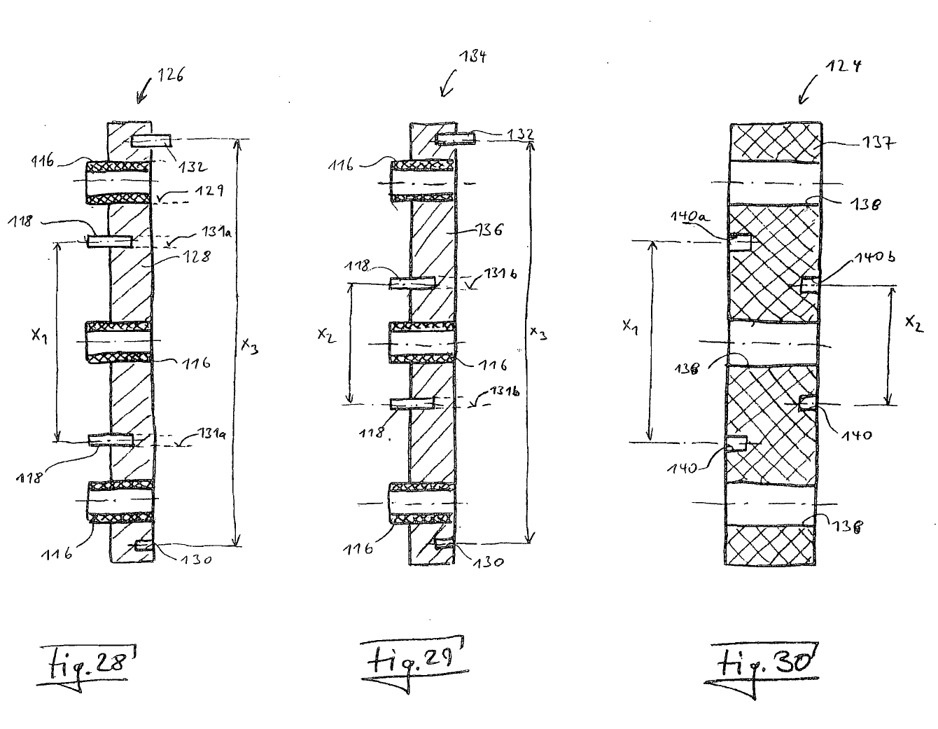

FIG. 28 shows a cross-sectional view of a semi-bar for contacting a positive connector;

FIG. 29 shows a cross-sectional view of a semi-bar for contacting a negative connector;

FIG. 30 shows a cross-sectional view of the insulating bar from FIG. 27;

FIG. 31 shows a front view of an intermediate frame in the twelfth embodiment;

FIG. 32 shows a cross-sectional view of a semi-bar for contacting a positive connector in a thirteenth embodiment of the present invention;

FIG. 33 shows a cross-sectional view of a semi-bar for contacting a negative connector in the thirteenth embodiment;

FIG. 34 shows a cross-sectional view of an insulating bar in the thirteenth embodiment;

FIG. 35 shows a spacer semi-plate coded for a positive terminal in a fourteenth embodiment of the present invention in longitudinal section;

FIG. 36 shows a spacer semi-plate coded for a negative terminal in the fourteenth embodiment in longitudinal section;

FIG. 37 shows a contact sleeve in the fourteenth embodiment in longitudinal section;

FIG. 38 shows a double-pin collar for series connection in the fourteenth embodiment in longitudinal section;

FIG. 39 shows an inside collar for parallel connection in the fourteenth embodiment in longitudinal section;

FIG. 40 shows a single pin collar for a transition from parallel to series connection in the fourteenth embodiment in longitudinal section;

FIG. 41 shows a spacer sleeve for variable use in the fourteenth embodiment in longitudinal section;

FIG. 42 shows a storage cell of a nineteenth embodiment in front view;

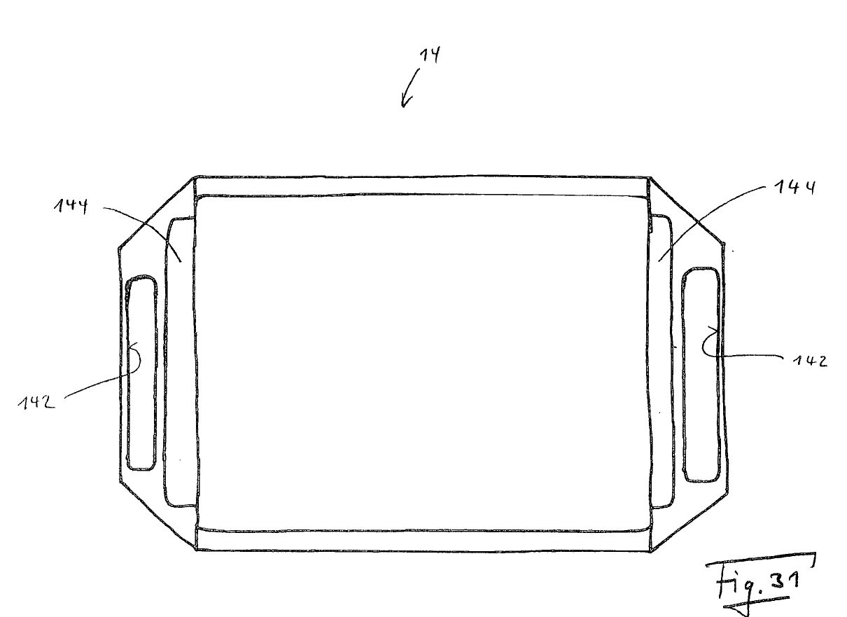

FIG. 43 shows a corner of a storage cell of a twentieth embodiment in front view;

FIG. 44 shows an end region of a storage cell of a twenty-first embodiment in section in the line of sight from above;

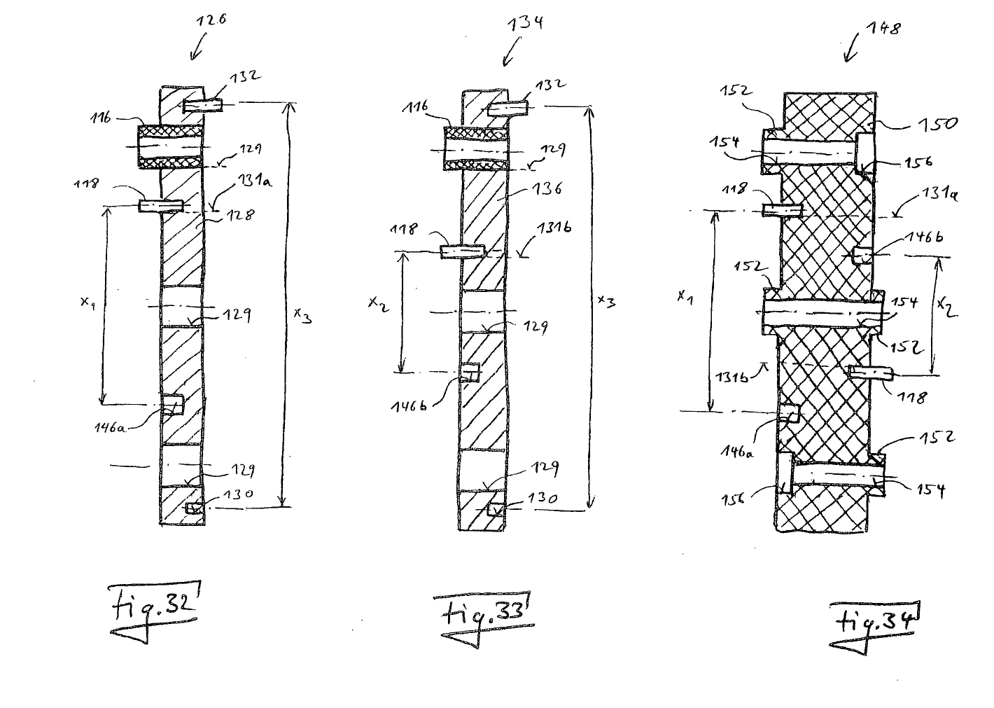

FIG. 45 shows a corner of a storage cell of a twenty-second embodiment in front view;

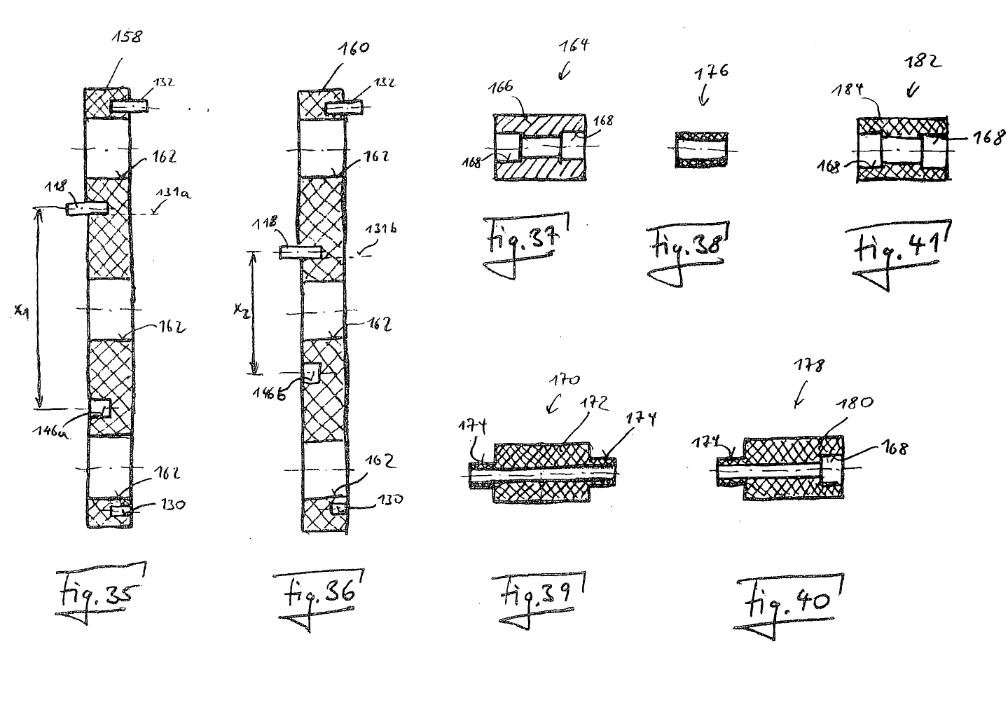

FIG. 46 shows an end region of a storage cell of a twenty-third embodiment in section in the line of sight from above;

FIG. 47 shows a sectional representation of an edge region of a storage cell in a twenty-fourth embodiment of the present invention with a connector in the line of sight from above;

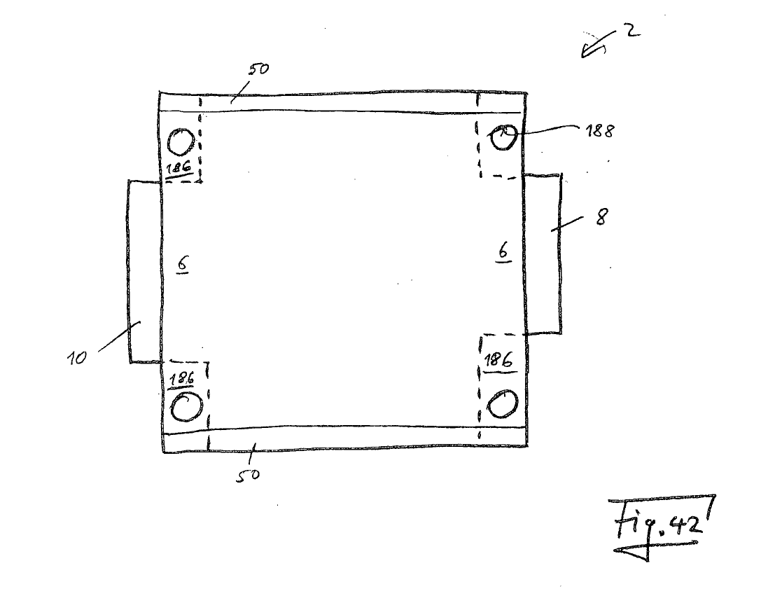

FIG. 48 shows a spacer of the twenty-fourth embodiment in section;

FIG. 49 shows a front view of a storage cell of a twenty-fifth embodiment of the present invention in an installed situation;

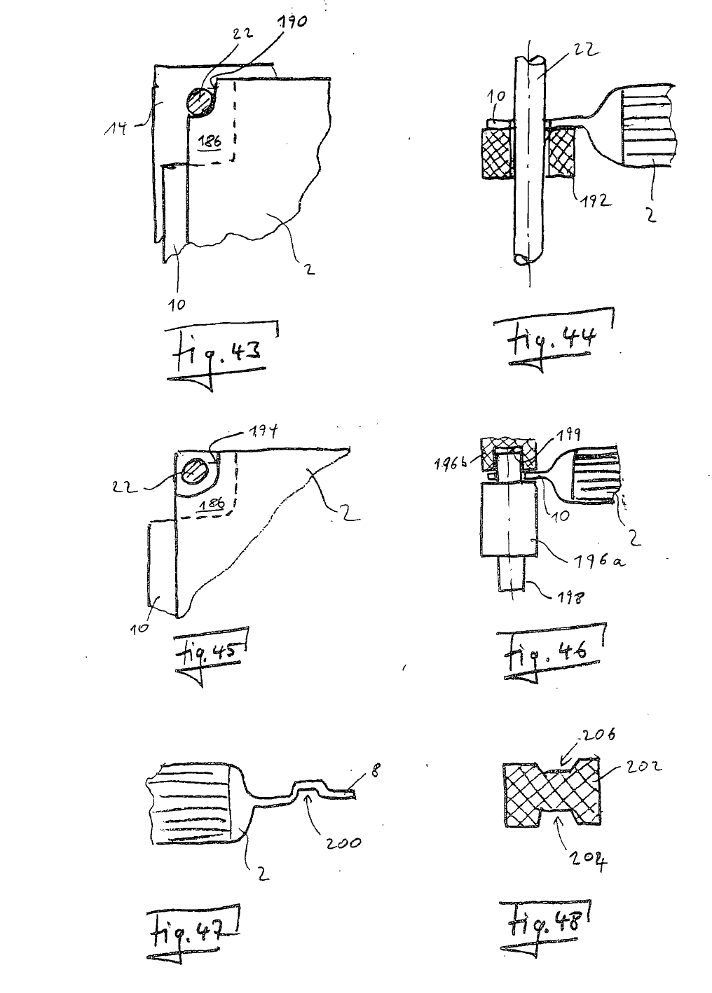

FIG. 50 shows an insulating sleeve of this embodiment in longitudinal section;

FIG. 51 shows a cell block in a twenty-sixth embodiment of the present invention;

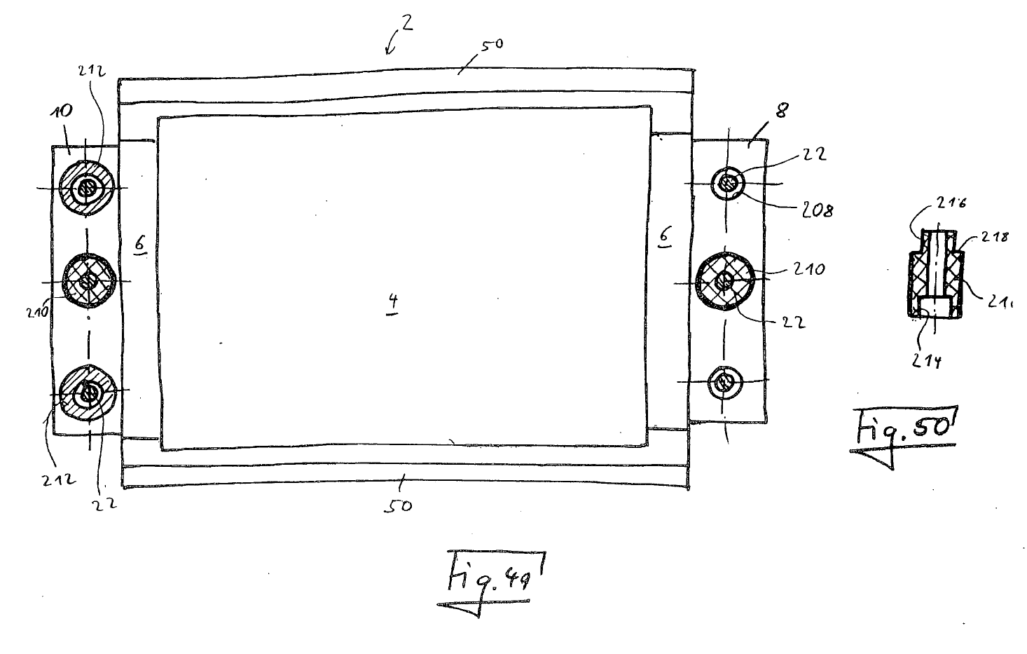

FIG. 52 shows a cell block in a twenty-seventh embodiment of the present invention;

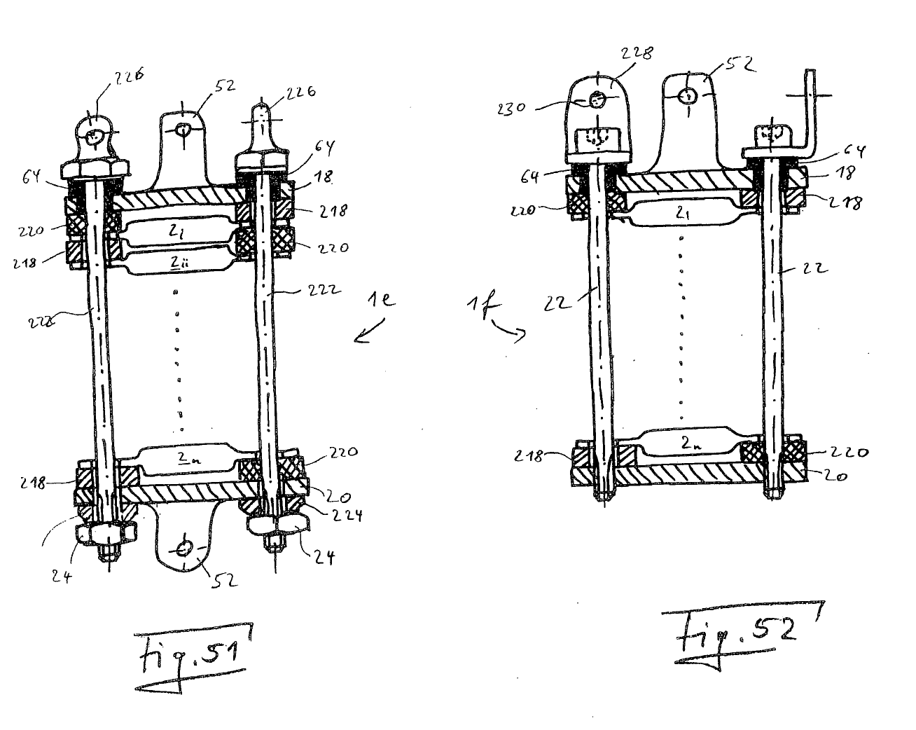

FIG. 53 shows several cell blocks connected to one another in series in a twenty-eighth embodiment of the present invention;

FIG. 54 shows a cell block of a twenty-ninth embodiment of the present invention from above in section;

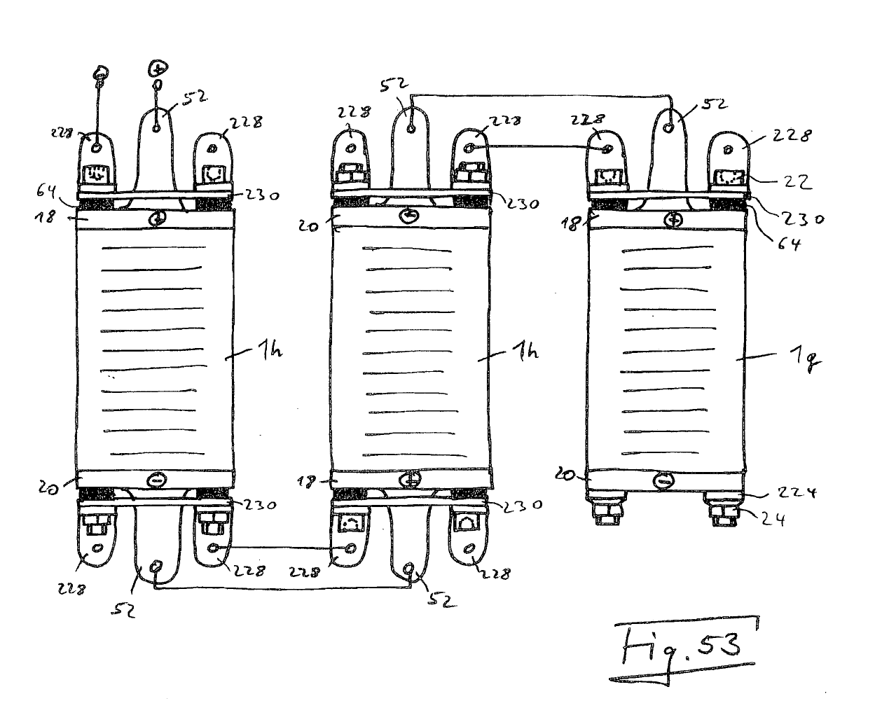

FIG. 55 shows a sectional view of a cell block of a thirtieth embodiment of the present invention from above;

FIG. 56 shows an enlarged view of a contacting clamp from FIG. 55 seen from the cell block;

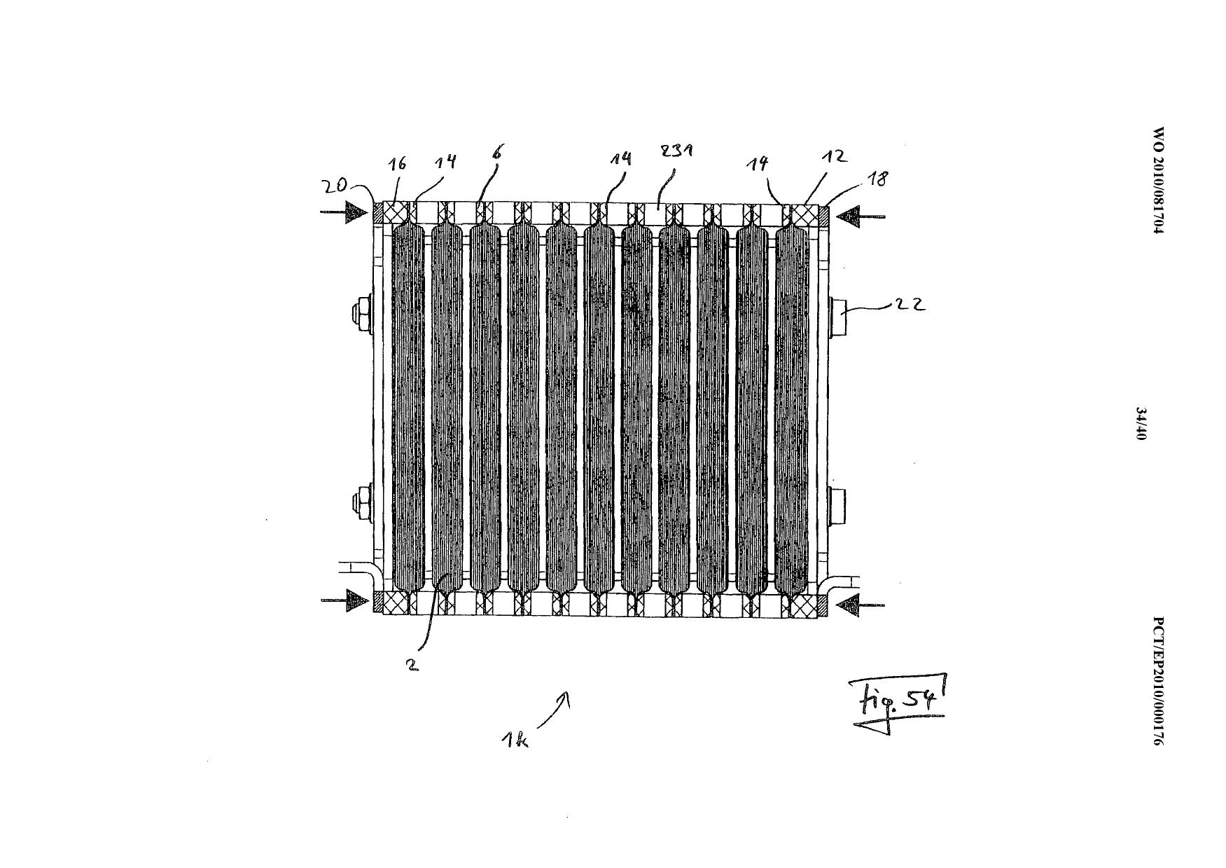

FIG. 57 shows a sectional view of the contacting clamp along a line LVII in FIG. 56 in the direction of the arrow;

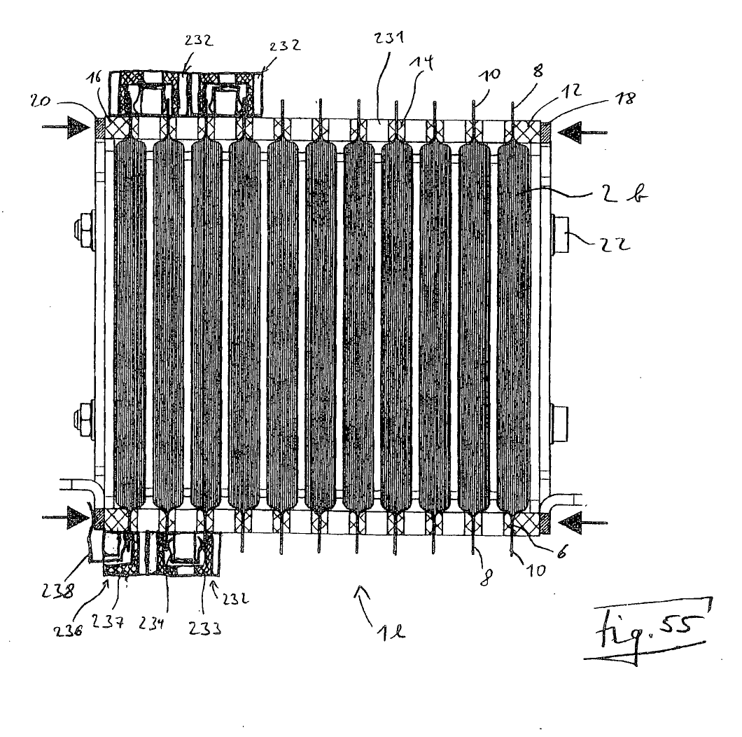

FIG. 58 shows a sectional view of the contacting clamp along a line LVIII in FIG. 56 in the direction of the arrow:

FIG. 59 shows a cell block of a thirty-first embodiment of the present invention in perspective plan view; and

FIGS. 60 through 62 show cell blocks according to the prior art.

It should be noted that the representations in the figures are diagrammatic and are limited to the presentation of the features most important for understanding the invention. It should also be noted that the dimensions and size ratios given in the figures are solely for clarifying the representation and on no account are to be understood as limiting or mandatory.

description of concrete embodiments and possible modifications thereof is provided below. If the same components are used in different embodiments, they are provided with the same or corresponding reference numbers. A repetition of the explanation of features already explained in connection with one embodiment has been largely omitted. Nevertheless, unless explicitly stated otherwise or evidently technically illogical, the features, arrangements and effects of one embodiment can also be applied to other embodiments.

A first embodiment of the present invention will now be explained on the basis of FIGS. 1 through 6. FIG. 1 thereby shows a cell block according to the first embodiment in a perspective partially exploded view, FIG. 2 shows a storage cell and a frame element thereof, FIG. 3 shows a sectional view through a cell block in a plane defined by two lines E1, E2, in the line of sight of an arrow III in FIG. 1, FIG. 4 shows a detail IV in FIG. 3 in the region of the threaded assembly, FIG. 5 shows a perspective overall view with additional connection elements and a control device, and FIG. 6 shows an equivalent circuit diagram of the cell block. (A detail XIII identified in FIG. 3 relates to a different embodiment).

FIG. 1 shows a cell block 1 according to the first embodiment in a perspective partially exploded view, a housing completing the overall arrangement having been omitted. The cell block 1 is the determinant constituent of an electrochemical energy storage device within the meaning of the invention.

A number of in all eleven storage cells 2 are arranged as a stack in the cell block 1. Each storage cell 2 is composed substantially of one active part 4, one inactive edge region 6 and two connectors 8, 10 arranged in the edge zone 6. The storage cells 2 are electrochemical storage cells within the meaning of the invention, the connectors 8, 10 are contact sections within the meaning of the invention and the edge zone together with the connectors 8, 10 forms an edge region within the meaning of the invention.

An electrochemical reaction takes place for storing and releasing electric energy (charge and discharge reaction) in the active part 4. The internal structure of the active part 4, not shown in greater detail in the figure, corresponds to a flat, laminated stack of electrochemically active electrode films of two types (cathode and anode), electrically conducting films for collecting and supplying or discharging electric current to and from the electrochemically active regions, and separator films for separating the electrochemically active regions of the two types from one another. This structure is well known in the art and will not be discussed in greater detail here. As a reference we refer to a storage cell that is described in an application (internal reference no. 105907) filed on the same day as the present application, the disclosure of which is thus incorporated in full by reference.

The active part 4 of the cell 2 is covered in a sandwich-like manner by two films, not designated in further detail in the Figure. The two films are sealed in a gas-tight and moisture-tight manner at their free ends and form a so-called sealed seam, which surrounds the active part 4 as a peripheral, inactive edge zone 6. The sealed seam is folded on two opposite narrow sides and there forms respectively a fold 50, which stabilizes the sealed seam at this point and prevents tearing (cf. FIG. 2).

Two connector 8, 10 project outwards from the interior of the cell 2 on two opposite narrow sides of the cell 2 through the sealed seam and extend as a flat formation in opposite directions. The connectors 8, 10 are connected to the electrochemically active cathodes and anode regions in the interior of the active region 6 and thus serve as cathode and anode connections of the cell 2.

To form the cell block 1, holding frames 12, 14, 16 and pressure plates 18, 20 are furthermore provided, the edges of which, seen from a flat side, respectively describe approximately the same contour. In this order a first pressure plate 18, a first end frame (holding frame) 12, an alternating sequence of storage cells 2 and intermediate frames (holding frame) 14, the sequence beginning and ending with a cell 2, so the number of intermediate frames is smaller by one than the number of cells 2, a second end frame (holding frame) 16 and a second pressure plate 20 are arranged. The entire arrangement described above is held together by four fillister head screws 22 with nuts 24, which act via washers 26 on the pressure plates 18, 20. The pressure plates 18, 20 transfer the pressure exerted by the fillister head screws 22 to the end frames 12, 16 and thus to the arrangement of intermediate frames 14 and storage cells 2. The pressure is thereby substantially exerted by the lateral sections of the holding frames 12, 14, 16 on the connectors 8, 10 of the storage cell 2 respectively located therebetween. The cells 2 are thereby respectively held between two holding frames 12, 14 or 14, 14 or 14, 16. The first end frame 12, the intermediate frames 14 and the second end frame 16 (holding frame) are frame elements within the meaning of the invention. The first and the second pressure plate 18, 20 have a frame form corresponding to the end frames 12, 16. They are pressure plates within the meaning of the invention and with the fillister head screws 22 and nuts 24 as well as the washers 26 jointly form a clamping device within the meaning of the invention. The fillister head screws 22 are thereby tension bars within the meaning of the invention.

The holding frames 12, 14, 16 are made of an insulating material. They therefore form an effective electrical separation between the individual cells 2. The pressure plates 18, 20 however, are made of a conductor material, in particular steel or aluminum or an alloy thereof, and serve at the same time as a potential collector and connector of the entire cell block 1, as is explained below.

The fillister head screws 24 run through through-holes (not designated in greater detail) in the pressure plates 18, 20, through-holes 28, 29 in the holding frames 12, 14, 16 and through-holes 30 in the connectors 8, 10 of the cells 2. The fillister head screws 24 have a smaller diameter than the through-holes 28, 29, 30. Due to the annular distance realized hereby between the outer contour of the fillister head screws 24 and the inner edge of the through-holes 30, an electrical insulation of the fillister head screws 24 and the connectors 8, 10 is realized, so that an accidental connection between connectors 8, 10 of different cells 2 is avoided. The same applies to an electrical insulation with respect to the pressure plates 18, 20, which will be explained in more detail.

In the holding frames 12, 14, 16 on one side through-holes 28 with a comparatively small diameter and on the other side through-holes 29 with a larger diameter are arranged. Contact sleeves 32 of a conductor material are arranged in the larger through-holes 29, while the through-holes 28 on the other side remain free. The contact sleeves 32 are contact connection elements within the meaning of the invention and provide an electrical connection between the connectors of two adjacent storage cells on the same side of the cell block 1. Copper, brass, bronze or the like have proven to be useful as conductor material, however, other materials are also conceivable, such as, for instance steel, aluminum, nickel silver or the like. A silver-plating or gold-plating of the contacts has proven to be useful for reducing the contact resistance between contacts. This applies to all contact elements within the scope of this description.

As is clearly discernible in FIG. 3, which is a sectional plan view of the cell block 1 in a plane running through two of the fillister head screws 22, the storage cells 2 are arranged in the stack with alternating direction of polarity. That is, a connector 8, which forms, e.g., a negative terminal of a cell 2, and a connector 10, which then forms a positive terminal of a cell 2, are arranged respectively alternately on one side of the cell block 1. (FIG. 3 shows the connectors 8 in section only as an outline, while the connectors 10 in section are shown blacked out.) Furthermore, contact sleeves 32 are arranged in holding frames 12, 14, 16 on one side, while they are arranged in the adjacent holding frame on the other side. In this manner, the positive terminal of one cell 2 is always connected to the negative terminal of another cell 2 in the region of the intermediate frames 14. In the region of the end frames 12, 16 the connector not yet connected to a connector of another cell 2 is connected via the contact sleeves 32 in the end frames 12, 16 to the respective pressure plate 18, 20. The pressure plates 18, 20 are made of a conductor material such as steel or aluminum or an alloy thereof and in this manner serve as connectors or terminals of the entire cell block 1; namely the first pressure plate 18 serves, e.g., as the positive terminal of the cell block 1, while the second pressure plate 20 serves as the negative terminal of the cell block 1.

FIG. 4 shows a detail IV in FIG. 3 in the region of a threaded assembly of the second pressure plate 16 and clarifies the arrangement and the electrical connection and insulation respectively of the components with and from one another. The right ends in FIG. 3 of the last and penultimate cell 2ₙ, 2ₙ₋₁ together with the last and penultimate intermediate frame 14ₘ, 14ₘ₋₁ (m=n−1), the end frame 20, a fillister head screw 22 with nut 24 and washer 26 in this section are shown.

As shown in the figure, the connector 8 of the last cell 2ₙ is electrically connected via the contact sleeve 32 in the second end frame 16 to the metallic second pressure plate 20. On the left (not shown in the detail of FIG. 4), the connector 10 of the last cell 2ₙ is connected via the contact sleeve 32 in the last intermediate frame 14ₘ to the connector 8 of the penultimate cell 2ₙ₋₁, as can be seen in FIG. 3. On the right again, the connector 10 of the penultimate cell 2ₙ₋₁ is connected via the contact sleeve 32 in the penultimate intermediate frame 14ₘ₋₁ to the connector (8) of the cell (2ₙ₋₂) arranged in front of it (in the detail of FIG. 4 only a section of the contact sleeve 32 is shown on the lower edge). This is continued in an alternating manner (see FIG. 3) until the first cell is connected via the contact sleeve 32 in the first end frame 12 to the first pressure plate 18.

The through-holes 29 for accommodating the contact sleeves 32 have a larger diameter than the through-holes 28 in which no contact sleeves are accommodated. The inside diameter of the contact sleeves 32 corresponds approximately to the diameter of the through-holes 28 in which no contact sleeves are accommodated, and these are larger than the outside diameter of the fillister head screw 22. In this manner an air gap 56 is formed between the fillister head screw 22 and current-carrying parts 32, 20, (, 18), which provides an electric insulation of the fillister head screw 22. The air gap 56 is also formed between the fillister head screw 22 and the holding frame 14, 16 (, 12) not current-carrying per se, so that there is a clearance here during assembly, which simplifies the assembly of the parts. The washer 26 is an insulating washer, which provides an electric insulation between the nut 24 and the second pressure plate 20 (and on the other side between the fillister head screw 22 and the first pressure plate 18, although not shown in greater detail in this figure). The electric insulation of the fillister head screw from the pressure plates 18, 20 prevents a short circuit between the pressure plates 18, 20 serving as terminals.

In a modification, an insulation, such as in the form of a heat-shrinking sleeve, can also be provided instead of the air gap 56.

Back to the embodiment and to FIGS. 1 and 2, respectively two fitted bores 36 are arranged in the connectors 8, 10 of the storage cells 2, which align with fitted bores 34 in the holding frames 12, 14, 16. Centering pins 38 are inserted in the fitted bores 24 in one of opposite holding frames 12, 14, 16 in each case on the side on which the contact sleeves 32 are arranged in the through-holes 29 in the holding frames 12, 14, 16. During assembly, these centering pins 38 extend through the fitted bores 36 in the connectors 8,10 of a cell 2 and into the fitted bores 34 of the holding frames 12, 14, 16 located opposite. In this manner holding frames 12, 14, 16 and the storage cells 2 located in between are fixed with respect to one another in radial directions (radial directions are understood to mean directions perpendicular to the stacking direction S). The fitted bores 34, 36 and the centering pins 38 form a centering device within the meaning of the invention. The centering pins 38 together with the fitted bores 34, 36 form a centering device within the meaning of the invention.

Respectively three radially extending slots 40 are arranged in the long sides of the intermediate frames 14 (at the top and bottom in FIGS. 1 and 2). The slots 40 connect an interior of the cell block 1 to the surrounding atmosphere. Furthermore, the intermediate frames 14 have jogs 42 on both sides in the thickness direction in each case on the lateral sides seen in the stacking direction (the sides on which the connectors 8, 10 are arranged between the frame elements). The end frames 12, 16 have jogs 42 of this type on only one side in the thickness direction, namely on the side that faces towards an intermediate frame. The jogs 42 of a frame element, which bring about a local reduction in thickness, with the notches 42 of a frame element located opposite form openings 44, which connect the interior of the cell block 1 with the surrounding atmosphere. The openings 44 are thereby respectively divided by the connectors 8, 10. Air flows into the interior of the cell block 1 and out thereof through the slots 40 and the openings 44 and cools (or heats) the storage cells 2 by heat transfer. As is clearest in FIG. 3, the thickness of the frame elements 12, 14, 16 is dimensioned such that there is a distance between the active parts 4 of the cells 2. There is therefore an air chamber in each case between adjacent cells 2, via which air chamber the cells 2 can release or absorb heat. (A heating of the cells 2 is useful at the start, in particular in cool weather, in order to bring the cells 2 to the optimal operating temperature.) A flow regulating device, not shown in greater detail, regulates the air flow rate overall and/or for the individual air chambers. In addition to the possibility of temperature regulation, the openings 40 and jogs 42 also provide a clear reduction in weight of the frame elements.

The end frames 12, 16 have braces 46, which extend between the longer sides and are aligned in the thickness direction with the surfaces facing towards the pressure plates 18, 20. The width of these braces 46 defines an opening cross section for the air fed to the first and last cell on the outside, stabilizes the geometry of the end frames 12, 16, screens the first and last cell 2 in the stack arrangement from the outside. As seen in FIG. 5, moreover, the braces 46 provide an attachment option for a controller 62, which is provided to regulate and balance the cells 2 inside the cell block 1.

It can be clearly seen in FIGS. 1, 2 and 5 that the frame elements 12, 14, 16 as well as the pressure plates 18, 20 have a flat, prismatic shape with an substantially rectangular cross section. Since all of these elements have the same cross section, the entire assembled cell block 1 also forms a prismatic, substantially rectangular contour. The cross section has bevels 48 at the corners, which facilitate handling and save unnecessary mass.

Lugs 52 are also shown there which are embodied in one piece with the end frames 18, 20, and by being bent away therefrom project in the stacking direction S. These lugs 52 serve as terminal connections of the cell block 1. The lugs 52 have respectively one bore 54, which can accommodate a connecting screw 58. Further connecting means, such as a connecting lug 60, can be attached by means of the connecting screw 58. In this manner the cell block 1 can be connected to a supply network, e.g., an onboard power supply of a vehicle. A connection with suitably embodied seats in a housing can also be produced first, which housing has connection terminals for connection to a supply network. These lugs 52 with screws 58 or similar connection means can also be used to attach the cell block 1 in a battery housing. For instance, threaded sleeves located in the battery housing can be used, which accommodate the connecting screws 58. In this manner a special power rail can be omitted.

FIG. 6 shows an equivalent circuit diagram an arrangement of storage cells 2, as described above. (A modification with only nine cells 2 instead of eleven in FIGS. 1, 3, 5 was shown).

The figure shows nine cells 2 with alternating directions of polarity, which cells are connected to one another in series. The connection is carried out according to the embodiment via respectively two contact sleeves 32 (cf. FIGS. 1, 2), which jointly form a contact connection device within the meaning of the invention. The connection terminals form the termination of the series connection, which according to the embodiment are embodied by the pressure plates 18, 20 or the lugs 52 thereof.

The number of cells 2 in a cell block is fundamentally arbitrary. Since the individual storage cells 2 have a uniform cell voltage, the terminal voltage can be adjusted via the number of the cells 2 connected in series. Apart from unavoidable losses, the terminal voltage Uₚ corresponds to the total of the cell voltages Uᵢ, in the present case, therefore, 9×Uᵢ. However, the charging capacity of the total arrangement corresponds only to the charging capacity of the individual cell.

FIG. 7 shows an equivalent circuit diagram of a second embodiment of the present invention. The second embodiment is structurally identical to the first embodiment. The difference is only in the connection of the cells 2 to one another. Namely, here respectively three consecutive cells 2 are combined in a parallel connection, i.e., the nine cells 2 of the cell block form three groups of respectively three cells 2 connected in parallel. To this end, the respectively three cells of one group are arranged in the stack with the same direction of polarity, and the same terminals of the cells 2 of this group are connected to one another via contact sleeves 32. Each group in turn is arranged in the stack with a different direction of polarity to the next group, and the last cell of the one group is connected in series to the first cell of the next group.

Each group of cells 2 connected in parallel has the voltage of an individual cell, but with threefold charging capacity. The total arrangement of groups connected in series therefore has a terminal voltage that corresponds to three times the cell voltage, i.e., only 3×Uᵢ or a third of the terminal voltage in the first embodiment. However, the total capacity is three times as high as in the first embodiment.

By varying and combining parallel connections and series connections, virtually any multiple of the cell voltage and cell capacity can therefore be realized in a very simple manner.

Further variation and combination possibilities result from the series connection and/or parallel connection of entire cell blocks.

FIGS. 8 and 9 show a series connection of four cell blocks as the third embodiment of the present invention. FIG. 8 thereby shows a perspective representation of the arrangement, and FIG. 9 shows a side view of the arrangement, in each case in turn while omitting any possible housing. In turn the arrangement is a determinant constituent of an electrochemical energy storage device within the meaning of the invention.

As shown in the figures, four cell blocks 1 are arranged one behind the other such that the second pressure plate 20 of one cell block is facing towards the first pressure plate 18 of a next cell block. The cell blocks 1 differ from the cell blocks 1 of the first embodiment in that lugs 52a project away from the pressure plate 18 and lugs 52b project away from the pressure plate 20, the tabs 52a, 52b projecting at different heights. The difference in height is measured such that when the cell blocks 1 are pushed together on the front, the lugs 52b of the second pressure plate 20 of the one cell block just fit under the lugs 52a of the first pressure plate 18 of the other cell block. The cell blocks 1 can therefore be respectively connected by means of only two connecting screws 58, which are placed through the respectively aligned bores 54 (not visible) of the lugs 52a, 52b. A connecting sheet is therefore not necessary and between cell blocks 1 arranged one behind the other, and the distance between the cell blocks 1 can be kept to a minimum. For the further connection to a supply network (not shown in further detail), respectively one connecting sheet is provided on lugs 52a, 52b pointing outward of the first and last cell block 1, 1.

As shown in FIG. 9, each cell block 1 bears a controller 62. The cell blocks 1 are therefore individually and separately controllable, and cell blocks 1 can be easily exchanged.

The terminal voltage of the arrangement is four times the terminal voltage of an individual cell block 1.

A series connection of several cell blocks is also possible by arranging cell blocks next to one another.

FIG. 10 shows a series connection of two cell blocks as the fourth embodiment of the present invention, again omitting any housing. The arrangement is again a determinant constituent of an electrochemical energy storage device within the meaning of the invention.

Two cell blocks 1 are respectively assembled like the cell blocks of one of the previous embodiments. They are arranged alternately such that the first pressure plate 18 of the one cell block 1, which here is assumed to be the negative terminal thereof, comes to rest next to the second pressure plate 20 of the other cell block 1, as the positive terminal thereof. A connection between the lugs 52 of a first and a second pressure plate 18, 20 is produced on a end face of the cell blocks 1 by means of a connecting sheet 60. On the other end face the lugs 52 of the respective pressure plates 18, 20 are connected to a supply network via connecting sheets 60 and thus form the negative and positive terminal of the arrangement. The connecting sheets 60 are respectively connected to the respective lugs 52 with the aid of connecting bolts 58 (not shown in further detail).

If even more cell blocks 1 are to be connected in this manner, they must be arranged next to one another respectively with alternating direction of polarity and connected to one another by alternating end faces. The end faces of the first and last cell block not connected to one another respectively form the terminals of the arrangement.

A parallel connection of several cell blocks is possible in a similar manner in order to increase the total capacity of the arrangement.

FIG. 11 shows a parallel connection of two cell blocks as a fifth embodiment of the present invention, again omitting any housing. The arrangement is again a determinant constituent of an electrochemical energy storage device within the meaning of the invention.

Two cell blocks 1 are respectively structured like the cell bocks of one of the previous embodiments. Unlike the fourth embodiment, they are arranged in the same direction in that respective first pressure plates 18, which here are assumed to be positive terminals of the cell blocks 1, and respective second pressure plates 20, as negative terminals of the cell blocks 1, come to rest next to one another. Respectively one connection between the lugs 52 of first pressure plates 18 located next to one another and between the lugs 52 of pressure plates 20 located next to one another of the cell blocks 1 is produced by means of connecting sheets 60. The free lugs 52 of the pressure plates 18, 20 of one of the cell block are connected to a supply network via connecting sheets 60 and thus form negative and positive terminal of the arrangement. The connecting sheets 60 are respectively connected to the respective lugs 52 with the aid of connecting screws 58 (not shown in greater detail).

If even more cell blocks 1 are to be connected in this manner, the arrangement shown is simply to be expanded by adding further blocks.

The arrangements of the third, fourth and fifth embodiment can be combined in order to realize any voltage and capacity values. The concept of the second embodiment can also be incorporated.

A sixth embodiment of the present invention is shown in FIG. 12. Cell blocks 1a, 1a and a cell block 1b are thereby arranged next to one another and connected to one another in series in the manner of the fourth embodiment. The special feature of the sixth embodiment is that cell block 1b is shorter, that is, has a smaller number of storage cells 2 (not shown in greater detail) than cell blocks 1a. In this manner not only can the terminal voltage of the arrangement be adjusted particularly finely, it is also possible to adapt the outer geometry of the arrangement to the available installation space. The arrangement shown in FIG. 12 according to this embodiment, optionally together with a housing and further components, forms an electrochemical energy storage device within the meaning of the invention.

An expansion and adaptation is also possible here by additionally applying the concept of the second, third, fourth and/or fifth embodiment.

The next embodiments are further developments of individual aspects of the first and second embodiment.

FIG. 13 shows a detail of a cell block of a seventh embodiment. The position in the cell block is indicated by a line XIII in FIG. 3, however, the elements shown in FIG. 13 differ in part from those in FIG. 3.

FIG. 13 shows a threaded region of the fillister head screw 22 with the second pressure plate 20 with the nut 24, sections of the last three storage cells 2ₙ, 2ₙ₋₁, 2ₙ₋₂ and the last three intermediate frames 14ₘ, 14ₘ₋₁, 14ₘ₋₂ as well as some contact sleeves 32 in this section.

In contrast to the first embodiment, the nut is not tightened on the pressure plate 20 via a washer 24, but via an insulating bushing 64. The insulating bushing 64 has a collar with sufficient outside diameter to provide a suitable bearing surface for the nut and extends, accommodating the fillister head screw 22, through a through-hole (not designated in greater detail) in the pressure plate 20 and a little into the through-hole 28 in the end frame 16. Where a contact sleeve 32 produces a contact between a storage cell 2 and the end frame 20 (, 18) on the opposite side, the insulating bushing 64 extends a little into the air gap 56 between the fillister head screw 22 and the contact sleeve 32.

In this manner a secure electrical separation of the fillister head screws 22 from the pressure plates 18, 20 as well as a centering of the pressure plates 18, 20 in the radial direction is achieved.

With reference to FIGS. 14 through 17 a cell block of an eighth embodiment is now described, which is a determinant constituent of an electrochemical energy storage device within the meaning of the invention. FIG. 14 thereby shows an assembled state in perspective view, FIG. 15 shows the same without pressure plates and clamping, FIG. 16 shows an end frame in this embodiment in the front view and FIG. 17 shows an intermediate frame in this embodiment in perspective view.

FIG. 14 shows a cell block 1c of the present embodiment in final assembly in perspective view such that the end face of a second pressure plate 20 and the top of the overall contour is prominently visible. In contrast to the first embodiment, the prismatic contour does not show a chamfer of the edges. Instead, on the surface of the cell block 1c a signal cable 66 extends in a channel 68 open at the top, which runs over the entire length of the cell block with the exception of the pressure plates 20, 18. A channel 68 of this type is available in two edges of the prismatic structure. From the end face, the channels 68 are accessible by respectively one access opening 70, which are worked in the second pressure plate 20.

The signal cable 66 is used for the connection of the controller 62, which in this embodiment is screwed to the second pressure plate 20. In the same manner a second controller 72, from which a further signal cable (not shown in further detail) is guided in the other of the channels 68, is screwed to the second pressure plate 20. The second controller is preferably used for the regulation of the heat balance and is connected, e.g., to thermo elements that are attached, for instance, to the storage cells 2 or at another suitable location in the interior of the cell block 1c.

FIG. 15 shows the cell block 1c shown in FIG. 14 once again without the pressure plates 20, 18, so that the end face of the second end frame 16 with the braces 46 is visible. In contrast to the first embodiment, the braces 46 here are not used to attach the controllers.

FIG. 16 shows the second end frame 16 in front view. The second end frame 16 of this embodiment differs from the second end frame 16 of the first embodiment in that respectively one notch 74 with a U-shaped cross section is worked in the surface to the left and right, while the corners have only one chamfer 84 instead of a clearer bevel. At the bottom of the notches 74 connection elements 76, 78 are discernible in the right and left channel 74 respectively. Single lines of the signal cable 66 are to be connected thereby.

FIG. 17 shows an intermediate frame 14 according to this embodiment in perspective view. The intermediate frame 14 also bears notches 74 at a corresponding location on the surface. All of the notches 74 on one side of all intermediate frames 14 and the end frames 12a, 16 form a channel 68. The intermediate frame 14 of this embodiment differs furthermore from the intermediate frame 14 of the first embodiment by a passage 80, which is embodied immediately below one of the notches 74. The passage 80 is provided in order to accommodate a rivet or the like to attach an LV contact and in the embodiment shown is a circular blind hole, thus has in particular a smaller depth than the thickness of the intermediate frame 14. The passage 80, although not shown in greater detail, can have a connection to the notch 74. A connection of this type can have the width of the diameter of the passage 80 or a smaller width.

In one modification, the passage 80 can also be embodied as a through-hole. All of the passages thus form an inner channel under the channel 68 accessible from outside, in which an interior control line or control elements can be accommodated.

Another difference to the first embodiment relates to the position of the fitted bores and centering pins.

On the one hand, the pairs of fitted bores on different lateral sides of the intermediate frame 14 have different distances from one another. That is, the first pair of fitted bores 34a, which is located on the one of the lateral sides of the intermediate frame 14, has a distance x₁ from one another, which is greater than a distance x₂ of the second pair of fitted bores 34b, which is located on the lateral side located opposite. In a corresponding manner the fitted bores in the connectors of the storage cells 2 also have different distances (not shown in greater detail). In order to code the assembling position of the storage cells 2 in this manner, i.e., to realize a reverse polarity protection within the meaning of the invention, e.g., the fitted bores are always arranged on the positive connector of a storage cell 2 at the larger distance x₁, while on the negative connector of a storage cell 2 they are always arranged at the smaller distance x₂.

To code the circuit, several types of intermediate frames 14 are to be provided. To this end, for orientation in FIG. 17 the visible end face of the intermediate frame 14 is labeled as the front side V and the end face that is not visible, as the back or rear side H, and the lateral sides are labeled left (L) and right (R).

In a first type of intermediate frame 14, the fitted bores 34a, 34b are embodied in the intermediate frame 14 as blind holes and different in a crosswise manner. That is, fitted bores 34a are embodied as blind holes at the larger distance x₁ on the left front side V:L and the right rear side H:R, while fitted bores 34b are embodied as blind holes at the smaller distance x₂ on the left rear side H:L and the right front side V:R. The through-holes 28 with the smaller diameter are thereby embodied on the right lateral side R, and the through-holes 29 with the larger diameter to accommodate the contact sleeves 32 are embodied on the left lateral side L.

In a second type of intermediate frame (14′, not shown in the figure), the fitted bores 34a, 34b in the intermediate frame 14 likewise differ crosswise as blind holes, but embodied the other way around from the first type. That is, fitted bores 34a are embodied as blind holes at the larger distance x₁ on the right front side V:R and the left rear side H:L, while fitted bores 34b are embodied as blind holes at the smaller distance x₂ on the right rear side H:R and the left front side V:L. The position of the through-holes 28, 29 and contact sleeves 32 is likewise the reverse of those in the first type 14. That is, the through holes 28 with the smaller diameter are embodied on the left side L and the through-holes 29 with the larger diameter to accommodate the contact sleeves 32 are embodied on the right side R.

A series connection of two cells 2 is coded by alternating arrangement of the intermediate frames of the first and the second type. Fitted bores with the same distance always lie opposite one on two sides of the intermediate frames facing one another, but only two consecutive cells 2 with opposite terminal location can be arranged on the front and rear side of an intermediate frame, since the fitted bores arranged on the front and rear side have a different distance on each lateral side, i.e., code different terminal locations. Furthermore, the sides with contact sleeves are always arranged alternately on the left and right in consecutive intermediate frames. This ensures that on one lateral side, L, R of an intermediate frame a connector of a first polarity is always connected on the front V to a connector of the second polarity on the rear H, while no connection of the connectors on the front and rear is carried out on the other lateral side R, L. This corresponds to the series connection in FIG. 6.

In a third type of intermediate frame (14″, not shown in the figure) all of the fitted bores 34a, 34b are embodied continuously, for example, the fitted bores 34a are embodied continuously at the larger distance x₁ on the left side L, while the fitted bores 34 are embodied continuously at the smaller distance x₂ on the right side R. Furthermore, the larger through-holes 29 are arranged with the contact sleeves 32 (not shown in the figure) on both lateral sides L, R. A parallel connection of two cells 2 is coded hereby, since two consecutive cells 2 can be arranged only with the same terminal location. That is, a connector with a first polarity is always arranged on the rear H of an intermediate frame 14′ and a connector with the same polarity is always arranged on the front V of the next intermediate frame 14′.

The third type of intermediate frame is used, for instance, in an arrangement according to the second embodiment according to FIG. 7 between the storage cells connected in parallel 2ᵢ with 2ᵢᵢ, 2ᵢᵢ with 2ᵢᵢᵢ, 2ᵢᵥ with 2ᵥ, etc. With the transition to a series connection of two groups of cells connected in parallel, e.g., 2ᵢᵢᵢ with 2ᵢᵥ and 2ᵢᵥ with 2ᵥᵢᵢ in FIG. 7, an intermediate frame of the first or second type is used.

In the end frames 12a, 16 fitted bores 34a, 34b are embodied as blind holes only on the side facing towards an intermediate frame. Their location results from the desired direction of polarity of the first or last storage cell 2.

On the other hand, the fitted bores 34a, 34b are embodied in the region of the jogs 42, thus in the areas of reduced material thickness, while the through-holes 28, 29 are embodied in areas of full material thickness, which form pressure surfaces 86 for transferring the clamping pressure of the fillister head screws 22 to the edge regions 6, in particular the connectors 8, 10 of the storage cells 2. This permits a slight clearance during assembly and a slight “give” of the elements relative to one another during operation, since the centering pins 38 run through free space over a small distance.

In a modification of the eighth embodiment, the fitted bores 34a, 34b are also embodied as blind holes in the third type of intermediate frame, the bore depth being less than half of the material thickness. This simplifies assembly, since the centering pins 38 come across a stop during insertion.

In a further modification of the eighth embodiment, the fitted bores 34a, 34b, like the through-holes 28, 29, are embodied in the pressure surfaces 86. The centering can hereby be realized more precisely, but also requires a higher manufacturing accuracy. One could also say that in this modification the centering pins 38 are used for reverse polarity protection at the same time.

In a further modification of the eighth embodiment, the lower corners of the frame elements 12a, 14, 16, 18, 20 are provided with a clearer bevel (like the bevels 48 of the first embodiment), for reasons of weight, for example, instead of the chamfers 84.

In FIGS. 18 and 19 a cell block and several of these cell blocks connected in series are shown as the ninth embodiment of the present invention. FIG. 18 thereby shows a perspective representation of an individual cell block according to this embodiment, and FIG. 19 shows a side view of the arrangement of four cell blocks connected in series according to this embodiment, in each case again with any housing being omitted. The arrangement as well as the individual cell block is again a determinant constituent of an electrochemical energy storage device within the meaning of the invention.

The cell block 1d shown in FIG. 18 has two channels 68 on the top, as in the eighth embodiment. In its structure it differs due to a changed type of connection terminals. And in this embodiment the pressure plates 18, 20 have lugs 52c, which project laterally in the same plane beyond the prismatic contour of the cell block 1d. With this type of embodiment of connecting lugs no bending is necessary. Instead the production of the pressure plates is limited substantially to a punching operation.

The connection of several cell blocks 1d of this embodiment in series is shown in FIG. 19. There four cell blocks 1d are arranged one behind the other in the stacking direction. The first pressure plate 18 of a cell block 1d is screwed to the second pressure plate 20 of the next cell block 1d via connecting screws 58 and a connecting nut 88, a spacer sleeve 90 being arranged between the first pressure plate 18 of the one cell block 1d and the second pressure plate 20 of the next cell block 1d to maintain a necessary minimum distance.

The pressure plates 18, 20 furthermore have depressions 82 for accommodating the heads of the fillister head screws 22 or of the washers 26. The necessary distance between the cell blocks 1d can hereby be reduced.

FIGS. 20 and 21 show a storage cell according to a tenth embodiment. FIG. 20 is thereby a perspective view of the storage cell, and FIG. 21 is a plan view, i.e., a view on the upper narrow side of the storage cell of this embodiment.

The storage cell 2 according to the representation in FIG. 20, as in the previous embodiments, has an active part 4, an edge region 6 surrounding it and two laterally projecting connectors 8, 10. The edge region 6 formed by two casing films (not designated in greater detail) placed one on top of the other and sealed to one another is folded in the upper and lower part to form a fold 50. Where the connectors 8, 10 run between the two casing films, the edge region 6 respectively has a thickened region 92.

In this embodiment, the fold 50 is embodied such that its thickness t is equal to the thickness of the connectors 8, 10. That is, the thickness t of the fold 50 is somewhat less than the thickness of the thickened regions 92.

In this manner the end faces of the frame elements 12, 14, 16 exert a uniform pressure on the connectors 8, 10 and the fold 50 and hold the storage cell 2 particularly securely. The transitions and connections between connectors 8, 10 and the casing films in the edge region 6 as well as the connections between the connectors 8, 10 and the current-carrying films in the interior of the active part 4, are exposed to lower mechanical stresses.

Furthermore, two elastic cushions 94 are attached to a end face of the cell 2 of this embodiment in the region of the active part 4. The cushions 94 are made of an elastic material such as foam, sponge rubber or the like and attached directly, i.e., adhered or sprayed on, to the oversheath of the active region 4. This simplifies assembly and prevents the cushions 94 from slipping or falling off during handling or in operation. The thickness thereof is somewhat greater than the distance between two cells 2 in a cell block 1, so that a reliable and gentle elastic support in the axial, i.e., stacking direction of the cells 2 is given. In this manner oscillations of the cells 2 are effectively buffered. For reasons of stability the cushions 94 are arranged in the stacking direction aligned with the braces 46.

The cushions 94 are spring elements within the meaning of the invention. The spring behavior can be adapted by means of the use of several elastomer materials and the surfaces.

FIGS. 22 through 25 show elements of one cell block in an eleventh embodiment of the present invention. FIG. 22 is thereby a perspective representation of two storage cells in their arrangement in the cell block with contact strips according to this embodiment, FIG. 23 is a plan view, that is, a view from above on the long narrow sides of the storage cells, FIG. 24 is a perspective representation of a contact strip of this embodiment and FIG. 25 is a front view of an intermediate frame of this embodiment.

FIG. 22 shows two consecutive storage cells 2, and 2ᵢ₊₁, which are representative of a multiplicity of cells 2, in their arrangement in the cell block according to this embodiment in a perspective representation. FIG. 23 shows this arrangement in a plan view (arrow XXIII in FIG. 22).

Elastic cushions 95 are attached to the flat sides of the active parts 4 of the cells 2. These are smaller than the elastic cushions 94 of the tenth embodiment. In particular, they have a shorter length and two cushions 95 are arranged one above the other in the direction of the height of the cells 2. The arrangement of the cushions 95 further differs from that of the cushions 94 of the tenth embodiment in that respectively two cushions 95 are arranged on the front as well as on the rear of the cells 2, but only on the lateral half of the connector 8, while no cushions are arranged on half of the connector 10. The function of the cushions 95 corresponds to that of the cushions 94 of the tenth embodiment. In addition, in this embodiment the direction of polarity of the cells 2 is coded, so that for instance the cushions 95 are arranged only on the side of the positive terminal. In this manner, by alternating installation, such that the cushions 95 lie once on the right side and next time on the left side, the cells 2 are always arranged such that the terminals are correctly oriented for a series connection. In this embodiment the cushions 95 are therefore also a reverse polarity protection device within the meaning of the invention.

The contacting of the connectors 8, 10 in this embodiment is not carried out by sleeves, but by bar-shaped contact strips 96. These have the basic shape of a cuboid, elevations projecting from two opposite long sides, which form contact surfaces and pressure surfaces 100 for contacting with the connectors 8, 10. There are corresponding recesses or jogs 102 between the pressure surfaces 100. The pressure surfaces 100 of opposite elevations are connected by through-holes 98. The fillister head screws (22, not shown in greater detail here) for bracing the cell block run through these through-holes 98, which are aligned with corresponding through-holes 30 in the connectors 8, 10.

The contact strips 96 are made of a conductive material, such as, for instance, copper, brass, bronze or the like, and are contact connection elements within the meaning of the invention. Compared to the contact sleeves 32 of other embodiments, the pressure surfaces 100 of the contacts trips 96 are used completely as contact surfaces. The transition resistance between connected connectors 8, 10 is therefore lower in this embodiment.

As in the first embodiment, the depressions 102 form lateral openings, through which air can flow in the interior of the cell block to regulate the temperature of the cells 2.

Several ribs 104 running in a longitudinal manner project from a long side of the contact strips 96, which stands perpendicular to the pressure surfaces 100. The ribs 104 point in the direction of the interior of the cell block and serve as cooling surfaces, which are flowed around by the cooling fluid flowing through the openings 102. The ribs 104 are embodied in a suitable manner so that the best possible heat transfer is generated. The conventional methods of heat engineering can be applied here. For example, the ribs 104 are particularly effective if they are arranged in the flow direction (with forced convection) or in the direction of gravitational force (with natural convection). Furthermore, the flow paths are designed so that the most turbulent flow possible is opposed. In this manner the contact strips 96 serve overall as heat sinks, with the aid of which heat generated in the active parts 4 of the cells 2 can be dissipated via the connectors 8, 10.

FIG. 25 shows an intermediate frame 14 in this embodiment in a front view. On the right side through-holes 28 are provided to accommodate the fillister head screws (22, not shown in greater detail). Likewise, between pressure surfaces 86 jogs 42 are provided, which form openings for the cooling fluid to flow in or flow out. Centering pins 38 are arranged in corresponding fitted bores 34 in the surfaces of the jogs 42. On the left side an indentation 106 is embodied such that only a narrow web 108 holds the top and bottom of the intermediate frame together. The indentation 106 is dimensioned such that a contact strip (96) can be placed precisely between two fitting surfaces 110. Towards the inside of the intermediate frame 14, the fitting surfaces 110 are expanded in the manner of a cut-out 112. When the contact strip (96) is installed the ribs (104) thereof come to rest in the region of the cut-out 112, so that cooling fluid flowing around can also flow off upwards and downwards there. The web 108 has jogs 42 in the manner already described, which form openings aligned with the jogs (102) of the contact strip (96).

It should be noted that with this embodiment three fillister head screws (22) are provided for each lateral side. That is, in the contact strips 96 respectively three through-holes 98 are provided in corresponding elevations, in the frame elements 12, 14, 16 respectively three through-holes 28 are provided on those of the lateral sides which lie opposite the indentation 106 to accommodate a contact strip 96, with the storage cells 2 respectively three through-holes 30 are provided in each connector 8, 10, and the pressure plates 18, 20 also have three through-holes on each lateral side.

It should also be noted that in this embodiment all of the through-holes 30, 28, 98 have the same diameter and larger through-holes (29 in the first embodiment) to accommodate contact sleeves are not necessary, since the contact strips 96 already produce the contact between adjacent connectors 8, 10.

The modification is also conceivable in this embodiment that the fitted bores 34 and centering pins 38 are arranged in the region of the pressure surfaces 86 instead of the jogs 42.

FIGS. 26 through 31 show elements of a cell block in a twelfth embodiment of the present invention. FIG. 26 is thereby a perspective representation of a storage cell in its arrangement in the cell block with contacting bars according to this embodiment, FIG. 27 is an exploded view according to FIG. 26, an insulation bar being shown in addition, FIG. 28 is a cross-sectional view of a semi-bar for contacting a positive connector, FIG. 29 is a cross-sectional view of a semi-bar for contacting a negative connector, FIG. 30 is a cross-sectional view of the insulation bar from FIG. 27 and FIG. 31 is a front view of an intermediate frame of this embodiment.

FIG. 26 shows in perspective view a storage cell 2 of this embodiment with two contacting bars 114, 122 which are arranged on the same axial side of the connectors 8, 10. The contacting bars 114, 122 are used for the contacting of connectors 8, 10 of adjacent cells 2. That is, the arrangement shown realizes a parallel connection to a next cell 2 (not shown in greater detail), which is arranged in the same direction of polarity as the cell 2 shown in the cell block, such as, for instance, the cells 2ᵢᵥ and 2ᵥ in FIG. 7. The contacting bar 114 thereby contacts the connectors 8 (on the right in the drawing) of the adjacent cells to one another, and the contacting bar 122 contacts the connectors 10 (on the left in the drawing) of the adjacent cells to one another. The connector 8 is assumed to be positive (plus) and the connector 10 is assumed to be negative (minus). The contacting bar 114 is therefore a contacting bar plus-to-plus and the contacting bar 122 is a contacting bar minus-to-minus. To realize a series connection, contacting bars plus-to-minus are also provided, which are explained later.

Insulating sleeves 116 and coding pins 118 project from each contacting bar through respective holes in the connectors 8, 10 of the cell 2. The arrangement of these components is clearer from the exploded drawing of FIG. 27.

FIG. 27 shows the arrangement from FIG. 26 in an exploded view. In addition, an insulating bar 124 on the other side of the connector 10 and a section of a fillister head screw 22 are shown, which extends through one of the insulating sleeves 116. Three through-holes 121 are respectively arranged in the surface of the connectors 8, 10, through which through-holes the insulating sleeves 116 of the contacting bars 114, 122 extend. Furthermore, two continuous coding bores 120a are arranged at a distance x₁ in the surface of the connector 8, through which the coding pins 118 in the coding bar plus-to-plus 114 extend. Two continuous coding bores 120b are arranged at a distance x₂ in the surface of the connector 10, through which the coding pins 118 in the coding bar minus-to-minus extend. The distance x₁ is larger than the distance x₂. That is, the positive or negative polarity is coded via the distance x₁, x₂. The coding pins 118 and the coding bores 120a, 120b realize a reverse polarity protection device within the meaning of the invention.

Furthermore, three through-holes 121 are respectively arranged in the surface of the connectors 8, 10, through which through-holes the insulating sleeves 116 of the contacting bars 114, 122 extend. On the other side of the connector 10, an insulating bar 124 is shown. This has through-holes 138, into which the insulating sleeves 116 of the contacting bar 122 extend in assembly. The diameter of the through-holes 138 of the insulating bar 124 corresponds to the outside diameter of the insulating sleeves 116. The inside diameter of the insulating sleeves 122 corresponds to the diameter of the fillister head screws. The insulating sleeves 116 with the through-holes 121, 140 thus realize a centering device within the meaning of the invention.

The structure of the contacting bars and the insulating bar is now explained in more detail based on the sectional representations of FIGS. 28 through 30.

FIG. 28 shows a semi-bar 126, which is coded for contacting a positive connector 8 (referred to below as semi-bar plus 126). Two semi-bars plus 126, which are assembled with their rears towards one another later form a contacting bar plus-to-plus 114. The semi-bar plus 126 is composed substantially of a base plate (base plate plus) 128 of conducting material such as, for instance, copper, brass, bronze or another metal or another metal alloy, in which a number of holes have been made. Namely three through-holes 129 are provided, which correspond to the subsequent position of the fillister head screws (22). One insulating sleeve 116 each is arranged in the through-holes 129. The length of the insulating sleeves is greater than the thickness of the base plate plus 128 plus the thickness of a connector 8. Furthermore, on one side (here labeled as the rear) of the base plate 128, two fitted bores 130 are arranged as blind holes, namely in an upper and lower edge region outside the region of the through-holes 129. The distance of the fitted bores 130 is labeled in the FIG. by x₃. A dowel pin 132 is placed in one of the fitted bores 131. On the other side (here labeled as front or contacting side) of the base plate 128, two blind holes 131a are arranged at a distance x₁, in which respectively a coding pin 118 is placed. This semi-bar 126 is thus coded as a semi-bar of a plus side.

If two semi-bars 126 are arranged with their rears towards one another such that respectively the dowel pin 132 of a semi-bar 126 lies opposite a free fitted bore 131 of the other semi-bar, the two semi-bars 126 can be joined to form a contacting bar plus-to-plus 114.

FIG. 29 shows a semi-bar 134, which is coded for contacting a negative connector 10 (referred to below as semi-bar minus 134). Two semi-bars minus 134, which are assembled with their rears towards one another, later form a contacting bar minus-to-minus 122. The semi-bar minus 134 is composed substantially of a base plate (base plate minus) 136 of conducting material, which differs from the base plate plus 128 of the semi-bar plus 126 only in that two blind bores 131b with the distance x₂ are made instead of the blind bores 131a with the distance x₁. This semi-bar 134 is thus coded as a semi-bar of a minus side. The statements on the semi-bar plus 126 apply to the other details, bores and equipment.

If two semi-bars 134 are arranged with their rears towards one another such that respectively the dowel pin 132 of the one semi-bar 134 lies opposite a free fitted bore 131 of the other semi-bar, the two semi-bars 134 can be joined to form a contacting bar minus-to-minus 122.

If one semi-bar plus 126 and one semi-bar minus 134 are arranged with their rears towards one another such that the dowel pin 132 of the semi-bar 126 lies opposite the free fitted bore 131 of the other semi-bar 134 and vice versa, and if the semi-bars are joined in this manner, a contacting bar plus-to-minus (not shown in greater detail) is formed, which is used in a series connection.

In a parallel connection of several cells 2, the contacting bars 114, 122 are arranged such that a contacting bar 114, 122 with insulating sleeves 116 and coding pins 118 is followed by a contacting bar 114, 122 without insulating sleeves and coding pins, etc. In a modification, in each contacting bar 114, 122 a semi-bar 126, 132 can also be respectively provided with insulating sleeves 116 and coding pins 118, and the other semi-bar 126, 132 not. In this manner it is ensured that a projecting element (insulating sleeve 116, coding pin 118) always meets a corresponding hole 129, 131.

With the transition from a parallel connection to a series connection, and in a series connection anyway, it is necessary on one side to connect a positive terminal (connector 8) of a cell 2 to a negative terminal (connector 10) of an adjacent cell 2, and to insulate the two other terminals of these adjacent cells from one another. The insulating bar 124 is used for this purpose, which is shown in section in FIG. 30.

The insulating bar 124 is substantially composed of a plate 137 made of insulating material, such as plastic, hard rubber, ceramic material or the like, and is twice as thick as the semi-bars 126, 134. Three through-holes 138 are provided at distances that correspond to the positions of the fillister head screws (22). Two coding bores 140a having the distance x₁ are arranged on one side of the plate 137, and two coding bores 140b having the distance x₂ are provided on the other side.

The diameter of the through-holes 138 corresponds to the outside diameter of the insulating sleeves 116, and the diameter of the coding bores 140a, 140b corresponds to the diameter of the coding pins 18. When assembled, the insulating sleeves 116 and coding pins 18, which are disposed in the respective next contacting bars, extend through corresponding bores 121, 120a, 120b of the connectors 8, 10 of a secondary cell 2 and into the through-holes 138 and coding bores 140a, 140b of the insulating bar. In this way, the relative positions of the elements in the cell block are radially centered and the elements can be mounted protected against polarity reversal. Because the fillister head screws are always guided in insulating sleeves 116, they are reliably insulated with respect to the connectors 8, 10, the contacting bars 114, 122 and the pressure plates 118, 120.

FIG. 31 shows an intermediate frame 14 in this embodiment in an end face view. This frame has a particularly simple and symmetrical design. Elongated recesses 142, the contour of which corresponds to the outside contour of the contacting and insulating bars, are provided in the actual frame structure in the lateral webs. A free space 144 having a low material thickness accommodates the slightly greater thickness of the edge region 6 around the connectors 8, 10 of the secondary cell 2, so that clamping pressure is primarily applied only to the connectors 8, 10 via the contacting and insulating bars.

It should be noted that in this embodiment only one kind of intermediate frame 14 is required, which is symmetrical and has a particularly simple geometry. The manufacturing complexity is thus low, fewer differing individual parts must be stored, and during assembly no attention is required in terms of the correct installation position because contacting takes place solely by way of the contacting and insulating bars.

For assembly, merely sub-assembled semi-bars plus 126, sub-assembled semi-bars minus 134 and insulating bars 124 must be available, which are each sub-assembled with insulating sleeves 116 and coding pins 118. The semi-bars can be assembled into contacting bars plus-to-minus without the risk of confusion and mounted with correct polarity. If, in addition to series connections, parallel connections of secondary cells 2 are also to be implemented within a cell stack, the semi-bars 126, 134 must additionally be available with insulating sleeves 116 and coding pins 118, and without the same. In this case as well, mix-ups of parts or incorrect installation positions become apparent during assembly, or such errors become impossible. Of course it is also possible to individually store base plates 128, 136, insulating sleeves 116, coding pins 118 and dowel pins 132, and they can be mounted not until the installation of the cell block, which offers the greatest possible flexibility.

The insulating sleeves 116 are introduced in the through-holes 129 of the semi-bars 126, 134 with comparatively low friction. Assembly, for example, requires only little force, and disassembly is possible. The dowel pins 132 are firmly seated in the fitted bores thereof and reliably hold the semi-bars 126, 134 together. The coding pins 118 are likewise firmly seated in the blind holes 131a, 131b thereof. To prevent jamming in opposing semi-bars, the coding pins are considerably undersized at one end, or even have a smaller diameter than at the other end. Because the centering of the components in the radial direction is already achieved by the insulating sleeves 116, the coding pins 118 no longer have to fulfill this task. They should therefore only have a firm seat in the blind holes in the sub-assembled contacting bars, so that they cannot fall out; loose play in the opposing bores in the completely assembled state of the cell stack does not impair the coding function.

A thirteenth embodiment uses the same frames 14 as is described in the twelfth embodiment with reference to FIG. 31. Again, contacting and insulating bars are used for interconnecting the secondary cells, and these have the same outside contours at the end faces as in the twelfth embodiment. In details, however, the contacting and insulating bars exhibit differences over the twelfth embodiment. The individual parts of the thirteenth embodiment are illustrated in FIGS. 32 to 34. FIG. 32 shows a cross-sectional view of a semi-bar for contacting a positive connector, FIG. 33 shows a cross-sectional view of a semi-bar for contacting a negative connector, and FIG. 34 shows a cross-sectional view of an insulating bar.

FIG. 32 shows a semi-bar (semi-bar plus) 126 of this embodiment, which is coded for the contacting of a positive connector 8. The semi-bar plus 126 of this embodiment is substantially composed of a base plate (base plate plus) 128 made of conducting material and, as in the previous embodiment, is provided with three through-holes 129, which correspond to the subsequent positions of the fillister head screws (22), and two fitted bores 130 are provided on a back side as blind holes, in the upper one of which a dowel pin 132 is disposed, while the bottom one remains open. An insulating sleeve 116 is only disposed in the upper through-hole 129 and protrudes beyond the surface of the base plate 128 on the front. The front of the base plate 128 further comprises a fitted bore 131a and a coding bore 146a, each being designed as a blind hole, having the distance x₁, wherein the fitted bore 131a is the upper one of the two bores. A coding pin 118 is inserted in the fitted bore 131a.

FIG. 33 shows a semi-bar (semi-bar minus) 134 of this embodiment, which is coded for the contacting of a negative connector 10. The semi-bar minus 134 is substantially composed of a base plate (base plate minus) 136 made of conducting material, which differs from the base plate plus 128 of the semi-bar plus 126 only in that, instead of the fitted bore 131a and the coding bore 146a having the distance x₁, a fitted bore 131b and a coding bore 146b are introduced as blind holes having the distance x₂, wherein the fitted bore 131b is the upper one of the two bores. The description of the semi-bar plus 126 applies to the remaining details, bores and fitting. In particular a protruding insulating sleeve 116 is also disposed only in the upper through-hole 129 on the semi-bar minus 134, and a coding pin 118 is disposed in the fitted bore 131b.

When two semi-bars plus 126 are disposed with the backs thereof relative to one another such each dowel pin 132 of the one semi-bar 126 is located opposite of an open fitted bore 131 of the other semi-bar, the two semi-bars 126 can be joined to form a contacting bar plus-to-plus. However, when two semi-bars minus 134 are disposed with the backs thereof relative to one another such each dowel pin 132 of the one semi-bar 134 is located opposite of an open fitted bore 131 of the other semi-bar, the two semi-bars 134 can be joined to form a contacting bar minus-to-minus. Contacting bars plus-to-plus and minus-to-minus are used in a parallel connection of secondary cells 2.

When a semi-bar plus 126 and a semi-bar minus 134 are disposed with the backs thereof relative to one another such that the dowel pin 132 of the semi-bar 126 is located opposite of the open fitted bore 131 of the other semi-bar 134, and conversely, and when the semi-bars are joined, a contacting bar plus-to-minus is formed, which is used in a series connection and for a transition between a parallel connection and a series connection.

FIG. 34 shows an insulating bar 148 in this embodiment. The insulating bar 148 is substantially composed of a cuboid base body 150 made of insulating material and is twice as thick as the semi-bars 126, 134. Elevations 152 are configured on the front at the top, which have a circular cross-section. Likewise, two such elevations 152 are configured on the back in the center and at the bottom. This means that in the height direction, two elevations 152 are located opposite of one another at the center. The elevations 152 are disposed at distances that correspond to the positions of the fillister head screws (22), and in these locations through-holes 154 are introduced in the base body 150 and in the elevations 152, respectively. Depressions 156 are introduced in the surface of the base body 150 concentrically with the respective through-holes 154 at the top and bottom opposite of the unilateral elevations.

As in the semi-bar plus 126 of this embodiment, the front of the base plate 150 further comprises a fitted bore 131a and a coding bore 146a, each being designed as blind a hole, having the distance x₁, wherein the fitted bore 131a is the upper one of the two bores. Moreover, a fitted bore 131b and a coding bore 146b are introduced as blind holes having the distance x₂ on the back of the base body 150, wherein the fitted bore 131b is the lower one of the two bores. The positions of the bores 131b and 146b thus correspond to the situation of the semi-bar 134 in this embodiment when it is placed upside down as compared with the illustration in FIG. 33.

The diameter of the through-holes 129 of the semi-bars 126, 134 corresponds to the outside diameter of the insulating sleeves 116, and the outside diameter of the elevations 152 of the insulating bar 150 corresponds to the diameter of the through-holes 129 of the semi-bars 126, 134. Like the inside diameter of the insulating sleeves 116, the diameter of the through-hole 154 of the elevation 150 corresponds to the diameter of the fillister head screws (22). The diameter of the coding bores 146a, 146b is greater than the diameter of the coding pins 18.

Given the special asymmetrical arrangement of the projecting components, regardless of whether the semi-bars 126, 134 are assembled to form contacting bars plus-to-plus, minus-to-minus or plus-to-minus, and regardless of whether a series connection or parallel connection or a transition between a parallel connection and a series connection is to be implemented, when properly assembled the insulating sleeves 116, elevations 152 and coding pins 18 will project through the corresponding bores 121, 120a, 120b of the connectors 8, 10 of a secondary cell on the one hand, and will always project into an open through-hole 130 of a contacting bar or into a depression 156 of an insulating bar 148, or into open coding bores 146a, 146b of a contacting or insulating bar, on the other hand. This radially centers the relative positions of the elements in the cell block and they can be mounted protected against polarity reversal, and the fillister head screws are reliably insulated with respect to the connectors 8, 10, the contacting bars 114, 122 and the pressure plates 118, 120.

For assembly, therefore semi-bars plus 126, semi-bars minus 134 and insulating bars 148 that are merely sub-assembled with insulating sleeves 116 and coding pins 118 must be stored with respect to the contacting of the cells 2. The semi-bars can be assembled into contacting bars without the risk of confusion regardless of the desired type of interconnection and mounted with correct polarity.

A fourteenth embodiment relates to a modular design of the contact connection elements using the intermediate frame 14 of the twelfth embodiment, as shown in FIG. 31, and is illustrated in FIGS. 35 to 41. Each showing a longitudinal section, FIG. 35 illustrates a spacer semi-plate plus coded for a positive pole, FIG. 36 illustrates a spacer semi-plate minus coded for a negative pole, FIG. 37 illustrates a contact sleeve, FIG. 38 a double pin collar for a series connection, FIG. 39 an inside collar for a parallel connection, FIG. 40 a single pin collar for a transition from a parallel to a series connection, and FIG. 41 a spacer sleeve for a variable use of the fourteenth embodiment.

A spacer semi-plate plus 158 and a spacer semi-plate minus 160 are plates that have identical outside contours made of an electrically insulating material. As is shown in FIGS. 35 and 36, three through-holes 162, which correspond to the subsequent positions of the fillister head screws (22), are provided in each of the spacer semi-plates 158, 160 and two fitted bores 130 are provided on a back side as blind holes, in the upper one of which a dowel pin 132 is disposed, while the lower one remains open. The front of the spacer semi-plate plus 158 further comprises a fitted bore 131a and a coding bore 146a, each being designed as a blind hole, having the distance x₁, wherein the fitted bore 131a is the upper one of the two bores, in which a coding pin 118 is inserted. In contrast, the front of the spacer semi-plate minus 160 comprises a fitted bore 131a and a coding bore 146a, each being designed as a blind hole, having the smaller distance x₂, wherein the fitted bore 131a is the upper one of the two bores, in which a coding pin 118 is inserted.

Analogous to the two preceding embodiments, the spacer semi-plates 158, 160 can be assembled to form spacer bars in such a way that they are coded for plus-to-plus, minus-to-minus or plus-to-minus.

FIG. 37 shows a longitudinal section of a contacting sleeve 164, which is inserted in the through-holes 162 of a spacer bar for the contacting of the connectors of two secondary cells 2. The contacting sleeve 164 is substantially a hollow cylinder 166 made of conducting material. The length of the contacting sleeve 164 (of the hollow cylinder 166) corresponds to the thickness of two spacer semi-plates, that is the thickness of a spacer bar. The outside diameter of the contacting sleeve 164 corresponds to the diameter of the through-holes 162 of the spacer semi-plates 158, 160. The inside diameter of the contacting sleeve 164 is considerably larger than the diameter of a fillister head screw (22) for bracing the cell stack. The contacting sleeve 164 comprises two depressions 168 at the ends.

FIG. 38 shows a longitudinal section of a sleeve having two pins (double pin collar) 170 at the ends. A double pin collar 170 is substantially composed of a hollow cylinder 172 made of an electrically insulating material. Shoulders 174 are provided at the two ends. The outside diameter of the double pin collar 170 (of the hollow cylinder 172) corresponds to the diameter of the through-holes 162 of the spacer semi-plates 158, 160. The inside diameter of the double pin collar 170 corresponds to the diameter of a fillister head screw (22). The outside diameter of the shoulders 174 corresponds to the inside diameter of the depressions 166 of the contacting sleeve 164. The length of the shoulders 174 is slightly less than the depth of the depressions 166 plus the thickness of a connector 8, 10 of a secondary cell 2. The remaining length of the hollow cylinder 172 between the shoulders 174 corresponds to the thickness of two spacer semi-plates, that is the thickness of a spacer bar.

FIG. 39 shows a longitudinal section of an inside collar 176. The inside collar is a sleeve made of electrically insulating material. The outside diameter of the inside collar 176 corresponds to the inside diameter of the depressions 166 of the contacting sleeve 164. The length of the inside collar 176 is slightly less than twice the depth of the depressions 166 plus the thickness of a connector 8, 10 of a secondary cell 2.

The elements described above in connection with this embodiment are typically sufficient to implement the interconnection of the secondary cells 2 to form a cell block.

For a series connection, spacer semi-plates 158, 160 are assembled to form spacer bars plus-to-minus. Contacting sleeves 164 are inserted in the through-holes 162 in one spacer bar and double pin collars 170 are inserted in the other spacer bar. The spacer bars are inserted in the recesses 142 of the intermediate frame 14 (FIG. 31), wherein on an end face of the intermediate frame a coding pin 118 and a coding bore 146a having the larger distance x₁ for coding a plus side can be seen on one lateral side (approximately on the left), and a coding pin 118 and a coding bore 146b having the smaller distance x₂ for coding a minus side can be seen on the other lateral side (this being the right). On the next intermediate frame, a coding pin 118 and a coding bore 146b having the smaller distance x₂ for coding a minus side must then be seen on the one lateral side (left), and a coding pin 118 and a coding bore 146a having the smaller distance x₁ for coding a minus side must be seen on the other lateral side (right). If a secondary cell 2 is now placed with the only matching orientation of the coding bores 121a, 121b in the connectors 8, 10 on the coding pins 118 of an intermediate frame 14, only the correct intermediate frame 14 can be added in the correct pole direction. This continues until all cells 2 are installed. For connecting a pressure plate 18, 20 via the end frames 12, 16 to a contacting sleeve 164, the inside collars 176 are required, which are inserted in a through-hole of the pressure plate 18, 20 having a diameter that corresponds to the outside diameter of the inside collar 176 on that lateral side on which the contacting to a pole of the cell 2 is to take place. On the other lateral side, the double pin collars 170 remain, which extend with a shoulder 174 into the through-holes of the pressure plate 18, 20 and have the same outside diameter as the inside collars 176. The fillister head screws are guided in the double pin collars 170 and the inside collars 176 and insulated from current-carrying component; the radial centering of the components takes place analogously to the above embodiments using the same components.

For a parallel connection, only the contacting sleeves 164 and inside collars 176 are used. To this end, a respective inside collar 176 is placed in a depression 166 of a contacting sleeve 164, inserted in the spacer bars assembled from two identical spacer semi-plates 158 or 160, and the components are mounted in the pole direction predefined in this way.

FIG. 40 shows a longitudinal section of a sleeve having one pin (single pin collar) 178 at the end. A single pin collar 178 is substantially composed of a hollow cylinder 180 made of an electrically insulating material. A shoulder 174 is provided at an end. A depression 168 is provided at the other end. The outside diameter of the single pin collar 178 (of the hollow cylinder 180) corresponds to the diameter of the through-holes 162 of the spacer semi-plates 158, 160. The inside diameter of the single pin collar 178 corresponds to the diameter of a fillister head screw (22). The outside diameter of the shoulders 174 corresponds to the inside diameter of the depressions 166 of the contacting sleeve 164 and of the single pin collar 178 per se. The length of the shoulders 174 is slightly less than the depth of the depressions 166 plus the thickness of a connector 8, 10 of a secondary cell 2. The remaining length of the hollow cylinder 172 starting at the shoulder 174 corresponds to the thickness of two spacer semi-plates, that is the thickness of a spacer bar.

In a mixed parallel and series connection of secondary cells, as that which is shown in FIG. 7, for example, a double pin collar 170 or a single pin collar 178 can be inserted between the connectors to be insulated at the transition between a parallel connection and a series connection, depending on whether or not an inside collar protrudes. Optionally, at this transition site an inside collar 176 must be inserted on both sides in the contacting sleeve 164, which establishes the connection between two groups of groups of cells 2 connected in parallel.

FIG. 41 shows a longitudinal section of an insulating sleeve 182. This sleeve has the same geometry as the contacting sleeve 164, being a hollow-cylindrical base body 184 comprising the same depressions 168, however it is made of an electrically insulating material.

The insulating sleeve 182 can replace a double pin collar 170 or a single pin collar 178 by inserting one or both inside collars 176 in the depressions 168.

The above-described components of this embodiment are provided as a kit for assembly. Because of the small and compact dimensions of the sleeves and collars, they can be easily handled as bulk material.

In a fifteenth embodiment of the present invention, which is not shown in detail in the drawings, inside collars 176 are present in two designs having differing outside diameters, the contacting sleeve 164 and the insulating sleeve 182 comprise two depressions having differing diameters in keeping with the outside diameters of the inside collars, and the double pin collar 170 comprises two shoulders having differing inside diameters in keeping with the depressions of the contacting sleeve 164 and insulating sleeve 182. Optionally, two designs of single pin collars 178 are provided, wherein one design comprises a shoulder having a larger outside diameter and a depression having a smaller diameter, and the other design has a shoulder having a smaller outside diameter and a depression having a larger diameter, wherein the diameters of the shoulders and depressions are adapted to the differing diameters of the depressions of the contacting sleeve, or the differing outside diameters of the two designs of inside collars.

In this embodiment, no coding pins and coding bores are provided. Instead, the through-holes in the connectors 8 of the cells 2 have differing diameters in keeping with the differing outside diameters of the inside collars 176. In this way, the contacting sleeves 164 form contact connection elements within the meaning of the present invention, and the collars form both a centering unit and a reverse polarity protection unit within the meaning of the invention.

It also applies to this embodiment that the insulating sleeves 182 and the inside collars 176 in the two designs can replace both the double pin collars 170 and the single pin collars 178 when assembled appropriately.

Since the coding of the pole direction takes place via the differing outside diameters of the inside collars 176, and optionally the shoulders of the double and single pin collars 170, 178, no spacer semi-plates are provided for in this embodiment, but single-piece spacer bars, which are inserted in the symmetrical recesses 142 of the frame elements (see FIG. 31).

In a sixteenth embodiment, the sleeves and collars of the fifteenth embodiment are used. No spacer bars are provided, however. Rather, the frame elements have three through-holes, instead of recesses, for receiving the spacer bars on both lateral sides. All through-holes have the same diameter, which corresponds to the outside diameter of the contacting sleeve 164 and insulating sleeve 182.

In this embodiment, the number of different components is even further reduced, and assembly is further simplified.

In a seventeenth embodiment of the present invention, no frame elements are used at all. Rather the secondary cells 2 are threaded on fillister head screws between two pressure plates, wherein insulating and contacting bars according to the twelfth or thirteenth embodiment, or spacer bars comprising sleeves and collars according to the fourteenth or fifteenth embodiment, are disposed between the connectors 8, 10 of the cells 2. The distance between the cells 2 is defined and the necessary holding and contacting pressure is transmitted via the bars.

In an eighteenth embodiment, the use of bars is also dispensed with. Rather only the sleeves and collars of the fifteenth embodiment are used to transmit the holding and contacting pressure, to define the distance between cells 2, to contact and/or insulate connectors 8, 10, for polarity reversal protection and for radial centering.

By dispensing with the intermediate frames in the seventeenth and eighteenth embodiments, the total weight of a cell block can be reduced, which is further promoted by dispensing with spacer bars in the eighteenth embodiment. The stability of the arrangement is ensured solely by the pressure plates 18, 20 and the fillister head screws 22, as well as by the pressure surfaces of the spacer bars (158+160, 2×158 or 2×160) (seventeenth embodiment), or the contact sleeves 164 and insulating sleeves 182 and/or single and double pin collars 178, 170 (eighteenth embodiment), which are supported by way of the pressure surfaces of the connectors 8, 10 of the cells 2.

The temperature of the exposed secondary cells 2 can be controlled particularly effectively in the seventeenth and eighteenth embodiments. A housing, which extends between the pressure plates 18, 20, can be provided in order to lend an individual atmosphere to the cell block and protect the edge regions of the cells 2 from damage. However, it is also possible for a plurality of cell blocks without individual housings to be inserted in an installation space, which is in turn enclosed, wherein during installation the protection of the edge regions of the cells 2 must be ensured.

The following embodiments relate to establishing the radial position of the secondary cells 2 in the cell block.

FIG. 42 shows a secondary cell of a nineteenth embodiment in an end face view. As is shown in FIG. 42, the connectors 8, 10 extend into the edge region 6 (sealed seam) of a secondary cell 2 of this embodiment. A dead zone 186 is formed both at the top and bottom beyond the region of the connectors 8, 10, with no active or current-carrying parts of the cell 2 being located in this dead zone. Through-holes 188 are configured in these dead zones. The fillister head screws (22) or other suitable centering elements are in the through-holes 188.

FIG. 43 shows a corner of a secondary cell 2 of a twentieth embodiment in an end face view. A jog 190 is configured in the dead zone 186 of this cell 2. With the jog 190, the cell 2 is supported against the fillister head screw 22.

FIG. 44 shows an end region of a secondary cell 2 in a twenty-first embodiment in a sectional view from above. The fillister head screw 22 runs through a spacer 192 between connectors of the cells 2.

FIG. 45 shows a corner of a secondary cell 2 of a twenty-second embodiment in an end face view. A jog 194 is configured in the dead zone 186 of this cell 2. The jog 194 is larger than the jog 190 of the twentieth embodiment. For this reason, only rough orientation of the cell 2 during installation is achieved. However play exists between the jog 194 and the fillister head screw 22, so that the dead zone 186 is kept force-free during operation.

FIG. 46 shows an end region of a secondary cell 2 in a twenty-third embodiment in a sectional view from above. A spacer 196a having two pins 198 is disposed between connectors of the cells 2. The pins 198 extend into a counter-bore 199 of a spacer 196b on the other side of a connector. It is also possible to provide spacers having a pin 198 and a bore 199. The pins 198 can have differing diameters for coding the pole positions. The pins 198 and bores 199 can also be configured directly on the retaining frames 12, 14, 16.

A twenty-fourth embodiment of the invention will be described with reference to FIGS. 47 and 48. FIG. 47 shows a sectional view of an edge region of a secondary cell comprising a connector, as viewed from above, and FIG. 48 shows a sectional view of a spacer. As is shown in FIG. 47, the connector 8 has an embossing 200. A spacer 202 is disposed between connectors of the cells 2. As is shown in FIG. 48, the spacer 202 comprises two recessed relief structures 204, 206. The shape of the relief structures 204, 206 corresponds to the raised side of the embossing 200 on the connector 8. It is apparent that the spacer 202 for coding an installation position is provided such that the raised parts of the embossings 200 of adjacent connectors face one another. Although it is not shown in the figure, spacers having raised relief structures are also provided, which are adapted to the recessed part of the embossings 200. These spacers code an installation position such that the recessed parts of the embossings 200 of adjacent connectors face one another. Furthermore, spacers having a recessed and a raised relief structure are provided. The embossings 200 can have varying shapes, sizes or depths on the connectors 8, 10 to code the polarity. When assembled, the embossings and relief structures establish the relative positions of the components in the radial direction. They act both as a centering unit and as a reverse polarity protection unit within the meaning of the invention.

In a modification of the twenty-fourth embodiment, which is not shown in detail, an embossing is configured in a section of the edge region that is free of connectors, that is in the region of the free sealed seam of the cell.

A twenty-fifth embodiment of the invention will be described with reference to FIGS. 49 and 50. FIG. 49 shows an end face view of a secondary cell 2 of this embodiment in an installed situation. For this purpose, parts located behind the cell 2 have been omitted. A holding frame located in front of the cell 2 has likewise been omitted, and parts extending through this frame are shown in a cross-sectional view. FIG. 50 shows a longitudinal section of an insulating sleeve of this embodiment.

According to the illustration in FIG. 49, a secondary cell 2 comprises an active part 4, an edge region 6 having folds 50 and two connectors 8, 10 in the manner already described. Three through-holes 208 are configured in each connector 8, 10; all through-holes 208 have the same diameter. Six fillister head screws 22 are concentric with the through-holes 208 so as to brace the cell block. An insulating sleeve 210 is disposed concentrically with the central through-hole 208 (not visible in the illustration) between the connector 8 and a connector of a cell disposed in front of the shown cell 2. A contacting sleeve 212 is disposed concentrically with the upper and lower through-holes 208 (not visible in the illustration) between the respective connector 10 and a connector of the cell disposed in front of the shown cell 2. Moreover, an insulating sleeve 210 is disposed concentrically with the central through-hole 208 (not visible in the illustration) between the connector 10 and the connector of the cell disposed in front of the shown cell 2.

The contacting sleeves 212 are made of an electrically conducting material and have a continuous hollow-cylindrical cross-section. They are inserted in through-holes having a corresponding diameter in a holding frame or in a spacer bar and are seated with the end faces thereof on a respective connector. The inside diameter of the contacting sleeves 212 is greater than the diameter of the fillister head screws 22.

The insulating sleeves 210 are made of an electrically insulating material. According to the illustration of FIG. 50, they have a basic hollow-cylindrical shape, comprising an end-face depression 214 and a shoulder (pin) 216 on the other end face. The outside diameter of the insulating sleeves 210 corresponds to the outside diameter of the contacting sleeves 212 and they are likewise inserted in through-holes having a corresponding diameter in a holding frame or a spacer bar. With the end face on which the depression 214 is located and with the end face of a collar 218 formed by the shoulder 216, the insulating sleeves 210 are seated on a respective connector. The shoulder 216 extends through the central through-hole 208 on the connector 8, 10 and is seated in the depression 214 of a subsequent insulating sleeve. The outside diameter of the shoulder 216 corresponds to the diameter of the through-holes 208. The inside diameter of the insulating sleeve 210 corresponds to the diameter of a fillister head screws 22. The two pressure plates 18, 20 (not shown here) of the cell block are provided with through-holes, the diameter of which corresponds to the outside diameter of the shoulders 216.

Because of the insulating sleeves 210, radial centering of the holding frames 12, 14, 16 and of the secondary cells 2 in relation to one another and the pressure plates 18, 20 is ensured. (Instead of the insulating sleeve 210, a modified insulating sleeve having two pins is disposed in one of the end frames; as an alternative, hollow-cylindrical inside collars are shown on the side of one of the pressure plates 18, 20, with the inside diameter of the inside collars corresponding to that of the insulating sleeves and the outside diameter corresponding to that of the depressions 214, and are inserted on the side of the one pressure plate 18, 20 into the depressions 214 of the insulating sleeves 210). Moreover, centering of all components and electrical insulation with respect to the two central fillister head screws 22 is ensured.

The interconnection of the secondary cells 2 is implemented via the contacting sleeves 212. The alternate arrangement on the left and right sides in consecutive holding frames shown here represents a series connection. The outer through-holes around the fillister head screws 22 are left open on the respective other lateral side of a holding frame. Provided that the four outer fillister head screws 22 are centered and insulated by suitable means (see the insulating sleeve in FIG. 13) with respect to the pressure plates 18, 20, a sufficiently large annular gap is ensured between the contacting sleeves 210 and the fillister head screws 22. So as to increase the contact pressure, and as a counter bearing for pressing on the contacting sleeves 212, however, it may be advantageous to dispose insulating sleeves 210 in the through-holes opposite of the contacting sleeves 212, like in the central through-holes.

In the embodiments described above, importance was always attached to ensuring that the fillister head screws 22, which hold the cell block together, are de-energized or potential-free, while the pressure plates formed the poles (+) and (−) of the cell block.

FIG. 51 shows a cell block in a twenty-sixth embodiment of the invention, in which the clamping screws are used as connecting poles.

FIG. 51 shows a cell block 1e of this embodiment in a cut top view. The cutting plane here is located in the plane between two clamping screws. The cell block 1e comprises a plurality of secondary cells 2, which are arranged with alternating pole directions and connected in a series connection using cell contact connection elements 218 and cell insulating elements 220. The first or last cell is electrically connected to a first pressure plate 18 or a second pressure plate 20 by a first or last cell contact connection element 218. The pressure plates 18, 20 are made of an electrically conducting material and comprise lugs 52 for connecting to a supply network or for connecting to additional cell blocks.

The arrangement is held together by a plurality of clamping screws, which in this embodiment are configured as eyelet bolts 222. An eyelet bolt here is a hexagon bolt having a long shank, to the head of which an eye 226 is attached (welded on). The eyelet bolts 222 are insulated and centered with respect to the first pressure plate 18 by means of insulating bushings 64. The eyelet bolts 222 are tightened on the side of the second pressure plate 20 by way of nuts 24. Contact washers 224 are disposed between the nuts 24 and the second pressure plate 20. The contact washers 224 are made of an electrically conducting material, which at the connecting points to the surface of the second pressure plate 20 and the nuts 24 has low contact resistance. They can be simple steel screws, or copper or brass washers, which start to flow when tightened and thereby establish a good connection.

In this way, the eyelet bolts 222 are in electrical contact with the second pressure plate 20, but are insulated with respect to the first pressure plate 18 and all current-carrying parts in the interior of the cell block 1e, in particular with respect to the connectors of the cells 2 and the cell contact connection elements 218. On the side of the first pressure plate 18, the lug 52 is thus connected to the potential of the first pressure plate 18, while the eyes 226 of the eyelet bolts 222 are connected to the potential of the second pressure plate 20. In this way, both poles are accessible on the same end face of the cell block 1e.

Additional cell blocks can be connected in series or in parallel via the lug 52 of the second pressure plate 20, as was already described above. In this way, it is possible to tap a total voltage via the lugs 52 of a first pressure plate 18 of a first cell block and a second pressure plate 20 of a last cell block in the circuit, while a partial voltage can be tapped via the lug 52 and the eyes 226 of the eyelet bolts 222 on the side of the first pressure plate 18 of the first cell block.

Of course, not all clamping screws have to be connected to the potential of the second pressure plate 20. It suffices if one or two of the clamping screws are designed as eyelet bolts 222 and connected to the second pressure plate 20, while the other clamping screws are insulated with respect to the two pressure plates 18, 20 in the manner described before.

Potential equalization on the side of the insulated screw ends is achieved when the screw ends are connected there, for example by a connecting sheet, which is screwed on beneath the screw heads, or the like.

FIG. 52 shows a cell block in a twenty-seventh embodiment of the invention, in which the clamping screws are likewise used as connecting poles.

FIG. 52 shows a cell block 1f of this embodiment in a cut top view. The cutting plane here is located in the plane between two clamping screws. The basic design of the cell block 1f corresponds to that of the cell block 1e of the twenty-sixth embodiment, with the exception of the type of the screw assembly.

In this embodiment, the clamping screws are simple fillister head screws, which are screwed into internal threads in the second pressure plate 20 and thereby have reliable electrical contact therewith. On the head side, the fillister head screws 22 are insulated and centered with respect to the first pressure plate 18 by way of insulating bushings 64. Moreover, angle brackets 228 are screwed in between the screw heads and the insulating bushings 64. The angle brackets are angled metal plates made of electrically conducting material, which in one limb comprises a through-hole for receiving a screw shank and in the other limb comprises a through-hole for receiving a connecting pin (not shown in detail).

In this way, the eyelet bolts 222 are in electrical contact with the second pressure plate 20, but are insulated with respect to the first pressure plate 18 and all current-carrying parts in the interior of the cell block 1f, in particular with respect to the connectors of the cells 2 and the cell contact connection elements 218. On the side of the first pressure plate 18, the lug 52 is thus connected to the potential of the first pressure plate 18, while the angle brackets 228 are connected to the potential of the second pressure plate 20. In this way, both poles are accessible on the same end face of the cell block 1f.

In this embodiment, the second pressure plate 20 does not comprise a lug, in order to implement a short length to the extent possible. However, for the purpose of interconnecting to additional cell blocks, the pressure plates 18, 20 may comprise lugs projecting on one lateral side, or both lateral sides (shown in FIG. 18 in connection with the ninth embodiment is a laterally projecting lug 52c).

In a twenty-eighth embodiment, which is shown in FIG. 53, a plurality of cell blocks are connected in series to one another. For the description below, it shall be defined that the first pressure plate 18 of each cell block always represents a positive pole of the cell block and the second pressure plate 20 of each cell block always represents a negative pole of the cell block.

A first cell block 1g of this embodiment is generally composed as is shown in FIG. 51 or 52. In this embodiment, fillister head screws 22 and angle brackets 228 as in FIG. 52 are used on the insulated side, and nuts 24 and contact washers 224 as in FIG. 51 are used on the contacted side. This means that the screws 22 are connected to the negative pole of the cell block, whereas they are electrically disconnected from the positive pole. It shall further be assumed that only one pair of screws 22, preferably the uppermost, is mounted in a contacting manner, while another pair of screws is, or other pairs of screws are, insulated with respect to all poles.

A random number of additional cell blocks 1h are composed differently from the first cell block 1g. All screws are insulated with respect to all poles (that is all pressure plates 18, 20) of the respective cell block 1h (that is they are screwed together via insulating bushings 64). With a pair of screws, an angle bracket 228 is screwed in each case beneath the screw heads and beneath the nuts, and these screws are connected to one another by suitable means for potential equalization, in this example potential equalization plates 230, for example.

So as to implement a series connection, as it is shown by way of example in FIGS. 8 and 9, positive poles and negative poles of the cell blocks 1g, 1h, 1h are connected in series to one another. Moreover, the angle brackets on the positive side are connected to the respective angle brackets on the negative side. The potential of the negative pole of the first cell block 1g is thus conducted over the pairs of screws of this one and all additional cell blocks 1h to the positive side of the last cell block 1h. For example, both the positive pole (via the lug 52 of the first pressure plate 18 of this cell bock) and the negative pole (via the angle brackets 228) of the overall arrangement are present on the same end face of the last cell block 1h and can be tapped directly next to one another.

In a modification of the twenty-eighth embodiment, analogously intermediate potentials that are several times the terminal voltage of a cell block can be tapped. For example, an additional pair of screws of the central cell block 1h could be connected to the second pressure plate 20 of this cell block and the potential present there could be conducted to the side of the first pressure plate 18 of the last cell block (on the left in the drawing). Moreover, the potential present at the second pressure plate 20 of the last (left) cell block 1h could be conducted via a third pair of screws from the second pressure plate 20 of this cell block to the side of the first pressure plate 18 thereof. In this way, the terminal voltage of the last cell block, the added terminal voltages of the last and second to the last cell blocks, and the added terminal voltages of the first to the last cell blocks could be tapped on the side of the first pressure plate 18 of the last cell block.

In a further modification of the twenty-eighth embodiment, only one screw of a cell block is used in each case for conducting a potential.

It should be pointed out that some of the angle brackets 228 could be dispensed with in the cell blocks 1g, 1h of the twenty-eighth embodiment. However, if all current-carrying screws carry angle brackets 228, this will contribute to increased modularity and flexibility in the connection situation and prevent remounting if different connections are required, for example if the cell blocks are not supposed to be arranged next to, but behind one another. For protection purposes, the angle brackets that are not used may carry insulating caps.

FIG. 54 shows a cell block of the twenty-ninth embodiment from above in a sectional view.

In a cell block 1k according to this embodiment, the fillister head screws 22 run above and below the secondary cells 2a. The cells 2a comprise a thin edge region 6 designed as a peripheral sealed seam. The cells 2a are held at this edge region (sealed seam) 6 by frame elements 12, 14, 16. The sealed seam notably has a substantially constant, well-defined and known thickness peripherally.

Pressure frames 18, 20 rest on the first end frame 12 and the last end frame 16, respectively, the frames being acted on by the fillister head screws 22.

The intermediate frames 14 comprise openings 40 not only on the upper and lower faces (not shown in detail), but also comprise openings 231 on the lateral sides, with a coolant (generally air) flowing through these openings.

Except for the thin edge region, the cells 2a can be designed and contacted as in the prior art (see, for example, FIG. 60). If the cells 2a comprise connectors integrated in the edge region, inner contacting can take place via contact sleeves or the like, as was described within the scope of this application. Contacting of such connectors can also take place from the outside, by means of jogs optionally configured in the frame elements, like the jogs 42 in FIG. 1, and suitable contacting means.

A thirtieth embodiment of the invention will be described hereinafter with reference to FIGS. 55 to 58. FIG. 55 shows a cut top view of a cell block of this embodiment, FIG. 56 shows an enlarged view of a contacting clamp, as viewed from the cell block, FIG. 57 shows a view of the contacting clamp in the direction of the arrow, cut along a line LVII of FIG. 56, and FIG. 58 shows a view of the contacting clamp in the direction of the arrow, cut along a line LVIII of FIG. 56.

The cell block 1l according to this embodiment is substantially composed like the cell block 1k of the twenty-ninth embodiment. The fillister head screws 22 again run above and below the secondary cells 2b. The cells 2b have a peripheral sealed seam 50 and are held at this sealed seam 50 by frame elements 12, 14, 16. Pressure frames 18, 20 rest on the first end frame 12 and the last end frame 16, respectively, the frames being acted on by the fillister head screws 22.

Like the cells 2, the cells 2b comprise connectors 8, 10 projecting laterally on opposing sides, which protrude beyond the contour defined by the frame elements 12, 14, 16 and the pressure frames 18, 20. The connectors 8, 10 of the cells 2b notably protrude laterally between two frame elements 12, 14, 16. The cells 2b are stacked in the customary manner with alternate polarities in the stacking direction. that is connectors 8 having a first polarity (for example positive) and connectors 10 having a second polarity (for example negative) alternately protrude on one side of the cell block 1l.

To implement a series connection, two consecutive connectors 8, 10 at a time are connected using a contacting clamp 232. Each contacting clamp 232 comprises an insulating body 233 and two contact springs 234 (of which only one is visible in the sectional view). FIG. 55 shows only three contacting clamps 232; however, the arrangement of the contacting clamps 232 in fact continues over the entire length of the cell block 1l.

The first and last cells 2b are connected to the first and second pressure plates 18, by way of an end contacting clamp 236 (the figure shows only the end contacting clamps 236 for the second pressure plate 20). Each end contacting clamp 236 comprises an insulating body 237 and two contact springs 238 (of which only one is visible in the sectional view).

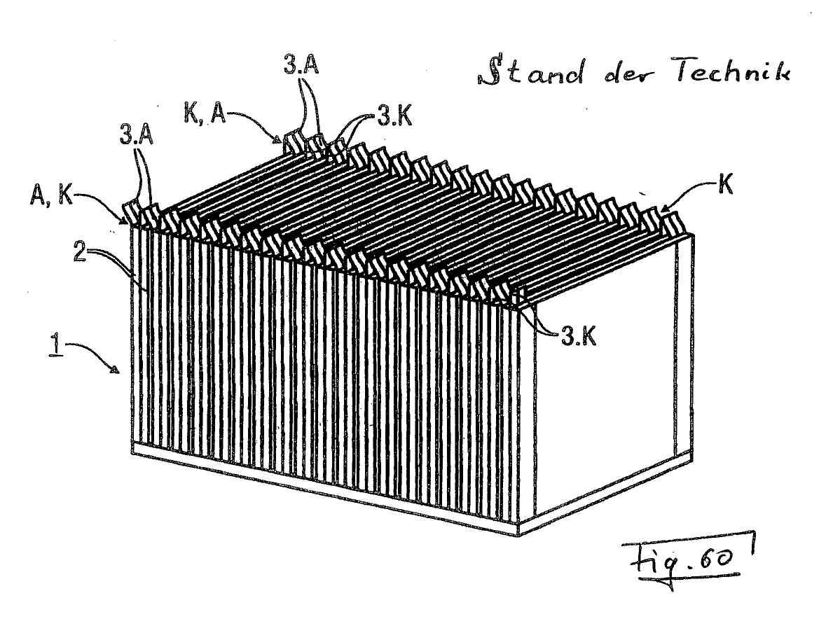

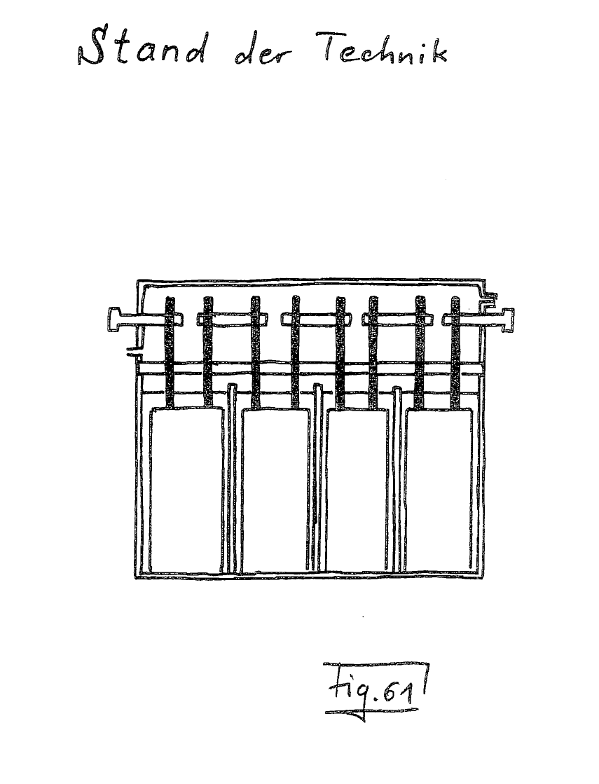

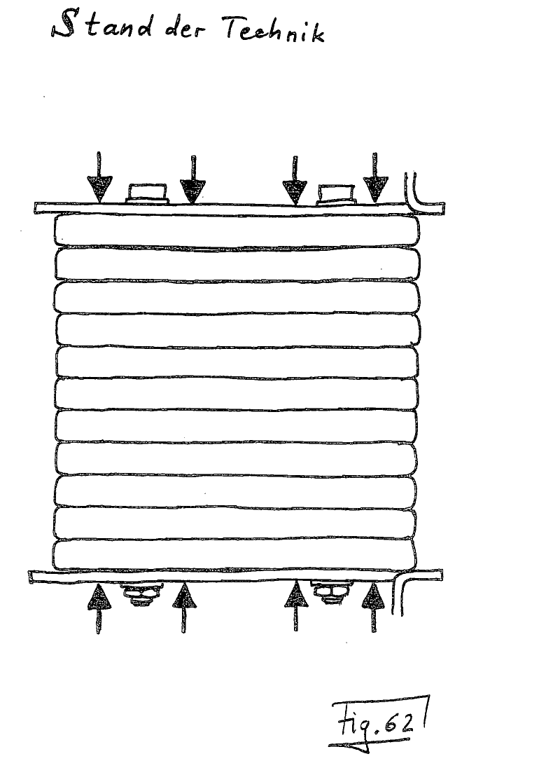

FIGS. 56 to 68 show details of one of the contacting clamps 232. As previously described, the contacting clamp 232 comprises an insulating body 233. The insulating body 233 is an elongated body having a U-shaped cross-section, which is connected to the end faces. The flanks of the U-shaped cross-section have a greater material thickness than the base side thereof. A jog 240 is configured on the outside of each flank of the insulating body 233, with the material being left in place on the end face. A continuous opening 242 is configured in the base side of the U-shaped cross-section. In the assembled state, two jogs 240 that are placed against one another and the opening 242 correspond to the openings 231 configured in the intermediate frame 14.

A projection 244 is configured toward the inside at each end face. Together with the U-profile, the projections 244 form a receiving slot 245 having likewise a U-shaped cross-section. An upper and a lower contact spring 234a, 234b, which are each secured to the respective projection 244 by means of a screw 246, are accommodated in the upper and lower receiving slots 245, respectively. Each of the contact springs 234a, 234b has a U-shaped cross-section with curved flanks. The contact springs 234a, 234b are slightly shorter than half the inside length of the U-profiles, minus the length of one of the projections 244; the contact springs 234a, 234b can thus be easily mounted for producing the contacting clamps 232. Windows 239 are incorporated in the contact springs 234a, 234b in areas where the contact springs 234a, 234b cover the opening 242 in the insulating body 233 in the installed state.

As is shown in FIG. 55, the contacting clamps 232 are placed from the outside onto two consecutive connectors 8, 10 in each case. For this purpose, the connectors 8, are supported on the flanks of the U-profile of the contacting clamp 232 and push the contact springs 234 away toward the center plane of the contacting clamp 232. To this end, the projections 244 form abutments at the top and bottom. This ensures a reliable contact. (Distances in the drawings between the connectors 8, 10 and the contact springs 234 on the one hand and/or the flanks of the profiles of the insulating bodies 233 on the other hand are only provided for a better understanding.)

The end contacting clamps 236 differ from the contacting clamps 232 in that the shape of the insulating body 237 thereof corresponds approximately to an insulating body 233 of a contacting clamp 232 cut lengthwise in half. The contact springs 238 thus protrude beyond the insulating body 237 and are elongated on one side and designed in terms of the width such that they establish a secure spring-loaded contact with the respective pressure plate 18, 20.

The contact springs 238 can also be clamped to the pressure plates 18, 20 by way of locking screws.

In a modification of this embodiment, contacting clamps could be provided which connect a plurality of contact sections to one another to implement a parallel connection. These contacting clamps, that is the U-profiles thereof, are accordingly wider, and in each case the number of pairs of projections 244 (and optionally openings 242) that is configured corresponds to the number of connections to be established between cells 2b. A contact spring is received and secured in each of the receiving slots 245 formed by the projections 244. This means that the contacting clamps are placed on the respective connectors 8, 10 such that these are enclosed in pairs by the limbs of two contact springs 234 disposed next to one another. So as to implement the exemplary circuitry of FIG. 7, for example two contacting clamps, each having five contact spring pairs 234, and two end contacting clamps, each having a contact spring pair 238 half exposed, are provided for the contacting with a pressure plate 18, 20 and two contact spring pairs 234 are provided for the contacting between cells.

FIG. 59 shows a perspective top view of a cell block of a thirty-first embodiment of the invention.

A cell block 1p of this embodiment comprises a plurality of secondary cells (not visible), which are held between frame elements and interconnected by way of contact connection elements in a suitable manner as described in the present application. Contrary to the previous embodiments, no tension screws are present here. Rather the entire stack is held together by a collar, which is formed by two semi-collars 248. The semi-collars are metal sheets bent in a U shape, or flat bodies formed into a U shape in another manner, comprising flange sections 250 that perpendicularly project outwardly. Through-holes 252 that are located opposite of and aligned with one another are configured in the flange sections 250 of the two semi-collars 248. The semi-collars 248 are screwed to one another by way of the through-holes 252 (not shown in detail). In the rigidly screw-fastened state, the flange sections of the two semi-collars 248 have a predefined minimum distance from one another. This ensures that the cell stack is rigidly braced by the pressure of the collar.

In this embodiment, of course, no contacting or insulating elements can be used which require screws of any kind for holding or centering. Contact connection elements described as sleeves, for example, in the preceding embodiments can be configured as solid bodies and thus have a larger contact surface. Insulating problems associated with long fillister head screws that extend through the entire stack cannot occur.

The semi-collars 248 are insulated with respect to the pressure plates so as to prevent short circuits. Moreover, the semi-collars 248, notably the transitions to the flange sections 250, are configured with sufficient rigidity to withstand the tension of the connecting means.

In a modification of this embodiment, the semi-collars 248 directly form the poles, that is the first and last cells are each contacted directly with one of the semi-collars 248. To prevent a short circuit, the screw assembly elements are suitably insulated at the flange sections; the frame elements are already composed of electrically insulating material. Separate pressure plates are eliminated. For the connection to a supply network or additional cell blocks 1p, the flange sections 250 or the end faces of the semi-collars 248 can comprise lugs.

The invention was described above based on preferred embodiments. The specific embodiments, of course, only illustrate and exemplify the claimed invention, without limiting the same. The characteristics of various embodiments can, of course, also be combined and/or exchanged in order to benefit from the respective advantages.

The above exemplary embodiments describe storage devices for electric energy of the type of a secondary lithium-ion storage device (rechargeable battery). The invention, however, can be applied to any type of storage devices for electric energy. It can be applied to primary storage devices (batteries) and to secondary storage devices. Likewise, the type of the electrochemical reaction for storing and delivering electric energy is not limited to lithium metal oxide reactions, but instead the individual storage cells can be based on any electrochemical reaction.

Above, several embodiments were described which use four or six fillister head screws as tensioning elements. However, wherever six fillister head screws were described, it is also possible to use four fillister head screws, and in most cases the reverse also applies.

Instead of the washers 25, or in addition to the washers, it is possible to use disk springs or disk spring sets together with the fillister head screws to compensate for the thermal expansion.

The cooling fluid described in the embodiments can be air, water (notably deionized water), oil or another suitable heat transfer medium. It can flow in a suitably designed and configured cooling circuit and used to control the temperature of the cell blocks, or of the individual cells. It is conceivable to utilize phase transition, for example evaporation, of the heat transfer medium. As an alternative, solid matters, such as metal plates, can be used as the heat transfer medium.

Several essential characteristics of the invention will be summarized again hereinafter. This is done to provide an overview.

A electric energy storage device comprises a plurality of storage cells with a flat shape, wherein a plurality of storage cells are stacked in a stacking direction to form a cell block and held together by a clamping device between two pressure plates, and wherein the storage cells are connected to one another in parallel and/or in series inside the cell block. Each storage cell is held in the edge region thereof between two frame elements.

According to another aspect, each storage cell comprises connectors in the edge region, and electric contacting between connectors of consecutive storage cells is carried out via the clamping device by way of friction fit. In this aspect, the frame elements can be replaced with support elements, however these have higher strength.

The frame elements are produced from electrically insulating material, such as plastic, and electric contact elements are integrated therein for connecting the cells to one another. (All the features apply analogously to support elements, which are produced from ceramic material or glass, for example, for higher strength.).

The clamping elements (such as tension bars, and the like) are used to connect a cell block made of pouch cells and frames both mechanically and electrically.

Connectors, the contact elements connected thereto and/or the insulating or holding elements (these also being the frames) connected thereto are provided with a geometric coding that prevents polarity reversal of the cells.

Heat sinks are fastened to the connectors, with these heat sinks increasing the heat transfer surface to the cooling fluid.

The cell is laterally (radially) oriented and fixed by the frame elements. In addition, the frames and/or cells can optionally be coated with foam or the like.

The dead zones, which are caused by the fact that the connectors do not take up the entire length of a lateral edge of the rectangular cell, are used for arranging fastening elements in a neutral manner in terms of the installation space. These elements generally engage in recesses or jogs of the packaging of the cell.

The frame elements are designed so as to form one or more at least partially closed (cable) ducts when arranged next to one another.

The cell blocks within one battery, or different batteries, are composed of standard elements (frames, end plates, contact elements, . . . ), the number of which is dependent upon the properties (voltage, capacitance) of the cells to be installed.

The electronics (cell voltage and temperature monitoring, balancing, . . . ) electrically connected directly to the individual cells are arranged fixed in the cell block.

The cell blocks are fastened in the housing or electrically connected among one another at the electric poles thereof.

### LIST OF REFERENCE SIGNS

1 Cell block
1a,b,c,d,e,f,g,h,k,j,p Cell block (certain embodiments)
2 Secondary cell
2a,b,c Secondary cell (certain embodiments)
4 Active part
6 Edge region (sealed seam)
8, 10 Connector, electrical connector, busbar, terminal
12, 16 End frame
14 Intermediate frame
18, 20 Pressure plate
22 Fillister head screw, cylinder screw
24 Nut
26 Insulating washer
28 Small through-hole in 12-16
29 Large through-hole in 12-16
30 Through-hole in 8, 10
32 Contact sleeve
34 Fitted bore in 12-16
34a,b Fitted bore in 14
36 Fitted bore in 8, 10
38 Centering pin
40 Slot in 14
42 Jog, recess area, depression in 12-16
44 Opening
46 Brace
48 Bevel
50 Fold of 6
52 Lug
52a,b Lugs (third embodiment)
52c Lug (ninth embodiment)
54 Bore in 52
56 Air gap
58 Connecting screw
60 Connecting sheet
62 Controller
64 Insulating bushing
66 Signal cable
68 Channel
70 Access opening
72 Second controller
74 Notch in 14, 16
76, 78 Connecting element
80 Bore for inside line
82 Depression
84 Chamfer
86 Pressure surface
88 Connecting nut
90 Spacer sleeve
92 Thickened region
94 Elastic cushion
96 Contact strip
98 Through-hole in 96
100 Pressure surface on 96
102 Jog
104 Rib
106 Indentation
108 Web
110 Fitting surface
112 Cut-out
114 Contacting bar plus-to-plus
116 Insulating sleeve
118 Coding pin
120a,b Coding bore in 8, 10
121 Through-hole in 8, 10
122 Contacting bar minus-to-minus
124 Insulating bar
126 Semi-bar plus
128 Base plate plus
129 Through-hole in 128, 136
130 Fitted bore
131a Blind hole in 128, 150
131b Blind hole in 128, 150
132 Dowel pin
134 Semi-bar minus
136 Base plate minus
137 Plate
138 Through-hole in 124
140 Coding bore in 124
142 Recess
144 Free space
146a Coding bore in 128, 150
146b Coding bore in 136, 150
148 Insulating and centering bar
150 Base body
152 Elevation
154 Through-hole in 150
156 Depression
158 Spacer semi-plate plus
160 Spacer semi-plate minus
162 Through-hole
164 Contact sleeve
166 Hollow cylinder
168 Depression
170 Double pin collar
172 Hollow cylinder
174 Shoulder
176 Inside collar
178 Single pin collar
180 Hollow cylinder
182 Insulating sleeve
184 Hollow cylinder
186 Dead zone
188 Through-hole
190 Jog
192 Spacer
194 Jog
196a,b Spacer
198 Pin
199 Counter-bore
200 Embossing
202 Spacer
204, 206 Relief structure
208 Through-hole
210 Insulating sleeve
212 Contacting sleeve
214 Depression
216 Shoulder (pin)
218 Cell contact connection element
220 Cell insulating element
222 Eyelet bolt
224 Contact washer
226 Eye
228 Angle bracket
230 Through-hole
231 Lateral opening
232 Contacting clamp
233 Insulating body
234 Contact spring
236 End contacting clamp
237 Insulating body
238 Contact spring
239 Window
240 Jog
242 Opening
244 Projection
245 Receiving slot
246 Screw
248 Semi-collar
250 Tensioning lug
252 Through-hole
m Number of intermediate frames 14 in a cell block
n Number of cells 2 in a cell block
t Fold thickness
x1,x2 Distance of the fitted bores 34a, 34b, the coding bores 120a, 120b, 140 and the coding pins 118
H Rear (back side)
L Left lateral side
R Right lateral side
S Stacking direction
V Front
   Express reference is made to the fact that the above list of reference signs is an
integral part of the description.

1. An electric energy storage device, comprising a plurality of storage cells with a flat shape, several storage cells being stacked in a stacking direction to form a cell block and being held together by a clamping device between two pressure plates, and the storage cells being connected to one another in parallel and/or in series inside the cell block,
characterized in that
each storage cell is held in the edge region thereof between two frame elements.

2. The electric energy storage device according to claim 1, characterized in that each storage cell has an active part in which configured and adapted for absorbing and releasing electric energy by means of an electrochemical reaction is arranged, and the edge region surrounds the active part.

3. The electric energy storage device according to claim 1 or 2, characterized in that each storage cell has planar contact sections, which project in the edge region from two opposite narrow sides of the storage cell transversely to the stacking direction.

4. An electric energy storage device according to any one of the preceding claims, characterized in that the active part is tightly enclosed by a membrane, which has at least one seam in the edge region, in particular at least on two opposite narrow sides of the storage cell, wherein the region enclosed by the membrane is preferably evacuated.

5. The electric energy storage device according to claim 4, characterized in that the contact sections are a part of connectors that extend through the seams on the two opposite narrow sides and are in contact with the active part in the interior.

6. An electric energy storage device according to any one of the preceding claims, characterized in that the storage cells are electrochemical cells, in particular galvanic secondary cells.

7. An electric energy storage device according to any one of claims 3 to 6, characterized in that the contact sections form pressure surfaces for the pressure applied by the clamping device via the frame elements.

8. An electric energy storage device according to any one of claims 2 to 7, characterized in that the active part has a greater thickness than the edge region.

9. An electric energy storage device according to any one of claims 2 to 8, characterized in that the thickness of the frame elements is such that there is a free space between the active parts of adjacent storage cells.

10. The electric energy storage device according to claim 9, characterized in that each frame element has at least one opening transversely to the stacking direction, preferably a plurality of openings in sections of the frame elements located opposite transversely to the stacking direction, the opening connecting the free space between adjacent storage cells to an exterior space.

11. The electric energy storage device according to claim 9 or 10, characterized in that a cooling medium flows through the space between two storage cells, the cooling medium in particular entering and exiting through the openings in the frame elements.

12. The electric energy storage device according to claim 11, characterized in that the cooling medium is a fluid, in particular one that is not combustible or flame-resistant, preferably air, deionized water or oil.

13. The electric energy storage device according to claim 11 or 12, characterized in that the cooling medium undergoes a phase transition when flowing through the space between two storage cells.

14. An electric energy storage device according to any one of the preceding claims, characterized in that the pressure plates are embodied in a frame-shaped manner.

15. An electric energy storage device according to any one of the preceding claims, characterized in that the clamping device comprises a plurality of, in particular four or six, tension bars.

16. The electric energy storage device according to claim 15, characterized in that the tension bars extend through bores running in the stacking direction in the pressure plates, the frame elements and the edge regions of the storage cells.

17. The electric energy storage device according to claim 16, characterized in that the tension bars extend through holes running in the stacking direction in the contact sections of the storage cells.

18. An electric energy storage device according to any one of claims 1 to 17, characterized in that the electrical connection of the storage cells is carried out by means of friction fit via the clamping device.

19. The electric energy storage device according to claim 18, characterized in that a contact connection element made of an electrically conducting material is arranged where an electrical connection is to be produced between contact sections of adjacent storage cells, the element being pressed onto both contact sections by means of the clamping pressure exerted in the stacking direction by the clamping device.

20. The electric energy storage device according to claim 19, characterized in that the contact connection element is composed of a metal or a metal alloy, preferably copper, brass or bronze, and particularly preferably it is gold-plated or silver-plated.

21. The electric energy storage device according to claim 19 or 20, characterized in that the contact connection element is integrated into a frame element.

22. An electric energy storage device according to any one of claims 19 to 21, characterized in that the contact connection element is a plurality of cylindrical bodies, which are inserted into through-holes in the frame element.

23. The electric energy storage device according to claim 22, characterized in that the frame elements have a reduced thickness between regions in which contact connection elements are used.

24. The electric energy storage device according to claim 22 or 23, characterized in that the contact connection element is a plurality of sleeves through which respectively one of the tension bars runs.

25. A electric energy storage device according to any one of claims 19 to 21, characterized in that the contact connection element has an elongated basic shape with a substantially rectangular cross-section, wherein the contact connection element is inserted into a cut-out in the frame element between the contact sections of the two storage cells to be connected, substantially following the course thereof, and wherein parallel outer surfaces of the contact connection element contact the contact sections of the storage cells.

26. The electric energy storage device according to claim 25, characterized in that the contact connection element comprises thickened regions in the stacking direction, the outer end surfaces of which contact the contact sections of the storage cells.

27. The electric energy storage device according to claim 25 or 26, characterized in that the contact connection element comprises at least one cooling rib extending in the longitudinal direction and pointing into the interior of the device.

28. A electric energy storage device according to any one of claims 25 to 27, further characterized by spacer elements made of electrically insulating material, which are inserted between two contact sections into cutouts in the frame elements in areas where no electrical connection is to be produced between the contact sections.

29. The electric energy storage device according to claim 28, characterized in that the spacer elements substantially have the shape of the contact connection element.

30. An electric energy storage device according to any one of claims 19 to 29, characterized in that the contact connection element comprises at least two through-holes, through which respectively one of the tension bars runs.

31. The electric energy storage device according to claim 24 or 30, characterized in that the tension bars are electrically insulated with respect to the contact connection element and the contact section.

32. The electric energy storage device according to claim 31, characterized in that the tension bars comprise an electrically insulating coating on the shank surfaces.

33. The electric energy storage device according to claim 31, characterized in that each tension bar bears sleeves made of electrically insulating material.

34. An electric energy storage device according to any one of the preceding claims, characterized in that spring elements are arranged in an free space between adjacent storage cells, these elements elastically supporting the storage cells with respect to one another in the stacking direction.

35. The electric energy storage device according to claim 34, characterized in that the spring elements are planar foam elements.

36. The electric energy storage device according to claim 34 or 35, characterized in that the spring elements are fixedly attached to one or both flat sides of the storage cells.

37. The electric energy storage device according to claim 34 or 35, characterized in that the spring elements are fixedly attached to both flat sides of the storage cells.

38. An electric energy storage device according to any one of the preceding claims, further characterized by a centering unit, which establishes the relative position of the storage cells and frame elements transversely to the stacking direction.

39. The electric energy storage device according to claim 38, characterized in that the centering unit comprises projections arranged in end faces of the frame elements, the projections engaging in matching recesses in the edge region of the storage cells.

40. The electric energy storage device according to claim 39, characterized in that the projections are preferably pins, nubs, noses or the like and the recesses are arranged in the contact regions or in the non-conducting sections of the edge regions.

41. The electric energy storage device according to claim 39 or 40, characterized in that the recesses are through-holes or perforations.

42. The electric energy storage device according to claim 38, characterized in that the centering unit comprises embossings in the edge region of the storage cells, the embossings engaging in a matching relief of the frame elements.

43. The electric energy storage device according to claim 38, characterized in that the centering unit is implemented such that the tension bars run with fit through bores in the edge region of the storage cells, with the exception of the contact regions.

44. The electric energy storage device according to claim 38, characterized in that the centering unit is implemented such that the storage cells, in particular with the thicker active sections thereof, are supported against the frame elements transversely to the stacking direction.

45. The electric energy storage device according to claim 44, characterized in that an elastic element, in particular foam, is interposed as the centering unit between the frame elements and the storage cells, the element being preferably molded directly onto the frame elements.

46. An electric energy storage device according to any one of the preceding claims, further characterized by a reverse polarity protection unit, which codes an installation direction of the storage cells.

47. The electric energy storage device according to claim 46, characterized in that the reverse polarity protection unit is implemented such that the centering unit according to any one of claims 38 to 46 is configured non-symmetrically.

48. The electric energy storage device according to claim 47, characterized in that the projections and recesses, or the embossings and counter-reliefs, according to any one of claims 39 to 42 are arranged at a greater distance on the side of one contact section, or are embodied in another shape or size, than on the side of the other contact section.

49. The electric energy storage device according to claim 46, characterized in that the reverse polarity protection unit is implemented such that the spring elements according to claim 37 on both flat sides of the storage cells and, depending on the desired direction of polarity of a plurality of storage cells, are arranged on the half of the flat sides assigned to one and the same contact section, or on halves of the flat sides assigned to different contact sections.

50. An electric energy storage device according to any one of the preceding claims, characterized in that the frame elements comprise at least one edge-side indentation arranged at respectively the same point, wherein the indentations of several frame elements in the assembled state form a channel that is open toward the outside with a substantially U-shaped cross-section and extends in the stacking direction.

51. The electric energy storage device according to claim 50, characterized in that a hole is introduced at the base of the indentation perpendicular to the extension direction of the channel.

52. The electric energy storage device according to claim 50 or 51, characterized in that the channel is accessible on the end face via a through-hole or perforation or notches arranged in at least one of the pressure plates.

53. An electric energy storage device according to any one of the preceding claims, characterized in that the storage cells are connected in series.

54. An electric energy storage device according to any one of claims 1 to 52, characterized in that at least some of the storage cells are connected in parallel.

55. The electric energy storage device according to claim 54, characterized in that a plurality of storage cells connected in parallel in each case form a group, and a plurality of groups comprising an identical number of storage cells are connected in series.

56. An electric energy storage device according to any one of the preceding claims, characterized in that the pressure plates are made of an electrically conducting material and are electrically connected to a contact section of a storage cell via a contact connection element as defined in any one of claims 19 to 37.

57. The electric energy storage device according to claim 56, characterized in that the pressure plates comprise connection elements, which are equipped for connection to a connecting lead or a counterpart.

58. The electric energy storage device according to claim 57, characterized in that the connection elements are lugs, which are preferably provided with through-holes or carry stud bolts and which laterally project transversely to the stacking direction or project at the end face in the stacking direction.

59. An electric energy storage device according to any one of claims 56 to 58, characterized in that the tension bars are electrically insulated with respect to the pressure plates.

60. An electric energy storage device according to any one of claims 56 to 58, characterized in that the tension bars are electrically insulated with respect to one of the pressure plates, while they are connected to the other pressure plate in an electrically conducting manner and comprise connection elements that are preferably screwed to the tension bars or embodied integrally therewith at least on the side of the insulated pressure plate.

61. The electric energy storage device according to claim 60, characterized in that the tension bars comprise connection elements at least on one side, which are preferably screwed to the tension bars or embodied integrally therewith.

62. The electric energy storage device according to claim 60 or 61, characterized in that the connection elements of the tension bars are electrically connected to one another on the at least one side.

63. The electric energy storage device according to claim 60, characterized in that the tension bars are screwed directly into one of the pressure plates.

64. An electric energy storage device according to any one of the preceding claims, characterized in that the frame elements and pressure plates collectively define a substantially prismatic contour, which completely surrounds the storage cells arranged therein.

65. An electric energy storage device according to any one of the preceding claims, characterized in that, at the end-face ends of a cell block, the two frame elements comprise transverse braces of reduced thickness, which span the space left free by the respective frame element.

66. An electric energy storage device according to any one of the preceding claims, further characterized by a control unit for monitoring and balancing the storage cells.

67. The electric energy storage device according to claim 66, characterized in that the control unit is attached to the cell block, preferably to a transverse brace according to claim 65.

68. The electric energy storage device according to claim 66 or 67, characterized in that the control unit is connected to one or more leads that run in the channel according to any one of claims 50 to 52 formed by the indents.

69. The electric energy storage device according to claim 68, characterized in that the lines are connected to sensing and/or control elements via the bores according to claim 51.

70. An electric energy storage device according to any one of the preceding claims, characterized in that a plurality of storage cells are connected to one another in series and/or in parallel.

71. The electric energy storage device according to claim 70, characterized in that the cell blocks have a different number of storage cells.

72. The electric energy storage device according to claim 71, characterized in that the number of storage cells in the cell blocks is selected on the basis of the geometry of an available installation space.

73. An electric energy storage device according to any one of claims 70 to 72, characterized in that the cell blocks are arranged in the respective stacking directions one behind the other and/or with respect to the respective stacking directions next to one another and/or one above the other and/or at an angle, in particular a right angle, of the respective stacking directions in relation to one another.

74. A electric energy storage device according to any one of claims 64 to 66, characterized in that the cell blocks are connected to one another via the connection elements thereof according to any one of claim 57, 58 or 60 to 62.

75. An electric energy storage device according to any one of the preceding claims, further characterized by a housing which accommodates the entire arrangement.

76. The electric energy storage device according to claim 75, characterized in that the cell blocks are attached to the housing by means of at least some of the connection elements according to claim 57 or 58.

77. An electric energy storage device, comprising a plurality of flat storage cells, a plurality of storage cells being stacked in a stacking direction to form a cell block and held together by a clamping device, and the storage cells inside the cell block being connected to one another in parallel and/or in series,
characterized in that each storage cell comprises connectors in the edge region, and
electric contacting between connectors of consecutive storage cells is carried out via the clamping device by means of friction fit.

78. The electric energy storage device according to claim 77, characterized in that a pressure-transferring component is arranged between connectors in the stacking direction, which is either made of an electrically conducting material or of an electrically insulating material and on which the force of the clamping device acts.

79. The electric energy storage device according to claim 78, characterized in that the storage cells are held by the pressure-transferring components.
